(19) United States
(12) Patent Application Publication
(10) Pub. No.: US 2024/0381347 A1
(43) Pub. Date: Nov. 14, 2024

(54) NON-COHERENT UPLINK OPERATIONS

(71) Applicant: Samsung Electronics Co., Ltd., Suwon-si (KR)

(72) Inventors: Md. Saifur Rahman, Plano, TX (US); Eko Onggosanusi, Coppell, TX (US)

(21) Appl. No.: 18/647,749

(22) Filed: Apr. 26, 2024

Related U.S. Application Data
(60) Provisional application No. 63/465,735, filed on May 11, 2023.
(60) Provisional application No. 63/471,444, filed on Jun. 6, 2023.
(60) Provisional application No. 63/471,939, filed on Jun. 8, 2023.

(51) Int. Cl. H04W 72/1268; H04B 7/06; H04W 72/51

(52) U.S. Cl. CPC H04W 72/1268; H04B 7/0639; H04W 72/51

(57) ABSTRACT

Apparatuses and methods for non-coherent uplink (UL) operations. A method performed by a user equipment (UE) includes receiving a configuration including a value N_{g}=8 indicating an uplink (UL) codebook for eight antenna ports; receiving a transmit precoding matrix indicator (TPMI) index indicating a precoding matrix from the UL codebook; and transmitting a physical uplink shared channel (PUSCH) using the precoding matrix. The precoding matrix is given by

$$W = \frac{1}{2 \sqrt{2}} [ {e}_{{x}_{1}} , … , {e}_{{x}_{v}} ] ,$$

where v is a number of layers of the precoding matrix, xᵢ is a port index associated with layer i, eᵢ is a column vector with a value 1 at row corresponding to port xᵢ and value 0 at other rows, xᵢ∈{0, . . . ,7}, i∈{1, . . . , v}, v∈{1, . . . ,8}. The TPMI index maps to ports (x₁, . . . xᵥ) associated with v layers via an index I.

### CROSS-REFERENCE TO RELATED AND CLAIM OF PRIORITY

The present application claims priority under 35 U.S.C. § 119 (e) to: U.S. Provisional Patent Application No. 63/465,735 filed on May 11, 2023; U.S. Provisional Patent Application No. 63/471,444 filed on Jun. 6, 2023; and U.S. Provisional Patent Application No. 63/471,939 filed on Jun. 8, 2023, which are hereby incorporated by reference in their entirety.

### TECHNICAL FIELD

The present disclosure relates generally to wireless communication systems and, more specifically, the present disclosure is related to apparatuses and methods for non-coherent uplink (UL) operations.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to non-coherent UL operations.

In one embodiment, a user equipment (UE) is provided. The UE includes a processor and a transceiver operably coupled to the processor. The transceiver is configured to receive a configuration including a value N_{g}=8 indicating an UL codebook for eight antenna ports; receive a transmit precoding matrix indicator (TPMI) index indicating a precoding matrix from the UL codebook; and transmit a physical uplink shared channel (PUSCH) using the precoding matrix. The precoding matrix is given by

$$W = \frac{1}{2 \sqrt{2}} [ {e}_{{x}_{1}} , … , {e}_{{x}_{υ}} ] ,$$

where v is a number of layers of the precoding matrix, xᵢ is a port index associated with layer i, eᵢ is a column vector with a value 1 at row corresponding to port xᵢ and value 0 at other rows, xᵢ∈{0, . . . , 7}, i∈{1, . . . , v}, v∈{1, . . . ,8}. The TPMI index maps to ports (x₁, . . . xᵥ) associated with v layers via an index I.

In another embodiment, a base station (BS) is provided. The BS includes a processor and a transceiver operably coupled to the processor. The transceiver is configured to transmit a configuration including a value N_{g}=8 indicating an UL codebook for eight antenna ports; transmit a TPMI index indicating a precoding matrix from the UL codebook; and receive a PUSCH associated with the precoding matrix. The precoding matrix is given by

$$W = \frac{1}{2 \sqrt{2}} [ {e}_{{x}_{1}} , … , {e}_{{x}_{υ}} ] ,$$

where v is a number of layers of the precoding matrix, xᵢ is a port index associated with layer i, eᵢ is a column vector with a value 1 at row corresponding to port xᵢ and value 0 at other rows, xᵢ∈ {0, . . . ,7}, i∈{1, . . . , v}, v∈{1, . . . ,8}. The TPMI index maps to ports (x₁, . . . , xᵥ) associated with v layers via an index I.

In yet another embodiment, a method performed by a UE is provided. The method includes receiving a configuration including a value N_{g}=8 indicating an UL codebook for eight antenna ports; receiving a TPMI index indicating a precoding matrix from the UL codebook; and transmitting a PUSCH using with the precoding matrix. The precoding matrix is given by

$$W = \frac{1}{2 \sqrt{2}} [ {e}_{{x}_{1}} , … , {e}_{{x}_{υ}} ] ,$$

where v is a number of layers of the precoding matrix, xᵢ is a port index associated with layer i, eᵢ is a column vector with a value 1 at row corresponding to port xᵢ and value 0 at other rows, xᵢ∈{0, . . . ,7}, i∈{1, . . . , v}, v∈{1, . . . ,8}. The TPMI index maps to ports (x₁, . . . xᵥ) associated with u layers via an index I.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates a diagram of example antenna port layouts at a UE according to embodiments of the present disclosure; and

FIG. 7 illustrates an example method performed by a UE in a wireless communication system according to embodiments of the present disclosure.

### DETAILED DESCRIPTION

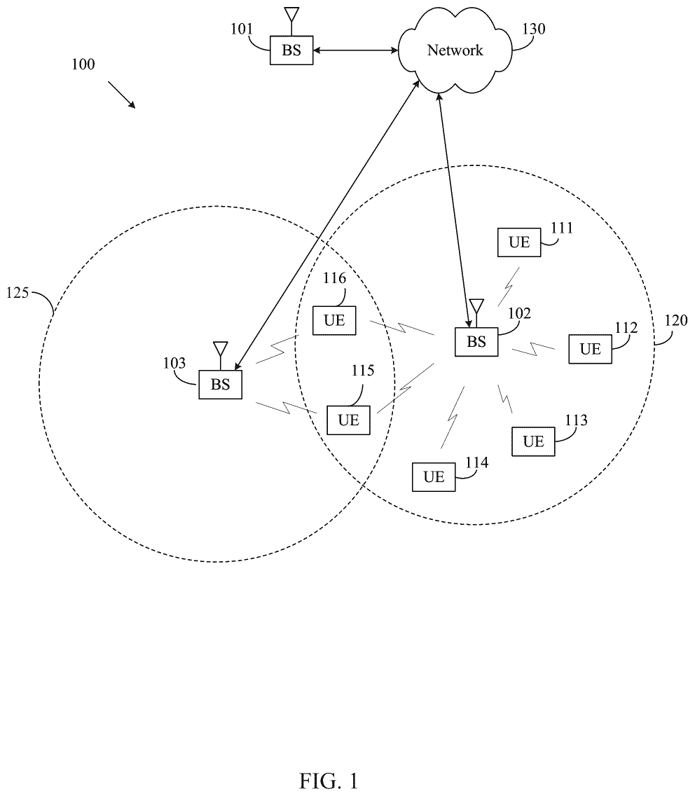

FIGS. 1-7, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [1] 3GPP TS 36.211 v17.1.0, “E-UTRA, Physical channels and modulation;” [2] 3GPP TS 36.212 v17.1.0, “E-UTRA, Multiplexing and Channel coding;” [3] 3GPP TS 36.213 v17.1.0, “E-UTRA, Physical Layer Procedures;” [4] 3GPP TS 36.321 v17.1.0, “E-UTRA, Medium Access Control (MAC) protocol specification;” [5] 3GPP TS 36.331 v17.1.0, “E-UTRA, Radio Resource Control (RRC) Protocol Specification;” [6] 3GPP TS 38.211 v17.1.0, “NR, Physical channels and modulation;” [7] 3GPP TS 38.212 v17.1.0, “NR, Multiplexing and Channel coding;” [8] 3GPP TS 38.213 v17.1.0, “NR, Physical Layer Procedures for Control;” [9] 3GPP TS 38.214 v17.1.0, “NR, Physical Layer Procedures for Data;” 3GPP TS 38.215 v17.1.0, “NR, Physical Layer Measurements;” 3GPP TS 38.321 v17.1.0, “NR, Medium Access Control (MAC) protocol specification;” and 3GPP TS 38.331 v17.1.0, “NR, Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for performing non-coherent UL operations. In certain embodiments, one or more of the BSs 101-103 include circuitry, programing, or a combination thereof to support non-coherent UL operations.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

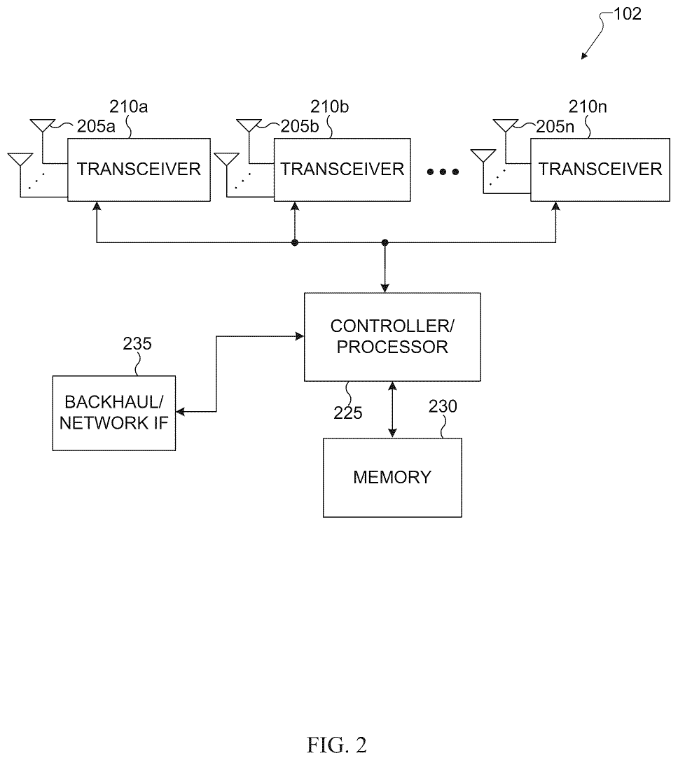

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods to enable and support non-coherent UL operations. Any of a wide variety of other functions could be supported in the gNB 102 by the controller/processor 225.

The controller/processor 225 is also capable of executing programs and other processes resident in the memory 230, such as processes to enable and support non-coherent UL operations. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

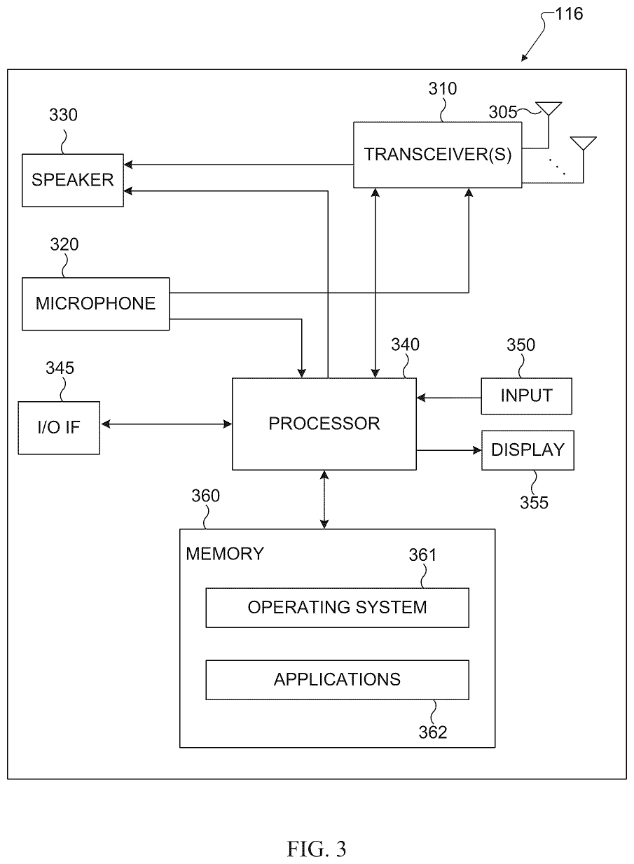

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for performing non-coherent UL operations as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

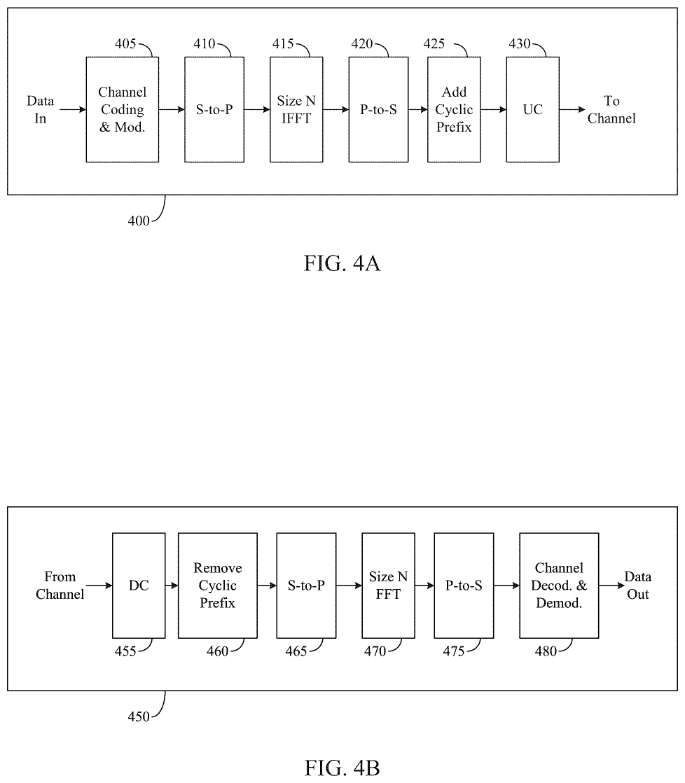

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or the receive path 450 is configured to perform or support non-coherent UL operations as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

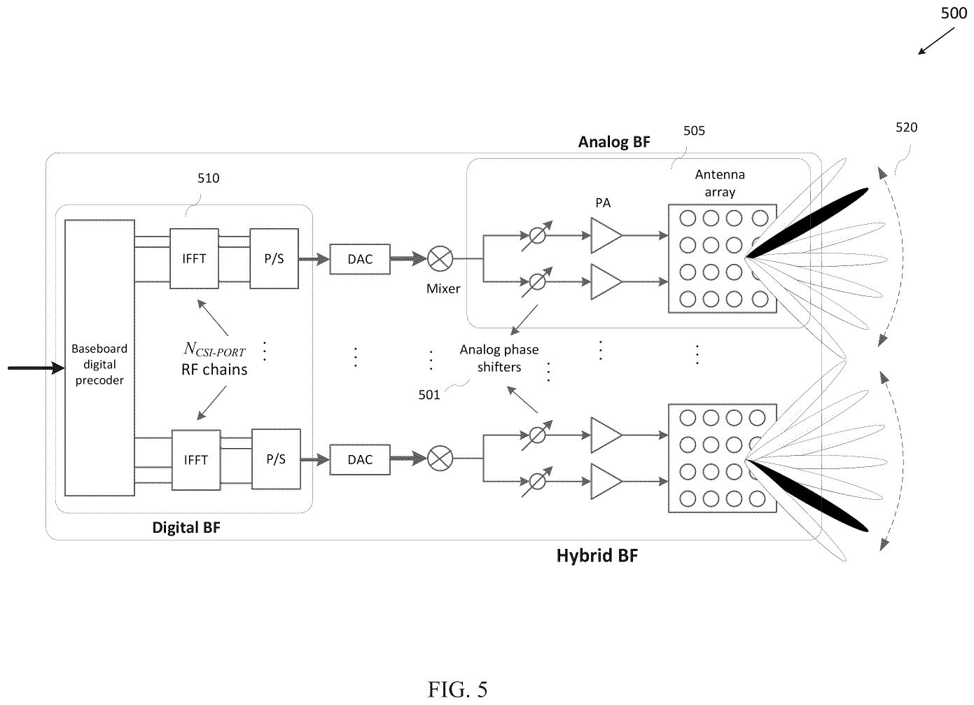

FIG. 5 illustrates an example of a transmitter structure 500 for beamforming according to embodiments of the present disclosure. In certain embodiments, one or more of gNB 102 or UE 116 includes the transmitter structure 500. For example, one or more of antennas 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 CSI-RS antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports N_{CSI-PORT}. A digital beamforming unit 510 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

The present disclosure relates generally to wireless communication systems and, more specifically, to UL transmission based on a codebook.

In NR, two transmission schemes are supported for physical uplink shared channel (PUSCH): codebook based transmission and non-codebook based transmission. The UE is configured with codebook based transmission when the higher layer parameter txConfig in pusch-Config is set to ‘codebook’. The UE is configured non-codebook based transmission when the higher layer parameter txConfig is set to ‘nonCodebook’.

According to Section 6.1.1.1 [REF9], the following is supported for codebook based UL transmission.

For codebook based transmission, PUSCH can be scheduled by downlink control information (DCI) format 0_0, DCI format 0_1, DCI format 0_2 or semi-statically configured to operate according to Clause 6.1.2.3 [REF9]. If this PUSCH is scheduled by DCI format 0_1, DCI format 0_2, or semi-statically configured to operate according to Clause 6.1.2.3 [REF9], the UE determines its PUSCH transmission precoder based on SRS resource indicator (SRI), transmit precoding matrix indicator (TPMI) and the transmission rank, where the SRI, TPMI and the transmission rank are given by DCI fields of SRS resource indicator and Precoding information and number of layers in clause 7.3.1.1.2 and 7.3.1.1.3 of [5, REF] for DCI format 0_1 and 0_2 or given by srs-ResourceIndicator and precodingAndNumberOfLayers according to clause 6.1.2.3. The SRS-ResourceSet(s) applicable for PUSCH scheduled by DCI format 0_1 and DCI format 0_2 is defined by the entries of the higher layer parameter srs-Resource SetToAddModList and srs-ResourceSetToAddModListDCI-0-2 in SRS-config, respectively. Only one SRS resource set can be configured in srs-ResourceSetToAddModList with higher layer parameter usage in SRS-ResourceSet set to ‘codebook’. Only one SRS resource set can be configured in srs-ResourceSetToAddModListDCI-0-2 with higher layer parameter usage in SRS-ResourceSet set to ‘codebook’. The TPMI is used to indicate the precoder to be applied over the layers {0 . . . v-1} and that corresponds to the SRS resource selected by the SRI when multiple SRS resources are configured. Or if a single SRS resource is configured, TPMI is used to indicate the precoder to be applied over the layers {0 . . . v-1} and that corresponds to the SRS resource. The transmission precoder is selected from the uplink codebook that has a number of antenna ports equal to higher layer parameter nrofSRS-Ports in SRS-Config, as defined in Clause 6.3.1.5 of [4, TS 38.211]. When the UE is configured with the higher layer parameter rxConfig set to ‘codebook’, the UE is configured with at least one SRS resource. The indicated SRI in slot n is associated with the most recent transmission of SRS resource identified by the SRI, where the SRS resource is prior to the physical downlink control channel (PDCCH) carrying the SRI.

For codebook based transmission, the UE determines its codebook subsets based on TPMI and upon the reception of higher layer parameter codebookSubset in pusch-Config for PUSCH associated with DCI format 0_1 and codebookSubsetDCI-0-2 in pusch-Config for PUSCH associated with DCI format 0_2 which may be configured with ‘fully AndPartial AndNonCoherent’, or ‘partialAndNonCoherent’, or ‘nonCoherent’ depending on the UE capability. When higher layer parameter ul-FullPowerTransmission is set to ‘fullpowerMode2’ and the higher layer parameter codebookSubset or the higher layer parameter codebookSubsetForDCI-Format0-2 is set to ‘partial AndNonCoherent’, and when the SRS-resourceSet with usage set to “codebook” includes at least one SRS resource with 4 ports and one SRS resource with 2 ports, the codebook Subset associated with the 2-port SRS resource is ‘nonCoherent’. The maximum transmission rank may be configured by the higher layer parameter maxRank in pusch-Config for PUSCH scheduled with DCI format 0_1 and maxRank-ForDCIFormat0_2 for PUSCH scheduled with DCI format 0_2.

A UE reporting its UE capability of ‘partialAndNonCoherent’ transmission shall not expect to be configured by either codebookSubset or codebookSubsetForDCI-Format0-2 with ‘fully AndPartial AndNonCoherent’.

A UE reporting its UE capability of ‘nonCoherent’ transmission shall not expect to be configured by either codebookSubset or codebookSubsetForDCI-Format0-2 with ‘fully AndPartial AndNonCoherent’ or with ‘partial AndNonCoherent’.

A UE shall not expect to be configured with the higher layer parameter codebookSubset or the higher layer parameter codebookSubsetForDCI-Format0-2 set to ‘partialAndNonCoherent’ when higher layer parameter nrofSRS-Ports in an SRS-ResourceSet with usage set to ‘codebook’ indicates that the maximum number of the configured SRS antenna ports in the SRS-ResourceSet is two.

For codebook based transmission, only one SRS resource can be indicated based on the SRI from within the SRS resource set. Except when higher layer parameter ul-FullPowerTransmission is set to ‘fullpowerMode2’, the maximum number of configured SRS resources for codebook based transmission is 2. If aperiodic SRS is configured for a UE, the SRS request field in DCI triggers the transmission of aperiodic SRS resources.

A UE shall not expect to be configured with higher layer parameter ul-FullPower Transmission set to ‘fullpowerMode1’ and codebookSubset or codebookSubsetDCI-0-2 set to ‘fullAndPartial AndNonCoherent’ simultaneously.

The UE shall transmit PUSCH using the same antenna port(s) as the SRS port(s) in the SRS resource indicated by the DCI format 0_1 or 0_2 or by configuredGrantConfig according to clause 6.1.2.3.

The demodulation reference signal (DM-RS) antenna ports {\tilde{p}₀, . . . , \tilde{p}ᵥ₋₁} in Clause 6.4.1.1.3 of [4, TS38.211] are determined according to the ordering of DM-RS port(s) given by Tables 7.3.1.1.2-6 to 7.3.1.1.2-23 in Clause 7.3.1.1.2 of [5, TS 38.212].

Except when higher layer parameter ul-FullPowerTransmission is set to ‘fullpowerMode2’, when multiple SRS resources are configured by SRS-ResourceSet with usage set to ‘codebook’, the UE shall expect that higher layer parameters nrofSRS-Ports in SRS-Resource in SRS-ResourceSet shall be configured with the same value for these SRS resources.

In the rest of the present disclosure, ‘fullAndPartialAndNonCoherent’, ‘partialAndNonCoherent’, and ‘Non-Coherent’ are referred to codebookSubsets depending on three coherence type/capability, where the term ‘coherence’ implies each or a subset of antenna ports at the UE that can be used to transmit a layer coherently. In particular:
The term ‘full-coherence’ (FC) implies each antenna port at the UE that can be used to transmit a layer coherently.
The term ‘partial-coherence’ (PC) implies a subset (at least two but less than all) of antenna ports at the UE that can be used to transmit a layer coherently.
The term ‘non-coherence’ (NC) implies only one antenna port at the UE that can be used to transmit a layer.

When the UE is configured with codebook Subset= ‘fullAndPartial AndNonCoherent’, the UL codebook includes three types (FC, PC, NC) of precoding matrices; when the UE is configured with codebookSubset= ‘partialAndNonCoherent’, the UL codebook includes two types (PC, NC) of precoding matrices; and when the UE is configured with codebookSubset= ‘nonCoherent’, the UL codebook includes only one type (NC) of precoding matrices.

According to Section 6.3.1.5 of REF7, for non-codebook-based UL transmission, the precoding matrix W equals the identity matrix. For codebook-based UL transmission, the precoding matrix W is given by W=1 for single-layer transmission on a single antenna port, otherwise by Table 1 to Table 6, which are copied below.

The rank (or number of layers) and the corresponding precoding matrix Ware indicated to the UE using TRI and TPMI, respectively. In one example, this indication is joint via a field ‘Precoding information and member of layers’ in DCI, e.g., using DCI format 0_1. In another example, this indication is via higher layer RRC signaling. In one example, the mapping between a field ‘Precoding information and member of layers’ and TRI/TPMI is according to Section 7.3.1.1.2 of [REF10].

TABLE 1
Precoding matrix W for single-layer transmission using two antenna ports.

| TPMI | W | | | | | | | |
|---|---|---|---|---|---|---|---|---|
| index | (ordered from left to right in increasing order of TPMI index) | | | | | | | |
| 0-5 | $\frac{1}{\sqrt{2}} [ \begin{matrix}1 \\ 0\end{matrix} ]$ | $\frac{1}{\sqrt{2}} [ \begin{matrix}0 \\ 1\end{matrix} ]$ | $\frac{1}{\sqrt{2}} [ \begin{matrix}1 \\ 1\end{matrix} ]$ | $\frac{1}{\sqrt{2}} [ \begin{matrix}1 \\ - 1\end{matrix} ]$ | $\frac{1}{\sqrt{2}} [ \begin{matrix}1 \\ j\end{matrix} ]$ | $\frac{1}{\sqrt{2}} [ \begin{matrix}1 \\ - j\end{matrix} ]$ | — | — |

TABLE 2
Precoding matrix W for single-layer transmission using four antenna
ports with transform precoding disabled

| TPMI | W | | | | | | | |
|---|---|---|---|---|---|---|---|---|
| index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ - 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ - 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ 1\end{matrix} ]$ | $\frac{1}{2} [ \begin{matrix}1 \\ - 1 \\ 1 \\ - 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ - 1\end{matrix} ]$ | — | — | — | — |

TABLE 3
Precoding matrix W for two-layer transmission using two antenna
ports with transform precoding disabled

| TPMI | W | | |
|---|---|---|---|
| index | (ordered from left to right in increasing order of TPMI index) | | |
| 0-2 | $\frac{1}{\sqrt{2}} [ \begin{matrix}1 & 0 \\ 0 & 1\end{matrix} ]$ | $\frac{1}{2} [ \begin{matrix}1 & 1 \\ 1 & - 1\end{matrix} ]$ | $\frac{1}{2} [ \begin{matrix}1 & 1 \\ j & - j\end{matrix} ]$ |

TABLE 4
Precoding matrix W for two-layer transmission using four antenna ports with transform
precoding disabled

| TPMI | W | | | |
|---|---|---|---|---|
| index | (ordered from left to right in increasing order of TPMI index) | | | |
| 0-3 | $\frac{1}{2} [ \begin{matrix}1 & 0 \\ 0 & 1 \\ 0 & 0 \\ 0 & 0\end{matrix} ]$ | $\frac{1}{2} [ \begin{matrix}1 & 0 \\ 0 & 0 \\ 0 & 1 \\ 0 & 0\end{matrix} ]$ | $\frac{1}{2} [ \begin{matrix}1 & 0 \\ 0 & 0 \\ 0 & 0 \\ 0 & 1\end{matrix} ]$ | $\frac{1}{2} [ \begin{matrix}0 & 0 \\ 1 & 0 \\ 0 & 1 \\ 0 & 0\end{matrix} ]$ |
| 4-7 | $\frac{1}{2} [ \begin{matrix}0 & 0 \\ 1 & 0 \\ 0 & 0 \\ 0 & 1\end{matrix} ]$ | $\frac{1}{2} [ \begin{matrix}0 & 0 \\ 0 & 0 \\ 1 & 0 \\ 0 & 1\end{matrix} ]$ | $\frac{1}{2} [ \begin{matrix}1 & 0 \\ 0 & 1 \\ 1 & 0 \\ 0 & - j\end{matrix} ]$ | $\frac{1}{2} [ \begin{matrix}1 & 0 \\ 0 & 1 \\ 1 & 0 \\ 0 & j\end{matrix} ]$ |
| 8-11 | $\frac{1}{2} [ \begin{matrix}1 & 0 \\ 0 & 1 \\ - j & 0 \\ 0 & 1\end{matrix} ]$ | $\frac{1}{2} [ \begin{matrix}1 & 0 \\ 0 & 1 \\ - j & 0 \\ 0 & - 1\end{matrix} ]$ | $\frac{1}{2} [ \begin{matrix}1 & 0 \\ 0 & 1 \\ - 1 & 0 \\ 0 & - j\end{matrix} ]$ | $\frac{1}{2} [ \begin{matrix}1 & 0 \\ 0 & 1 \\ - 1 & 0 \\ 0 & j\end{matrix} ]$ |
| 12-15 | $\frac{1}{2} [ \begin{matrix}1 & 0 \\ 0 & 1 \\ j & 0 \\ 0 & 1\end{matrix} ]$ | $\frac{1}{2} [ \begin{matrix}1 & 0 \\ 0 & 1 \\ j & 0 \\ 0 & - 1\end{matrix} ]$ | $\frac{1}{2 \sqrt{2}} [ \begin{matrix}1 & 1 \\ 1 & 1 \\ 1 & - 1 \\ 1 & - 1\end{matrix} ]$ | $\frac{1}{2 \sqrt{2}} [ \begin{matrix}1 & 1 \\ 1 & 1 \\ j & - j \\ j & - j\end{matrix} ]$ |
| 16-19 | $\frac{1}{2 \sqrt{2}} [ \begin{matrix}1 & 1 \\ j & j \\ 1 & - 1 \\ j & - j\end{matrix} ]$ | $\frac{1}{2 \sqrt{2}} [ \begin{matrix}1 & 1 \\ j & j \\ j & - j \\ - 1 & 1\end{matrix} ]$ | $\frac{1}{2 \sqrt{2}} [ \begin{matrix}1 & 1 \\ - 1 & - 1 \\ 1 & - 1 \\ - 1 & 1\end{matrix} ]$ | $\frac{1}{2 \sqrt{2}} [ \begin{matrix}1 & 1 \\ - 1 & - 1 \\ j & - j \\ - j & j\end{matrix} ]$ |
| 20-21 | $\frac{1}{2 \sqrt{2}} [ \begin{matrix}1 & 1 \\ - j & - j \\ 1 & - 1 \\ - j & j\end{matrix} ]$ | $\frac{1}{2 \sqrt{2}} [ \begin{matrix}1 & 1 \\ - j & - j \\ j & - j \\ 1 & - 1\end{matrix} ]$ | — | — |

TABLE 5
Precoding matrix W for three-layer transmission using four antenna ports with
transform precoding disabled

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 \\ 0 & 1 & 0 \\ 0 & 0 & 1 \\ 0 & 0 & 0\end{matrix} ]$ | $\frac{1}{2} [ \begin{matrix}1 & 0 & 0 \\ 0 & 1 & 0 \\ 1 & 0 & 0 \\ 0 & 0 & 1\end{matrix} ]$ | $\frac{1}{2} [ \begin{matrix}1 & 0 & 0 \\ 0 & 1 & 0 \\ - 1 & 0 & 0 \\ 0 & 0 & 1\end{matrix} ]$ | $\frac{1}{2 \sqrt{3}} [ \begin{matrix}1 & 1 & 1 \\ 1 & - 1 & 1 \\ 1 & 1 & - 1 \\ 1 & - 1 & - 1\end{matrix} ]$ |
| 4-6 | $\frac{1}{2 \sqrt{3}} [ \begin{matrix}1 & 1 & 1 \\ 1 & - 1 & 1 \\ j & j & - j \\ j & - j & - j\end{matrix} ]$ | $\frac{1}{2 \sqrt{3}} [ \begin{matrix}1 & 1 & 1 \\ - 1 & 1 & - 1 \\ 1 & 1 & - 1 \\ - 1 & 1 & 1\end{matrix} ]$ | $\frac{1}{2 \sqrt{3}} [ \begin{matrix}1 & 1 & 1 \\ - 1 & 1 & - 1 \\ j & j & - j \\ - j & j & j\end{matrix} ]$ | — |

TABLE 6
Precoding matrix W for four-layer transmission using four antenna ports with transform
precoding disabled

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ]$ | $\frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ]$ | $\frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ]$ | $\frac{1}{4} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ |
| 4 | $\frac{1}{4} [ \begin{matrix}1 & 1 & 1 & 1 \\ 1 & - 1 & 1 & - 1 \\ j & j & - j & - j \\ j & - j & - j & j\end{matrix} ]$ | — | — | — |

The subset of TPMI indices for the three coherence types are summarized in Table 7 and Table 8, where rank=r corresponds to (and is equivalent to) r layers.

TABLE 7
Total power of precoding matrix W for 2 antenna ports

| | |
|---|---|
| Non-Coherent (NC) | Full-Coherent (FC) |
| TPMIs | TPMIs |

| | TPMI | Total | TPMI | Total |
|---|---|---|---|---|
| Rank | indices | power | indices | power |
| 1 | 0-1 | ½ | 2-5 | 1 |
| 2 | 0 | 1 | 1-2 | 1 |

TABLE 8
Total power of precoding matrix Wfor 4 antenna ports

| | Non-Coherent | | Partial-Coherent | | Full-Coherent | |
|---|---|---|---|---|---|---|
| | (NC) TPMIs | | (PC) TPMIs | | (FC) TPMIs | |
| | TPMI | Total | TPMI | Total | TPMI | Total |
| Rank | indices | power | indices | power | indices | power |
| 1 | 0-3 | ¼ | 4-11 | ½ | 12-27 | 1 |
| 2 | 0-5 | ½ | 6-13 | 1 | 14-21 | 1 |
| 3 | 0 | ¾ | 1-2 | 1 | 3-6 | 1 |
| 4 | 0 | 1 | 1-2 | 1 | 3-4 | 1 |

The corresponding supported codebookSubsets are summarized in Table 9 and Table 10.

TABLE 9
TPMI indices for codebookSubsets for 2 antenna ports

| Rank | Non-Coherent | fullAndPartialAndNonCoherent |
|---|---|---|
| 1 | 0-1 | 0-5 |
| 2 | 0 | 0-2 |

TABLE 10
TPMI indices for codebookSubsets for 4 antenna ports

| | Non- | partialAndNonCo- | fullAndPartialAndNonCo- |
|---|---|---|---|
| Rank | Coherent | herent | herent |
| 1 | 0-3 | 0-11 | 0-27 |
| 2 | 0-5 | 0-13 | 0-21 |
| 3 | 0 | 0-2 | 0-6 |
| 4 | 0 | 0-2 | 0-4 |

In up to Rel. 17 NR, for UL transmission, the 3GPP specification supports 1, 2, or 4 SRS antenna ports in one SRS resource. In more advanced UL MIMO systems (e.g., in Rel. 18 and beyond), the number of SRS antenna ports can be more than 4, e.g., 6, 8, or even 12, and 16, especially for devices such as Customer Premise Equipment (CPE), Fixed Wireless Access (FWA), and vehicular UEs. Embodiments of the present disclosure recognize codebook-based UL transmission for such devices requires enhancements, e.g., codebook for >=4 antenna ports and related signaling for efficient UL MIMO operations. This disclosure provides example embodiments for potential enhancements. In particular, it provided examples of non-coherent precoders included in an UL codebook for 8 antenna ports. The scope of the disclosure is not limited to only these embodiments, but includes any extensions or combinations of the embodiments.

The present disclosure relates to codebook-based UL transmission for 8 antenna ports. The novel includes the following:
UL codebook design for 8 antenna ports that can be grouped into non-coherent N_{g}∈{8} groups, each with one antenna port;
Design principles and examples on NC precoder design for 8Tx UL codebook based on common (Rel.15 4Tx and 2Tx UL non-coherent precoders);
Mechanisms to reduce TPMI overhead indication.

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

The text and figures are provided solely as examples to aid the reader in understanding the disclosure. They are not intended and are not to be construed as limiting the scope of this disclosure in any manner. Although certain embodiments and examples have been provided, it will be apparent to those skilled in the art based on the disclosures herein that changes in the embodiments and examples shown may be made without departing from the scope of this disclosure.

In the following, for brevity, both frequency division duplexing (FDD) and time division duplexing (TDD) are considered as the duplex method for both DL and UL signaling.

Although exemplary descriptions and embodiments follow orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

The present disclosure covers several components which can be used in conjunction or in combination with one another, or can operate as standalone schemes.

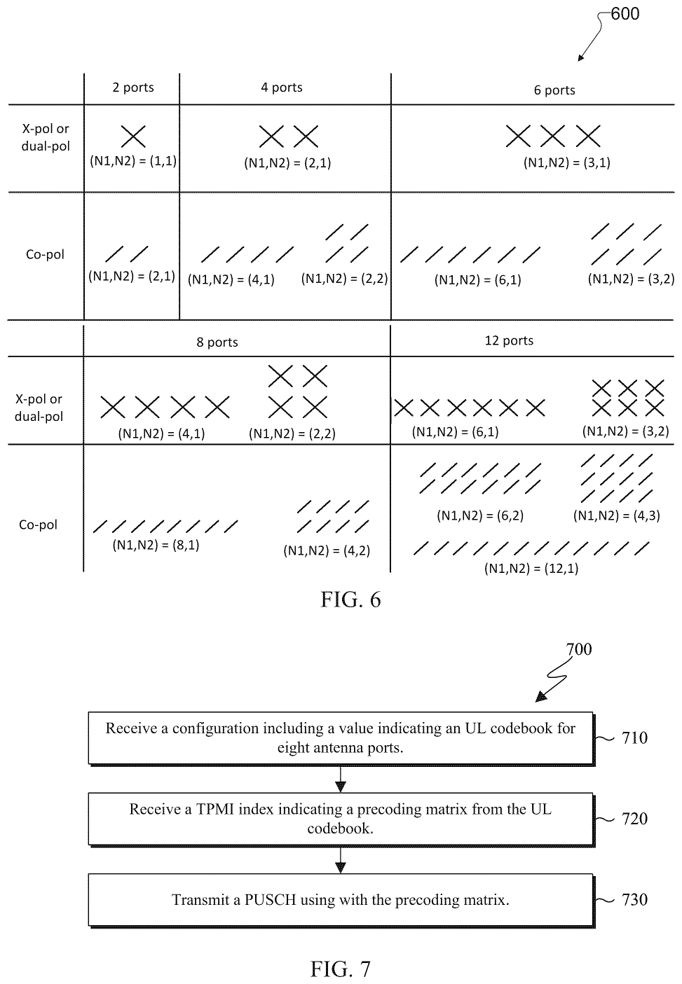

FIG. 6 illustrates a diagram of example antenna port layouts 600 at a UE according to embodiments of the present disclosure. For example, antenna port layouts 600 at a UE can be implemented in any of the UEs 111-116 of FIG. 1. This example is for illustration only and other embodiments can be used without departing from the scope of the present disclosure.

In one example, antenna ports of the UE (e.g., UE 116) belong to a single antenna panel (i.e., they are co-located, for example, at one plane, side, or edge of the UE). N₁ and N₂ are the number of antenna ports with the same polarization in the first and second dimensions, respectively. For 2D antenna port layouts, we have N₁>1, N₂>1, and for 1D antenna port layouts, we either have N₁>1 and N₂=1 or N₂>1 and N₁=1. In the rest of the disclosure, 1D antenna port layouts with N₁>1 and N₂=1 is considered. The disclosure, however, is applicable to the other 1D port layouts with N₂>1 and N₁=1. Also, in the rest of the disclosure, N₁≥N₂. The disclosure, however, is applicable to the case when N₁<N₂, and the embodiments for N₁>N₂ applies to the case N₁<N₂ by swapping/switching (N₁, N₂) with (N₂, N₁). For a (single-polarized) co-polarized antenna port layout, the total number of antenna ports is N₁N₂ and for a dual-polarized antenna port layout, the total number of antenna ports is 2N_{I}N₂. An illustration of antenna port layouts for {2, 4, 6, 8, 12} antenna ports at UE is shown in Table 11.

Let s denotes the number of antenna polarizations (or groups of antenna ports with the same polarization). Then, for co-polarized antenna ports, s=1, and for dual- or cross (X)-polarized antenna ports s=2. So, the total number of antenna ports P=sN₁N₂. In one example, the antenna ports at the UE refers to SRS antenna ports (either in one SRS resource or across multiple SRS resources).

The UL codebook W for P antenna ports at the UE is based on pre-coding vectors which are according to one of the two alternatives in Table 11 depending on whether the antenna ports are co-polarized or cross-/dual-polarized.

TABLE 11
Pre-coding vectors

| Co-pol | Dual-pol |
|---|---|
| ${v}_{l , m} = \frac{{v}_{l . m}}{\sqrt{{N}_{1} {N}_{2}}}$ | ${v}_{l , m , n} = \frac{1}{\sqrt{2 {N}_{1} {N}_{2}}} [ \begin{matrix}{v}_{l , m} \\ {φ}_{n} {v}_{l , m}\end{matrix} ]$ |

Here, V_{l,m} is a Kronecker product (⊗) of vectors wₗ and uₘ of lengths N₁ and N₂, respectively. In one example, wₗ and uₘ are oversampled DFT vectors, i.e.,

$${w}_{l} = {[ \begin{matrix}1 & {e}^{j \frac{2 π l}{{O}_{1} {N}_{1}}} & {e}^{j \frac{4 π l}{{O}_{1} {N}_{1}}} & … & {e}^{j \frac{2 π l ( {N}_{1} - 1 )}{{O}_{1} {N}_{1}}}\end{matrix} ]}^{T}$$

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}} \\ & & 1 & \end{matrix} ]$$

$$\begin{matrix}{N}_{2} > 1 \\ {N}_{2} = 1\end{matrix}$$

where O₁ and O₂ are oversampling factors in two dimensions, and v_{l,m} is then given by

$${v}_{l , m} = {w}_{l} ⊗ {u}_{m} = {[ \begin{matrix}{u}_{m} & {e}^{j \frac{2 π l}{{O}_{1} {N}_{1}}} & … & {e}^{j \frac{2 π l ( {N}_{1} - 1 )}{{O}_{1} {N}_{1}} {u}_{m}}\end{matrix} ]}^{T}$$

In one example, both O₁, O₂∈{2,4,8}. In one example, O₁ and O₂ can take the same values as Rel.15 NR Type I codebook (cf. 5.2.2.2.1, TS 38.214), i.e., (O₁, O₂)=(4,4) when N₂>1, and, i.e., (O₁, O₂)=(4,1) when N₂=1. Alternatively, they take different values from the Rel. 15 Type I NR codebook, for example, (O₁, O₂)=(2,2) when N₂>1, and, i.e., (O₁, O₂)=(2,1) when N₂=1. In one example, O₁ and O₂ is configurable (e.g., via higher layer).

The quantity φₙ is a co-phase for dual-polarized antenna port layouts. In one example, φₙ=e^{jπn/2}, where n∈{0,1,2,3} implying that φₙ belongs to QPSK alphabet {1, j, −1, −j}.

In one example, the values of N₁ and N₂ are configured, e.g., with the higher layer parameter n1-n2-ul. The supported configurations of (N₁, N₂) for a given number of antenna ports (P) is given in Table 12.

TABLE 12
Configurations of (N₁, N₂)

| Number of | Dual-pol | Co-pol |
|---|---|---|
| antenna ports, P | (N₁, N₂) | (N₁, N₂) |
| 2 | (1, 1) | (2, 1) |
| 4 | (2, 1) | (2, 2), (4, 1) |
| 6 | (3, 1) | (3, 2), (6, 1) |
| 8 | (2, 2), (4, 1) | (4, 2), (8, 1) |
| 12 | (3, 2), (6, 1) | (4, 3), (6, 2), (12, 1) |
| 16 | (4, 2), (8, 1) | (8, 2), (4, 4), (16, 1) |

In one example, the values of N₁ and N₂ are fixed for a given number of antenna ports.

$$( \frac{P}{2} , 1 )$$

For example, (N₁, N₂)=(P, 1) for co-pol and for dual-pol antenna. In one example, only one (N₁, N₂) is supported for each value of P, where the supported (N₁, N₂) is one of pairs in Table 12.

The dual-polarized antenna layout is implied in the rest of the disclosure. The number of antenna ports is implied to be P=8 in the rest of the disclosure.

In one example, P antenna ports can be divided into multiple groups. Let N_{g} be the number of antenna port groups. When each group comprises the same number of antenna ports, then each groups has the antenna layout with (N₁, N₂) value as shown in Table 13.

TABLE 13

| N_{g} | (N₁, N₂) |
|---|---|
| 1 | (4, 1), (2, 2) |
| 2 | (2, 1) |
| 4 | (1, 1) |
| 8 | Not applicable |

In one example, N_{g}=1 corresponds to a single antenna panel. In one example, N_{g}=1 corresponds to a full coherent (FC) UE or FC antenna layout.

In one example, N_{g}=2 corresponds to two antenna panels. In one example, N_{g}=2 corresponds to a partial coherent (PC) UE or PC antenna layout.

In one example, N_{g}=4 corresponds to four antenna panels. In one example, N_{g}=4 corresponds to a partial coherent (PC) UE or PC antenna layout.

In one example, N_{g}=8 corresponds to eight antenna panels. In one example, N_{g}=8 corresponds to a non-coherent (NC) UE or NC antenna layout.

In this disclosure, the codebook design examples for N_{g}=8 are provided.

The mapping of the antenna ports to antenna groups are according to at least one of the examples.
In one example (numbering A), the antenna group i=1 maps to (corresponds to) antenna ports 1,2,3,4, and the antenna group i=1 maps to (corresponds to) antenna ports 5,6,7,8.
In one example (numbering B), the antenna group i=1 maps to (corresponds to) antenna ports 1,2,5,6, and the antenna group i=1 maps to (corresponds to) antenna ports 3, 4,7,8.

Let eᵢ denote an 8×1 (port selection) column vector whose i-th entry is 1 (indicating port i is selected), and remaining entries are 0. Then,

$${e}_{1} = \frac{1}{s} [ \begin{matrix}1 \\ 0 \\ 0 \\ 0 \\ 0 \\ 0 \\ 0 \\ 0\end{matrix} ] , {e}_{2} = \frac{1}{s} [ \begin{matrix}0 \\ 1 \\ 0 \\ 0 \\ 0 \\ 0 \\ 0 \\ 0\end{matrix} ] , {e}_{3} = \frac{1}{s} [ \begin{matrix}0 \\ 0 \\ 1 \\ 0 \\ 0 \\ 0 \\ 0 \\ 0\end{matrix} ] , {e}_{4} = \frac{1}{s} [ \begin{matrix}0 \\ 0 \\ 0 \\ 1 \\ 0 \\ 0 \\ 0 \\ 0\end{matrix} ] , {e}_{5} = \frac{1}{s} [ \begin{matrix}0 \\ 0 \\ 0 \\ 0 \\ 1 \\ 0 \\ 0 \\ 0\end{matrix} ] , {e}_{6} = \frac{1}{s} [ \begin{matrix}0 \\ 0 \\ 0 \\ 0 \\ 0 \\ 1 \\ 0 \\ 0\end{matrix} ] , {e}_{7} = \frac{1}{s} [ \begin{matrix}0 \\ 0 \\ 0 \\ 0 \\ 0 \\ 0 \\ 1 \\ 0\end{matrix} ] , {e}_{8} = \frac{1}{s} [ \begin{matrix}0 \\ 0 \\ 0 \\ 0 \\ 0 \\ 0 \\ 0 \\ 1\end{matrix} ] .$$

In one example, s=2\sqrt{2}. In one example, s=\sqrt{K_{NZ}}, where K_{NZ} is a number of non-zero (NZ) entries in the precoder. In one example, s=\sqrt{v}.

Let the set of antenna ports be x₀, x₁, . . . , xᵥ₋₁. For rank v (or number of layers=v), the v columns of each of the precoding matrices can be given by

$$W = \frac{1}{s} [ {e}_{{x}_{1}} , … , {e}_{{x}_{υ}} ]$$

where s=\sqrt{v} and xᵢ is the port index on which layer i∈{0,1, . . . , v−1} is to be transmitted. Hence, eᵢ has an element 1 on the row corresponding to the port xᵢ on which layer i is to be transmitted, and element 0 in other rows.

In one example, when v>1, the port indices {xᵢ} in the precoding matrix are ordered such that xᵢ<xᵢ₊₁.

In one example (definition 1), the range of value of index xᵢ is {1,2, . . . ,8}. In one example (definition 2), the range of value of index xᵢ is {0,1, . . . ,7}.

According to definition 2,

$${e}_{0} = \frac{1}{s} [ \begin{matrix}1 \\ 0 \\ 0 \\ 0 \\ 0 \\ 0 \\ 0 \\ 0\end{matrix} ] , {e}_{1} = \frac{1}{s} [ \begin{matrix}0 \\ 1 \\ 0 \\ 0 \\ 0 \\ 0 \\ 0 \\ 0\end{matrix} ] , {e}_{2} = \frac{1}{s} [ \begin{matrix}0 \\ 0 \\ 1 \\ 0 \\ 0 \\ 0 \\ 0 \\ 0\end{matrix} ] , {e}_{3} = \frac{1}{s} [ \begin{matrix}0 \\ 0 \\ 0 \\ 1 \\ 0 \\ 0 \\ 0 \\ 0\end{matrix} ] , {e}_{4} = \frac{1}{s} [ \begin{matrix}0 \\ 0 \\ 0 \\ 0 \\ 1 \\ 0 \\ 0 \\ 0\end{matrix} ] , {e}_{5} = \frac{1}{s} [ \begin{matrix}0 \\ 0 \\ 0 \\ 0 \\ 0 \\ 1 \\ 0 \\ 0\end{matrix} ] , {e}_{6} = \frac{1}{s} [ \begin{matrix}0 \\ 0 \\ 0 \\ 0 \\ 0 \\ 0 \\ 1 \\ 0\end{matrix} ] , {e}_{7} = \frac{1}{s} [ \begin{matrix}0 \\ 0 \\ 0 \\ 0 \\ 0 \\ 0 \\ 0 \\ 1\end{matrix} ] .$$

A vector eᵢ with the index i according to definition 1 maps to (the same) a vector eᵢ₋₁ with index i−1 according to definition 2. Hence, according to definition 2,

$$W = \frac{1}{s} [ {e}_{{x}_{0}} , … , {e}_{{x}_{υ - 1}} ]$$

In one example, a TPMI index (I) indicating a precoding matrix is given by:
Definition 1: I=Σₚ₌₁⁸δ(p−1)2^{p-1}, where δ(p)=1 if a layer is to be transmitted on port p and δ(p)=0; otherwise,
Definition 2: I=Σₚ₌₀⁷δ(p)2^{p}, where δ(p)=1 if a layer is to be transmitted on port p and δ(p)=0.

In one example, a TPMI index (J) is J=I−1, where/is defined herein.

In one embodiment, a UE is configured with an UL codebook for 8 antenna ports, which includes NC precoders or precoding matrices. In one example, NC precoders can only be configured to a NC UE, i.e., to a UE that reports non-coherence as its capability. In one example, NC precoders can also be configured to a FC or PC UE, i.e., a UE that reports full-coherence or partial-coherence as its capability can be configured with an UL codebook for 8 antenna ports that includes (each of or a subset of) the NC precoders.

In one example, when rank r=1, an UL codebook for 8 antenna ports includes n₁=8 rank-1 NC precoding vectors eₓ_{₁} where x₁∈{1,2, . . . ,8} (definition 1) or x₁∈{0,1, . . . ,7} (definition 2). In one example, s=\sqrt{v}=\sqrt{1}=1. In one example, s=\sqrt{8}=2\sqrt{2}.

In one example, for rank 1, the mapping between TPMI index and port index is given by Table 14. Two examples of mapping are shown. In one example (A), the TPMI index=J₁. In one example (B), the TPMI index=I.

TABLE 14
port indices xᵢ associated with rank 1 precoding matrix/vector

| Example A | | Example B | | | |
|---|---|---|---|---|---|
| TPMI index | Index | Index | TPMI index | Port index xᵢ | |
| (J₁) | (I = 2^{p}) | (J₁) | (I = 2^{p}) | DEF1: i | DEF2: i |
| 0 | 1 | 0 | 1 | 1 | 0 |
| 1 | 2 | 1 | 2 | 2 | 1 |
| 2 | 4 | 2 | 4 | 3 | 2 |
| 3 | 8 | 3 | 8 | 4 | 3 |
| 4 | 16 | 4 | 16 | 5 | 4 |
| 5 | 32 | 5 | 32 | 6 | 5 |
| 6 | 64 | 6 | 64 | 7 | 6 |
| 7 | 128 | 7 | 128 | 8 | 7 |

In one example, when rank r=2, an UL codebook for 8 antenna ports includes n₂≥1 rank-2 NC precoding matrix/matrices. In one example, s=2\sqrt{2}. The value of n₂ is according to at least one of the following examples.
In one example,

$${n}_{2} = ( \begin{matrix}8 \\ 2\end{matrix} ) = 28 rank - 2$$

NC precoding matrices included. The two columns of each of the precoding matrices can be given by [eₓ_{₁}, eₓ_{₂}], where (x₁, x₂) is according to Table 15.
In one example,

$${n}_{2} = {n}_{2}^{{N}_{g} = 4} = {N}_{g} \times ( \begin{matrix}\frac{8}{{N}_{g}} \\ 2\end{matrix} ) = 4 rank - 2$$

precoding matrices based on N_{g}=4 antenna groups are included. The two columns of each of the 4 precoding matrices can be given by [eₓ_{₁}, eₓ_{₂}], where
for numbering A, (x₁, x₂)∈{(1,2), (3,4), (5,6), (7,8)}, (4 groups).
for numbering B, (x₁, x₂)∈{(1,5), (2,6), (3,7), (4,8)}, (4 groups).
In one example,

$${n}_{2} = {n}_{2}^{{N}_{g} = 2} = {N}_{g} \times ( \begin{matrix}\frac{8}{{N}_{g}} \\ 2\end{matrix} ) = 2 ( \begin{matrix}4 \\ 2\end{matrix} ) = 12 rank - 2$$

precoding matrices based on N_{g}=2 antenna groups are included. The two columns of each of the 12 precoding matrices can be given by [eₓ_{₁}, eₓ_{₂}], where
for numbering A, (x₁, x₂)∈{(1,2), (1,3), (1,4), (2,3), (2,4), (3,4)} (based on group 1) or {(5,6), (5,7), (5,8), (6,7), (6,7), (7,8)} (based on group 2),
for numbering B, (x₁, x₂)∈{(1,2), (1,5), (1,6), (2,5), (2,6), (5,6)} (based on group 1) or {(3,4), (3,7), (3,8), (4,7), (4,8), (7,8)} (based on group 2).
In one example, n₂=n₂^{N}^{_{g}}⁼⁴+n₂^{N}^{_{g}}⁼²=2=16 rank-2 precoding matrices based on N_{g}=4. and 2 antenna groups are included. The two columns of each of the precoding matrices can be given by [eₓ_{₁}, eₓ_{₂}], where (x₁, x₂) is according previous two examples.

TABLE 15
indices (x₁, x₂) associated with rank 2 precoding matrices

| Index (J₂) | x₁ | x₂ |
|---|---|---|
| 0 | 1 | 2 |
| 1 | 1 | 3 |
| 2 | 1 | 4 |
| 3 | 1 | 5 |
| 4 | 1 | 6 |
| 5 | 1 | 7 |
| 6 | 1 | 8 |
| 7 | 2 | 3 |
| 8 | 2 | 4 |
| 9 | 2 | 5 |
| 10 | 2 | 6 |
| 11 | 2 | 7 |
| 12 | 2 | 8 |
| 13 | 3 | 4 |
| 14 | 3 | 5 |
| 15 | 3 | 6 |
| 16 | 3 | 7 |
| 17 | 3 | 8 |
| 18 | 4 | 5 |
| 19 | 4 | 6 |
| 20 | 4 | 7 |
| 21 | 4 | 8 |
| 22 | 5 | 6 |
| 23 | 5 | 7 |
| 24 | 5 | 8 |
| 25 | 6 | 7 |
| 26 | 6 | 8 |
| 27 | 7 | 8 |

In one example, for rank 2, the mapping between Index (J₂) (and port indices (x₁, x₂), DEF1) in Table 15 and the index/is given by Table 16. In one example, the TPMI index=I. In one example, the TPMI index=k+J₂, where k=1+max (J₁).

TABLE 16
mapping between indices (x₁, x₂) and TPM index for rank v = 2

| Index (J₂) | 0 | 1 | 2 | 3 | 4 | 5 | 6 | 7 | 8 | 9 | 10 | 11 | 12 | 13 |
|---|---|---|---|---|---|---|---|---|---|---|---|---|---|---|
| Index (I) | 3 | 5 | 9 | 17 | 33 | 65 | 129 | 6 | 10 | 18 | 34 | 66 | 130 | 12 |

| Index (J₂) | 14 | 15 | 16 | 17 | 18 | 19 | 20 | 21 | 22 | 23 | 24 | 25 | 26 | 27 |
|---|---|---|---|---|---|---|---|---|---|---|---|---|---|---|
| Index (I) | 20 | 36 | 68 | 132 | 24 | 40 | 72 | 136 | 48 | 80 | 144 | 96 | 160 | 192 |

In one example, an UL codebook for 8 antenna ports includes n₃≥1 rank-3 NC precoding matrix/matrices. In one example, s=2\sqrt{2}.

In one example,

$${n}_{3} = ( \begin{matrix}8 \\ 3\end{matrix} ) = 56 rank - 3$$

NC precoding matrices are included. The three columns of each of the precoding matrices can be given by [eₓ_{₁}, eₓ_{₂}, eₓ_{₃}], where (x₁, x₂, x₃) is according to Table 17.

In one example,

$${n}_{3} = {n}_{3}^{{N}_{g} = 2} = {N}_{g} \times ( \begin{matrix}\frac{8}{{N}_{g}} \\ 3\end{matrix} ) = 8 rank - 3$$

precoding matrices based on N_{g}=2 antenna groups are included. The 3 columns of each of the 8 precoding matrices can be given by [eₓ_{₁}, eₓ_{₂}, eₓ_{₃}], where
for numbering A, (x₁, x₂, x₃)∈{(1,2,3), (1,2,4), (1,3,4), (2,3,4)}, (based on group 1) or {(5,6,7), (5,6,8), (5,7,8), (6,7,8)} (based on group 2),
for numbering B, (x₁, x₂, x₃)∈{(1,2,5), (1,2,6), (1,5,6), (2,5,6) (based on group 1) or {(3,4,7), (3,4,8), (3,7,8), (4,7,8)} (based on group 2).

In one example, n₃=2 rank-3 precoding matrices based on Rel. 15 rank-3 NC precoding matrix for 4 antenna ports are included.
for numbering A, (x₁, x₂, x₃)∈{(1,2,3), (5,6,7)},
for numbering B, (x₁, x₂, x₃)∈{(1,2,5), (3,4,6)}.

TABLE 17
indices (x₁, x₂, x₃) associated with rank 3 precoding matrices

| Index (J₃) | x₁ | x₂ | x₃ |
|---|---|---|---|
| 0 | 1 | 2 | 3 |
| 1 | 1 | 2 | 4 |
| 2 | 1 | 2 | 5 |
| 3 | 1 | 2 | 6 |
| 4 | 1 | 2 | 7 |
| 5 | 1 | 2 | 8 |
| 6 | 1 | 3 | 4 |
| 7 | 1 | 3 | 5 |
| 8 | 1 | 3 | 6 |
| 9 | 1 | 3 | 7 |
| 10 | 1 | 3 | 8 |
| 11 | 1 | 4 | 5 |
| 12 | 1 | 4 | 6 |
| 13 | 1 | 4 | 7 |
| 14 | 1 | 4 | 8 |
| 15 | 1 | 5 | 6 |
| 16 | 1 | 5 | 7 |
| 17 | 1 | 5 | 8 |
| 18 | 1 | 6 | 7 |
| 19 | 1 | 6 | 8 |
| 20 | 1 | 7 | 8 |
| 21 | 2 | 3 | 4 |
| 22 | 2 | 3 | 5 |
| 23 | 2 | 3 | 6 |
| 24 | 2 | 3 | 7 |
| 25 | 2 | 3 | 8 |
| 26 | 2 | 4 | 5 |
| 27 | 2 | 4 | 6 |
| 28 | 2 | 4 | 7 |
| 29 | 2 | 4 | 8 |
| 30 | 2 | 5 | 6 |
| 31 | 2 | 5 | 7 |
| 32 | 2 | 5 | 8 |
| 33 | 2 | 6 | 7 |
| 34 | 2 | 6 | 8 |
| 35 | 2 | 7 | 8 |
| 36 | 3 | 4 | 5 |
| 37 | 3 | 4 | 6 |
| 38 | 3 | 4 | 7 |
| 39 | 3 | 4 | 8 |
| 40 | 3 | 5 | 6 |
| 41 | 3 | 5 | 7 |
| 42 | 3 | 5 | 8 |
| 43 | 3 | 6 | 7 |
| 44 | 3 | 6 | 8 |
| 45 | 3 | 7 | 8 |
| 46 | 4 | 5 | 6 |
| 47 | 4 | 5 | 7 |
| 48 | 4 | 5 | 8 |
| 49 | 4 | 6 | 7 |
| 50 | 4 | 6 | 8 |
| 51 | 4 | 7 | 8 |
| 52 | 5 | 6 | 7 |
| 53 | 5 | 6 | 8 |
| 54 | 5 | 7 | 8 |
| 55 | 6 | 7 | 8 |

In one example, for rank 3, the mapping between Index (J₃) (and port indices (x₁,x₂, x₃), DEF1) in Table 17 and the index/is given by Table 18. In one example, the TPMI index=I. In one example, the TPMI index=k+J₃, where k=1+max (J₂).

TABLE 18
mapping between indices (x₁, x₂, x₃) and TPM index for rank 3

| Index (J₃) | 0 | 1 | 2 | 3 | 4 | 5 | 6 | 7 | 8 | 9 | 10 | 11 | 12 | 13 |
|---|---|---|---|---|---|---|---|---|---|---|---|---|---|---|
| Index (I) | 7 | 11 | 19 | 35 | 67 | 131 | 13 | 21 | 37 | 69 | 133 | 25 | 41 | 73 |

| Index (J₃) | 14 | 15 | 16 | 17 | 18 | 19 | 20 | 21 | 22 | 23 | 24 | 25 | 26 | 27 |
|---|---|---|---|---|---|---|---|---|---|---|---|---|---|---|
| Index (I) | 137 | 49 | 81 | 145 | 97 | 161 | 193 | 14 | 22 | 38 | 70 | 134 | 26 | 42 |

| Index (J₃) | 28 | 29 | 30 | 31 | 32 | 33 | 34 | 35 | 36 | 37 | 38 | 39 | 40 | 41 |
|---|---|---|---|---|---|---|---|---|---|---|---|---|---|---|
| Index (I) | 74 | 138 | 50 | 82 | 146 | 98 | 162 | 194 | 28 | 44 | 76 | 140 | 52 | 84 |

| Index (J₃) | 42 | 43 | 44 | 45 | 46 | 47 | 48 | 49 | 50 | 51 | 52 | 53 | 54 | 55 |
|---|---|---|---|---|---|---|---|---|---|---|---|---|---|---|
| Index (I) | 148 | 100 | 164 | 196 | 56 | 88 | 152 | 104 | 168 | 200 | 112 | 176 | 208 | 224 |

In one example, an UL codebook for 8 antenna ports includes n₄≥1 rank-4 NC precoding matrix/matrices. In one example, s=2\sqrt{2}.

In one example,

$${n}_{4} = ( \begin{matrix}8 \\ 4\end{matrix} ) = 70 rank - 4$$

NC precoding matrices are included. The 4 columns of each of the precoding matrices can be given by [eₓ_{₂}, . . . , eₓ_{₄}], where (x₁, . . . , x₄) is according to Table 19.

In one example, n₄=2 rank-4 precoding matrices based on Rel.15 rank-4 NC precoding matrix for 4 antenna ports are included.
for numbering A, (x₁, x₂, x₃, x₄)∈{(1,2,3,4), (5,6,7,8)}.
for numbering B, (x₁, x₂, x₃, x₄)∈{1,2,5,6), (3,4,7,8).

TABLE 19
indices (x₁, x₂, x₃, x₄) associated with rank 4 precoding matrices

| Index (J₄) | x₁ | x₂ | x₃ | x₄ |
|---|---|---|---|---|
| 0 | 1 | 2 | 3 | 4 |
| 1 | 1 | 2 | 3 | 5 |
| 2 | 1 | 2 | 3 | 6 |
| 3 | 1 | 2 | 3 | 7 |
| 4 | 1 | 2 | 3 | 8 |
| 5 | 1 | 2 | 4 | 5 |
| 6 | 1 | 2 | 4 | 6 |
| 7 | 1 | 2 | 4 | 7 |
| 8 | 1 | 2 | 4 | 8 |
| 9 | 1 | 2 | 5 | 6 |
| 10 | 1 | 2 | 5 | 7 |
| 11 | 1 | 2 | 5 | 8 |
| 12 | 1 | 2 | 6 | 7 |
| 13 | 1 | 2 | 6 | 8 |
| 14 | 1 | 2 | 7 | 8 |
| 15 | 1 | 3 | 4 | 5 |
| 16 | 1 | 3 | 4 | 6 |
| 17 | 1 | 3 | 4 | 7 |
| 18 | 1 | 3 | 4 | 8 |
| 19 | 1 | 3 | 5 | 6 |
| 20 | 1 | 3 | 5 | 7 |
| 21 | 1 | 3 | 5 | 8 |
| 22 | 1 | 3 | 6 | 7 |
| 23 | 1 | 3 | 6 | 8 |
| 24 | 1 | 3 | 7 | 8 |
| 25 | 1 | 4 | 5 | 6 |
| 26 | 1 | 4 | 5 | 7 |
| 27 | 1 | 4 | 5 | 8 |
| 28 | 1 | 4 | 6 | 7 |
| 29 | 1 | 4 | 6 | 8 |
| 30 | 1 | 4 | 7 | 8 |
| 31 | 1 | 5 | 6 | 7 |
| 32 | 1 | 5 | 6 | 8 |
| 33 | 1 | 5 | 7 | 8 |
| 34 | 1 | 6 | 7 | 8 |
| 35 | 2 | 3 | 4 | 5 |
| 36 | 2 | 3 | 4 | 6 |
| 37 | 2 | 3 | 4 | 7 |
| 38 | 2 | 3 | 4 | 8 |
| 39 | 2 | 3 | 5 | 6 |
| 40 | 2 | 3 | 5 | 7 |
| 41 | 2 | 3 | 5 | 8 |
| 42 | 2 | 3 | 6 | 7 |
| 43 | 2 | 3 | 6 | 8 |
| 44 | 2 | 3 | 7 | 8 |
| 45 | 2 | 4 | 5 | 6 |
| 46 | 2 | 4 | 5 | 7 |
| 47 | 2 | 4 | 5 | 8 |
| 48 | 2 | 4 | 6 | 7 |
| 49 | 2 | 4 | 6 | 8 |
| 50 | 2 | 4 | 7 | 8 |
| 51 | 2 | 5 | 6 | 7 |
| 52 | 2 | 5 | 6 | 8 |
| 53 | 2 | 5 | 7 | 8 |
| 54 | 2 | 6 | 7 | 8 |
| 55 | 3 | 4 | 5 | 6 |
| 56 | 3 | 4 | 5 | 7 |
| 57 | 3 | 4 | 5 | 8 |
| 58 | 3 | 4 | 6 | 7 |
| 59 | 3 | 4 | 6 | 8 |
| 60 | 3 | 4 | 7 | 8 |
| 61 | 3 | 5 | 6 | 7 |
| 62 | 3 | 5 | 6 | 8 |
| 63 | 3 | 5 | 7 | 8 |
| 64 | 3 | 6 | 7 | 8 |
| 65 | 4 | 5 | 6 | 7 |
| 66 | 4 | 5 | 6 | 8 |
| 67 | 4 | 5 | 7 | 8 |
| 68 | 4 | 6 | 7 | 8 |
| 69 | 5 | 6 | 7 | 8 |

In one example, for rank 4, the mapping between Index (J₄) (and port indices (x₁, x₂, x₃, x₄), DEF1) in Table 19 and the index/is given by Table 20. In one example, the TPMI index=1. In one example, the TPMI index=k+J₄, where k=1+max (J₃).

TABLE 20
mapping between indices (x₁, x₂, x₃, x₄) and TPM index for rank 4

| Index (J₄) | x₁ | x₂ | x₃ | x₄ | Index (I) |
|---|---|---|---|---|---|
| 0 | 1 | 2 | 3 | 4 | 15 |
| 1 | 1 | 2 | 3 | 5 | 23 |
| 2 | 1 | 2 | 3 | 6 | 39 |
| 3 | 1 | 2 | 3 | 7 | 71 |
| 4 | 1 | 2 | 3 | 8 | 135 |
| 5 | 1 | 2 | 4 | 5 | 27 |
| 6 | 1 | 2 | 4 | 6 | 43 |
| 7 | 1 | 2 | 4 | 7 | 75 |
| 8 | 1 | 2 | 4 | 8 | 139 |
| 9 | 1 | 2 | 5 | 6 | 51 |
| 10 | 1 | 2 | 5 | 7 | 83 |
| 11 | 1 | 2 | 5 | 8 | 147 |
| 12 | 1 | 2 | 6 | 7 | 99 |
| 13 | 1 | 2 | 6 | 8 | 163 |
| 14 | 1 | 2 | 7 | 8 | 195 |
| 15 | 1 | 3 | 4 | 5 | 29 |
| 16 | 1 | 3 | 4 | 6 | 45 |
| 17 | 1 | 3 | 4 | 7 | 77 |
| 18 | 1 | 3 | 4 | 8 | 141 |
| 19 | 1 | 3 | 5 | 6 | 53 |
| 20 | 1 | 3 | 5 | 7 | 85 |
| 21 | 1 | 3 | 5 | 8 | 149 |
| 22 | 1 | 3 | 6 | 7 | 101 |
| 23 | 1 | 3 | 6 | 8 | 165 |
| 24 | 1 | 3 | 7 | 8 | 197 |
| 25 | 1 | 4 | 5 | 6 | 57 |
| 26 | 1 | 4 | 5 | 7 | 89 |
| 27 | 1 | 4 | 5 | 8 | 153 |
| 28 | 1 | 4 | 6 | 7 | 105 |
| 29 | 1 | 4 | 6 | 8 | 169 |
| 30 | 1 | 4 | 7 | 8 | 201 |
| 31 | 1 | 5 | 6 | 7 | 113 |
| 32 | 1 | 5 | 6 | 8 | 177 |
| 33 | 1 | 5 | 7 | 8 | 209 |
| 34 | 1 | 6 | 7 | 8 | 225 |
| 35 | 2 | 3 | 4 | 5 | 30 |
| 36 | 2 | 3 | 4 | 6 | 46 |
| 37 | 2 | 3 | 4 | 7 | 78 |
| 38 | 2 | 3 | 4 | 8 | 142 |
| 39 | 2 | 3 | 5 | 6 | 54 |
| 40 | 2 | 3 | 5 | 7 | 86 |
| 41 | 2 | 3 | 5 | 8 | 150 |
| 42 | 2 | 3 | 6 | 7 | 102 |
| 43 | 2 | 3 | 6 | 8 | 166 |
| 44 | 2 | 3 | 7 | 8 | 198 |
| 45 | 2 | 4 | 5 | 6 | 58 |
| 46 | 2 | 4 | 5 | 7 | 90 |
| 47 | 2 | 4 | 5 | 8 | 154 |
| 48 | 2 | 4 | 6 | 7 | 106 |
| 49 | 2 | 4 | 6 | 8 | 170 |
| 50 | 2 | 4 | 7 | 8 | 202 |
| 51 | 2 | 5 | 6 | 7 | 114 |
| 52 | 2 | 5 | 6 | 8 | 178 |
| 53 | 2 | 5 | 7 | 8 | 210 |
| 54 | 2 | 6 | 7 | 8 | 226 |
| 55 | 3 | 4 | 5 | 6 | 60 |
| 56 | 3 | 4 | 5 | 7 | 92 |
| 57 | 3 | 4 | 5 | 8 | 156 |
| 58 | 3 | 4 | 6 | 7 | 108 |
| 59 | 3 | 4 | 6 | 8 | 172 |
| 60 | 3 | 4 | 7 | 8 | 204 |
| 61 | 3 | 5 | 6 | 7 | 116 |
| 62 | 3 | 5 | 6 | 8 | 180 |
| 63 | 3 | 5 | 7 | 8 | 212 |
| 64 | 3 | 6 | 7 | 8 | 228 |
| 65 | 4 | 5 | 6 | 7 | 120 |
| 66 | 4 | 5 | 6 | 8 | 184 |
| 67 | 4 | 5 | 7 | 8 | 216 |
| 68 | 4 | 6 | 7 | 8 | 232 |
| 69 | 5 | 6 | 7 | 8 | 240 |

In one example, an UL codebook for 8 antenna ports includes n₅≥1 rank-5 NC precoding matrix/matrices. In one example, s=2\sqrt{2}.

In one example.

$${n}_{5} = ( \begin{matrix}8 \\ 5\end{matrix} ) = 56 rank - 5$$

NC precoding matrices are included. The 5 columns of each of the precoding matrices can be given by [eₓ_{₁}, . . . , eₓ_{₅}], where (x₁, . . . , x₅) is according to Table 21.

TABLE 21
indices (x₁, x₂, . . . , x₅) associated with rank 5 precoding matrices

| Index (J₅) | x₁ | x₂ | x₃ | x₄ | x₅ |
|---|---|---|---|---|---|
| 0 | 1 | 2 | 3 | 4 | 5 |
| 1 | 1 | 2 | 3 | 4 | 6 |
| 2 | 1 | 2 | 3 | 4 | 7 |
| 3 | 1 | 2 | 3 | 4 | 8 |
| 4 | 1 | 2 | 3 | 5 | 6 |
| 5 | 1 | 2 | 3 | 5 | 7 |
| 6 | 1 | 2 | 3 | 5 | 8 |
| 7 | 1 | 2 | 3 | 6 | 7 |
| 8 | 1 | 2 | 3 | 6 | 8 |
| 9 | 1 | 2 | 3 | 7 | 8 |
| 10 | 1 | 2 | 4 | 5 | 6 |
| 11 | 1 | 2 | 4 | 5 | 7 |
| 12 | 1 | 2 | 4 | 5 | 8 |
| 13 | 1 | 2 | 4 | 6 | 7 |
| 14 | 1 | 2 | 4 | 6 | 8 |
| 15 | 1 | 2 | 4 | 7 | 8 |
| 16 | 1 | 2 | 5 | 6 | 7 |
| 17 | 1 | 2 | 5 | 6 | 8 |
| 18 | 1 | 2 | 5 | 7 | 8 |
| 19 | 1 | 2 | 6 | 7 | 8 |
| 20 | 1 | 3 | 4 | 5 | 6 |
| 21 | 1 | 3 | 4 | 5 | 7 |
| 22 | 1 | 3 | 4 | 5 | 8 |
| 23 | 1 | 3 | 4 | 6 | 7 |
| 24 | 1 | 3 | 4 | 6 | 8 |
| 25 | 1 | 3 | 4 | 7 | 8 |
| 26 | 1 | 3 | 5 | 6 | 7 |
| 27 | 1 | 3 | 5 | 6 | 8 |
| 28 | 1 | 3 | 5 | 7 | 8 |
| 29 | 1 | 3 | 6 | 7 | 8 |
| 30 | 1 | 4 | 5 | 6 | 7 |
| 31 | 1 | 4 | 5 | 6 | 8 |
| 32 | 1 | 4 | 5 | 7 | 8 |
| 33 | 1 | 4 | 6 | 7 | 8 |
| 34 | 1 | 5 | 6 | 7 | 8 |
| 35 | 2 | 3 | 4 | 5 | 6 |
| 36 | 2 | 3 | 4 | 5 | 7 |
| 37 | 2 | 3 | 4 | 5 | 8 |
| 38 | 2 | 3 | 4 | 6 | 7 |
| 39 | 2 | 3 | 4 | 6 | 8 |
| 40 | 2 | 3 | 4 | 7 | 8 |
| 41 | 2 | 3 | 5 | 6 | 7 |
| 42 | 2 | 3 | 5 | 6 | 8 |
| 43 | 2 | 3 | 5 | 7 | 8 |
| 44 | 2 | 3 | 6 | 7 | 8 |
| 45 | 2 | 4 | 5 | 6 | 7 |
| 46 | 2 | 4 | 5 | 6 | 8 |
| 47 | 2 | 4 | 5 | 7 | 8 |
| 48 | 2 | 4 | 6 | 7 | 8 |
| 49 | 2 | 5 | 6 | 7 | 8 |
| 50 | 3 | 4 | 5 | 6 | 7 |
| 51 | 3 | 4 | 5 | 6 | 8 |
| 52 | 3 | 4 | 5 | 7 | 8 |
| 53 | 3 | 4 | 6 | 7 | 8 |
| 54 | 3 | 5 | 6 | 7 | 8 |
| 55 | 4 | 5 | 6 | 7 | 8 |

In one example, for rank 5, the mapping between Index (J) (and port indices (x₁, x₂, x₃, x₄, x₅), DEF1) in Table 21 and the index/is given by Table 22. In one example, the TPMI index=I. In one example, the TPMI index=k+J₅, where k=1+max (J₄).

TABLE 22
indices (x₁, x₂, . . . , x₅) associated with rank 5 precoding matrices

| Index (J₅) | x₁ | x₂ | x₃ | x₄ | x₅ | Index (I) |
|---|---|---|---|---|---|---|
| 0 | 1 | 2 | 3 | 4 | 5 | 31 |
| 1 | 1 | 2 | 3 | 4 | 6 | 47 |
| 2 | 1 | 2 | 3 | 4 | 7 | 79 |
| 3 | 1 | 2 | 3 | 4 | 8 | 143 |
| 4 | 1 | 2 | 3 | 5 | 6 | 55 |
| 5 | 1 | 2 | 3 | 5 | 7 | 87 |
| 6 | 1 | 2 | 3 | 5 | 8 | 151 |
| 7 | 1 | 2 | 3 | 6 | 7 | 103 |
| 8 | 1 | 2 | 3 | 6 | 8 | 167 |
| 9 | 1 | 2 | 3 | 7 | 8 | 199 |
| 10 | 1 | 2 | 4 | 5 | 6 | 59 |
| 11 | 1 | 2 | 4 | 5 | 7 | 91 |
| 12 | 1 | 2 | 4 | 5 | 8 | 155 |
| 13 | 1 | 2 | 4 | 6 | 7 | 107 |
| 14 | 1 | 2 | 4 | 6 | 8 | 171 |
| 15 | 1 | 2 | 4 | 7 | 8 | 203 |
| 16 | 1 | 2 | 5 | 6 | 7 | 115 |
| 17 | 1 | 2 | 5 | 6 | 8 | 179 |
| 18 | 1 | 2 | 5 | 7 | 8 | 211 |
| 19 | 1 | 2 | 6 | 7 | 8 | 227 |
| 20 | 1 | 3 | 4 | 5 | 6 | 61 |
| 21 | 1 | 3 | 4 | 5 | 7 | 93 |
| 22 | 1 | 3 | 4 | 5 | 8 | 157 |
| 23 | 1 | 3 | 4 | 6 | 7 | 109 |
| 24 | 1 | 3 | 4 | 6 | 8 | 173 |
| 25 | 1 | 3 | 4 | 7 | 8 | 205 |
| 26 | 1 | 3 | 5 | 6 | 7 | 117 |
| 27 | 1 | 3 | 5 | 6 | 8 | 181 |
| 28 | 1 | 3 | 5 | 7 | 8 | 213 |
| 29 | 1 | 3 | 6 | 7 | 8 | 229 |
| 30 | 1 | 4 | 5 | 6 | 7 | 121 |
| 31 | 1 | 4 | 5 | 6 | 8 | 185 |
| 32 | 1 | 4 | 5 | 7 | 8 | 217 |
| 33 | 1 | 4 | 6 | 7 | 8 | 233 |
| 34 | 1 | 5 | 6 | 7 | 8 | 241 |
| 35 | 2 | 3 | 4 | 5 | 6 | 62 |
| 36 | 2 | 3 | 4 | 5 | 7 | 94 |
| 37 | 2 | 3 | 4 | 5 | 8 | 158 |
| 38 | 2 | 3 | 4 | 6 | 7 | 110 |
| 39 | 2 | 3 | 4 | 6 | 8 | 174 |
| 40 | 2 | 3 | 4 | 7 | 8 | 206 |
| 41 | 2 | 3 | 5 | 6 | 7 | 118 |
| 42 | 2 | 3 | 5 | 6 | 8 | 182 |
| 43 | 2 | 3 | 5 | 7 | 8 | 214 |
| 44 | 2 | 3 | 6 | 7 | 8 | 230 |
| 45 | 2 | 4 | 5 | 6 | 7 | 122 |
| 46 | 2 | 4 | 5 | 6 | 8 | 186 |
| 47 | 2 | 4 | 5 | 7 | 8 | 218 |
| 48 | 2 | 4 | 6 | 7 | 8 | 234 |
| 49 | 2 | 5 | 6 | 7 | 8 | 242 |
| 50 | 3 | 4 | 5 | 6 | 7 | 124 |
| 51 | 3 | 4 | 5 | 6 | 8 | 188 |
| 52 | 3 | 4 | 5 | 7 | 8 | 220 |
| 53 | 3 | 4 | 6 | 7 | 8 | 236 |
| 54 | 3 | 5 | 6 | 7 | 8 | 244 |
| 55 | 4 | 5 | 6 | 7 | 8 | 248 |

In one example, an UL codebook for 8 antenna ports includes n₆≥1 rank-6 NC precoding matrix/matrices. In one example, s=2\sqrt{2}.

In one example,

$${n}_{6} = ( \begin{matrix}8 \\ 6\end{matrix} ) = 28 rank - 6$$

NC precoding matrices are included. The 6 columns of each of the precoding matrices can be given by [eₓ_{₁}, . . . eₓ_{₆}], where (x₁, . . . , x₆) is according to Table 23.

TABLE 23
indices (x₁, x₂, . . . , x₆) associated with rank 6 precoding matrices

| Index (J₆) | x₁ | x₂ | x₃ | x₄ | x₅ | x₆ |
|---|---|---|---|---|---|---|
| 0 | 1 | 2 | 3 | 4 | 5 | 6 |
| 1 | 1 | 2 | 3 | 4 | 5 | 7 |
| 2 | 1 | 2 | 3 | 4 | 5 | 8 |
| 3 | 1 | 2 | 3 | 4 | 6 | 7 |
| 4 | 1 | 2 | 3 | 4 | 6 | 8 |
| 5 | 1 | 2 | 3 | 4 | 7 | 8 |
| 6 | 1 | 2 | 3 | 5 | 6 | 7 |
| 7 | 1 | 2 | 3 | 5 | 6 | 8 |
| 8 | 1 | 2 | 3 | 5 | 7 | 8 |
| 9 | 1 | 2 | 3 | 6 | 7 | 8 |
| 10 | 1 | 2 | 4 | 5 | 6 | 7 |
| 11 | 1 | 2 | 4 | 5 | 6 | 8 |
| 12 | 1 | 2 | 4 | 5 | 7 | 8 |
| 13 | 1 | 2 | 4 | 6 | 7 | 8 |
| 14 | 1 | 2 | 5 | 6 | 7 | 8 |
| 15 | 1 | 3 | 4 | 5 | 6 | 7 |
| 16 | 1 | 3 | 4 | 5 | 6 | 8 |
| 17 | 1 | 3 | 4 | 5 | 7 | 8 |
| 18 | 1 | 3 | 4 | 6 | 7 | 8 |
| 19 | 1 | 3 | 5 | 6 | 7 | 8 |
| 20 | 1 | 4 | 5 | 6 | 7 | 8 |
| 21 | 2 | 3 | 4 | 5 | 6 | 7 |
| 22 | 2 | 3 | 4 | 5 | 6 | 8 |
| 23 | 2 | 3 | 4 | 5 | 7 | 8 |
| 24 | 2 | 3 | 4 | 6 | 7 | 8 |
| 25 | 2 | 3 | 5 | 6 | 7 | 8 |
| 26 | 2 | 4 | 5 | 6 | 7 | 8 |
| 27 | 3 | 4 | 5 | 6 | 7 | 8 |

In one example, for rank 6, the mapping between Index (J₆) (and port indices (x₁, x₂, . . . , x₆), DEF1) in Table 23 and the index/is given by Table 24. In one example, the TPMI index=I. In one example, the TPMI index=k+J₆, where k=1+max (J₅).

TABLE 24
indices (x₁, x₂, . . . , x₆) associated with rank 6 precoding matrices

| Index (J₆) | x₁ | x₂ | x₃ | x₄ | x₅ | x₆ | Index (I) |
|---|---|---|---|---|---|---|---|
| 0 | 1 | 2 | 3 | 4 | 5 | 6 | 63 |
| 1 | 1 | 2 | 3 | 4 | 5 | 7 | 95 |
| 2 | 1 | 2 | 3 | 4 | 5 | 8 | 159 |
| 3 | 1 | 2 | 3 | 4 | 6 | 7 | 111 |
| 4 | 1 | 2 | 3 | 4 | 6 | 8 | 175 |
| 5 | 1 | 2 | 3 | 4 | 7 | 8 | 207 |
| 6 | 1 | 2 | 3 | 5 | 6 | 7 | 119 |
| 7 | 1 | 2 | 3 | 5 | 6 | 8 | 183 |
| 8 | 1 | 2 | 3 | 5 | 7 | 8 | 215 |
| 9 | 1 | 2 | 3 | 6 | 7 | 8 | 231 |
| 10 | 1 | 2 | 4 | 5 | 6 | 7 | 123 |
| 11 | 1 | 2 | 4 | 5 | 6 | 8 | 187 |
| 12 | 1 | 2 | 4 | 5 | 7 | 8 | 219 |
| 13 | 1 | 2 | 4 | 6 | 7 | 8 | 235 |
| 14 | 1 | 2 | 5 | 6 | 7 | 8 | 243 |
| 15 | 1 | 3 | 4 | 5 | 6 | 7 | 125 |
| 16 | 1 | 3 | 4 | 5 | 6 | 8 | 189 |
| 17 | 1 | 3 | 4 | 5 | 7 | 8 | 221 |
| 18 | 1 | 3 | 4 | 6 | 7 | 8 | 237 |
| 19 | 1 | 3 | 5 | 6 | 7 | 8 | 245 |
| 20 | 1 | 4 | 5 | 6 | 7 | 8 | 249 |
| 21 | 2 | 3 | 4 | 5 | 6 | 7 | 126 |
| 22 | 2 | 3 | 4 | 5 | 6 | 8 | 190 |
| 23 | 2 | 3 | 4 | 5 | 7 | 8 | 222 |
| 24 | 2 | 3 | 4 | 6 | 7 | 8 | 238 |
| 25 | 2 | 3 | 5 | 6 | 7 | 8 | 246 |
| 26 | 2 | 4 | 5 | 6 | 7 | 8 | 250 |
| 27 | 3 | 4 | 5 | 6 | 7 | 8 | 252 |

In one example, an UL codebook for 8 antenna ports includes n₆≥1 rank-6 NC precoding matrix/matrices from Table 25. In one example, s=2\sqrt{2}.
In one example, n₆=1, and the rank 6 NC precoding matrix is Example A_{6,5} or A_{6,12}.
In one example, n₆=2, and the rank 6 NC precoding matrix are Examples (A_{6,x}_{₁}, A_{6,x}_{₂}), where (x₁,x₂) is one of (1,5), (1,6), (1,7), (1,12), (5,6), (5,7), (5,12), (6,7), (6,12), (7,12).
In one example, n₆=6, and the rank 6 NC precoding matrix are examples (A_{6,1}, . . . , A_{6,6}).
In one example, n₆=6, and the rank 6 NC precoding matrix are examples (A_{6,7}, . . . , A_{6,12}).
In one example, n₆=12, and the rank 6 NC precoding matrix are examples (A_{6,1}, . . . , A_{6,12}).
In one example, n₆=8, and the rank 6 NC precoding matrix are examples (A_{6,13}, . . . , A_{6,20}).
In one example, n₆=20, and the rank 6 NC precoding matrix are examples (A_{6,1}, A_{6,2}, . . . , A_{6,20}).

TABLE 25

| Example | A_{6,1} | A_{6,2} | A_{6,3} | A_{6,4} | A_{6,5} | A_{6,6} |
|---|---|---|---|---|---|---|
| 2 of ports, or row index {1, 4, 5, 8} is not selected (i.e., is zero) | $\frac{1}{s} [ \begin{matrix}0 & 0 & 0 & 0 & 0 & 0 \\ 1 & 0 & 0 & 0 & 0 & 0 \\ 0 & 1 & 0 & 0 & 0 & 0 \\ 0 & 0 & 0 & 0 & 0 & 0 \\ 0 & 0 & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1\end{matrix} ]$ | $\frac{1}{s} [ \begin{matrix}0 & 0 & 0 & 0 & 0 & 0 \\ 1 & 0 & 0 & 0 & 0 & 0 \\ 0 & 1 & 0 & 0 & 0 & 0 \\ 0 & 0 & 1 & 0 & 0 & 0 \\ 0 & 0 & 0 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1\end{matrix} ]$ | $\frac{1}{s} [ \begin{matrix}0 & 0 & 0 & 0 & 0 & 0 \\ 1 & 0 & 0 & 0 & 0 & 0 \\ 0 & 1 & 0 & 0 & 0 & 0 \\ 0 & 0 & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1 \\ 0 & 0 & 0 & 0 & 0 & 0\end{matrix} ]$ | $\frac{1}{s} [ \begin{matrix}1 & 0 & 0 & 0 & 0 & 0 \\ 0 & 1 & 0 & 0 & 0 & 0 \\ 0 & 0 & 1 & 0 & 0 & 0 \\ 0 & 0 & 0 & 0 & 0 & 0 \\ 0 & 0 & 0 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1\end{matrix} ]$ | $\frac{1}{s} [ \begin{matrix}1 & 0 & 0 & 0 & 0 & 0 \\ 0 & 1 & 0 & 0 & 0 & 0 \\ 0 & 0 & 1 & 0 & 0 & 0 \\ 0 & 0 & 0 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1 \\ 0 & 0 & 0 & 0 & 0 & 0\end{matrix} ]$ | $\frac{1}{s} [ \begin{matrix}1 & 0 & 0 & 0 & 0 & 0 \\ 0 & 1 & 0 & 0 & 0 & 0 \\ 0 & 0 & 1 & 0 & 0 & 0 \\ 0 & 0 & 0 & 1 & 0 & 0 \\ 0 & 0 & 0 & 0 & 0 & 0 \\ 0 & 0 & 0 & 0 & 1 & 0 \\ 0 & 0 & 0 & 0 & 0 & 1 \\ 0 & 0 & 0 & 0 & 0 & 0\end{matrix} ]$ |
| | (port 1, 4 not | (port 1, 5 not | (port 1, 8 not | (port 4, 5 not | (port 4, 8 not | (port 5, 8 not |
| | selected) | selected) | selected) | selected) | selected) | selected) |
| | A_{6,7} | A_{6,8} | A_{6,9} | A_{6,10} | A_{6,11} | A_{6,12} |
| 2 of ports, or row index {1, 2, 7, 8} is not selected (i.e., is zero) | $\frac{1}{s} [ \begin{matrix}0 & 0 & 0 & 0 & 0 & 0 \\ 0 & 0 & 0 & 0 & 0 & 0 \\ 1 & 0 & 0 & 0 & 0 & 0 \\ 0 & 1 & 0 & 0 & 0 & 0 \\ 0 & 0 & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1\end{matrix} ]$ | $\frac{1}{s} [ \begin{matrix}0 & 0 & 0 & 0 & 0 & 0 \\ 1 & 0 & 0 & 0 & 0 & 0 \\ 0 & 1 & 0 & 0 & 0 & 0 \\ 0 & 0 & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 0 \\ 0 & 0 & 0 & 0 & 0 & 1\end{matrix} ]$ | $\frac{1}{s} [ \begin{matrix}0 & 0 & 0 & 0 & 0 & 0 \\ 1 & 0 & 0 & 0 & 0 & 0 \\ 0 & 1 & 0 & 0 & 0 & 0 \\ 0 & 0 & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1 \\ 0 & 0 & 0 & 0 & 0 & 0\end{matrix} ]$ | $\frac{1}{s} [ \begin{matrix}1 & 0 & 0 & 0 & 0 & 0 \\ 0 & 0 & 0 & 0 & 0 & 0 \\ 0 & 1 & 0 & 0 & 0 & 0 \\ 0 & 0 & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 0 \\ 0 & 0 & 0 & 0 & 0 & 1\end{matrix} ]$ | $\frac{1}{s} [ \begin{matrix}1 & 0 & 0 & 0 & 0 & 0 \\ 0 & 0 & 0 & 0 & 0 & 0 \\ 0 & 1 & 0 & 0 & 0 & 0 \\ 0 & 0 & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1 \\ 0 & 0 & 0 & 0 & 0 & 0\end{matrix} ]$ | $\frac{1}{s} [ \begin{matrix}1 & 0 & 0 & 0 & 0 & 0 \\ 0 & 1 & 0 & 0 & 0 & 0 \\ 0 & 0 & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1 \\ 0 & 0 & 0 & 0 & 0 & 0 \\ 0 & 0 & 0 & 0 & 0 & 0\end{matrix} ]$ |
| | (port 1, 2 not | (port 1, 7 not | (port 1, 8 not | (port 2, 7 not | (port 2, 8 not | (port 7, 8 not |
| | selected) | selected) | selected) | selected) | selected) | selected) |
| | A_{6,13} | A_{6,14} | A_{6,15} | A_{6,16} | A_{6,17} | A_{6,18} |
| | $\frac{1}{s} [ \begin{matrix}1 & 0 & 0 & 0 & 0 & 0 \\ 0 & 1 & 0 & 0 & 0 & 0 \\ 0 & 0 & 0 & 0 & 0 & 0 \\ 0 & 0 & 0 & 0 & 0 & 0 \\ 0 & 0 & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1\end{matrix} ]$ | $\frac{1}{s} [ \begin{matrix}1 & 0 & 0 & 0 & 0 & 0 \\ 0 & 0 & 0 & 0 & 0 & 0 \\ 0 & 1 & 0 & 0 & 0 & 0 \\ 0 & 0 & 0 & 0 & 0 & 0 \\ 0 & 0 & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1\end{matrix} ]$ | $\frac{1}{s} [ \begin{matrix}1 & 0 & 0 & 0 & 0 & 0 \\ 0 & 0 & 0 & 0 & 0 & 0 \\ 0 & 0 & 0 & 0 & 0 & 0 \\ 0 & 1 & 0 & 0 & 0 & 0 \\ 0 & 0 & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1\end{matrix} ]$ | $\frac{1}{s} [ \begin{matrix}0 & 0 & 0 & 0 & 0 & 0 \\ 1 & 0 & 0 & 0 & 0 & 0 \\ 0 & 0 & 0 & 0 & 0 & 0 \\ 0 & 1 & 0 & 0 & 0 & 0 \\ 0 & 0 & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1\end{matrix} ]$ | $\frac{1}{s} [ \begin{matrix}1 & 0 & 0 & 0 & 0 & 0 \\ 0 & 1 & 0 & 0 & 0 & 0 \\ 0 & 0 & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 0 \\ 0 & 0 & 0 & 0 & 0 & 1 \\ 0 & 0 & 0 & 0 & 0 & 0\end{matrix} ]$ | $\frac{1}{s} [ \begin{matrix}1 & 0 & 0 & 0 & 0 & 0 \\ 0 & 1 & 0 & 0 & 0 & 0 \\ 0 & 0 & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 0 \\ 0 & 0 & 0 & 0 & 0 & 0 \\ 0 & 0 & 0 & 0 & 0 & 1\end{matrix} ]$ |
| | (port 3, 4 not | (port 2, 4 not | (port 2, 3 not | (port 1, 3 not | (port 6, 8 not | |
| | selected) | selected) | selected) | selected) | selected) | |
| | A_{6,19} | A_{6,20} | | | | |
| | $\frac{1}{s} [ \begin{matrix}1 & 0 & 0 & 0 & 0 & 0 \\ 0 & 1 & 0 & 0 & 0 & 0 \\ 0 & 0 & 1 & 0 & 0 & 0 \\ 0 & 0 & 0 & 1 & 0 & 0 \\ 0 & 0 & 0 & 0 & 0 & 0 \\ 0 & 0 & 0 & 0 & 1 & 0 \\ 0 & 0 & 0 & 0 & 0 & 0 \\ 0 & 0 & 0 & 0 & 0 & 1\end{matrix} ]$ | $\frac{1}{s} [ \begin{matrix}1 & 0 & 0 & 0 & 0 & 0 \\ 0 & 1 & 0 & 0 & 0 & 0 \\ 0 & 0 & 1 & 0 & 0 & 0 \\ 0 & 0 & 0 & 1 & 0 & 0 \\ 0 & 0 & 0 & 0 & 0 & 0 \\ 0 & 0 & 0 & 0 & 0 & 0 \\ 0 & 0 & 0 & 0 & 1 & 0 \\ 0 & 0 & 0 & 0 & 0 & 1\end{matrix} ]$ | | | | |

In one example, an UL codebook for 8 antenna ports includes n₇≥1 rank-7 NC precoding matrix/matrices. In one example, s=2\sqrt{2}.

In one example,

$${n}_{7} = ( \begin{matrix}8 \\ 7\end{matrix} ) = 8 rank - 7$$

NC precoding matrices are included. The 7 columns of each of the precoding matrices can be given by [eₓ_{₁}, . . . , eₓ_{₇},], where (x₁ . . . ,x₇) is according to Table 26.

TABLE 26
indices (x₁, x₂, . . . , x₇) associated with rank 7 precoding matrices

| Index (J₇) | x₁ | x₂ | x₃ | x₄ | x₅ | x₆ | x₇ |
|---|---|---|---|---|---|---|---|
| 0 | 1 | 2 | 3 | 4 | 5 | 6 | 7 |
| 1 | 1 | 2 | 3 | 4 | 5 | 6 | 8 |
| 2 | 1 | 2 | 3 | 4 | 5 | 7 | 8 |
| 3 | 1 | 2 | 3 | 4 | 6 | 7 | 8 |
| 4 | 1 | 2 | 3 | 5 | 6 | 7 | 8 |
| 5 | 1 | 2 | 4 | 5 | 6 | 7 | 8 |
| 6 | 1 | 3 | 4 | 5 | 6 | 7 | 8 |
| 7 | 2 | 3 | 4 | 5 | 6 | 7 | 8 |

In one example, for rank 7, the mapping between Index (J₇) (and port indices (x₁, x₂, . . . , x₇), DEF1) in Table 26 and index/is given by Table 27. In one example, the TPMI index=I. In one example, the TPMI index=k+J₇, where k=1+max (J₆).

TABLE 27
indices (x₁, x₂, . . . , x₇) associated with rank 7 precoding matrices

| Index (J₇) | x₁ | x₂ | x₃ | x₄ | x₅ | x₆ | x₇ | Index (I) |
|---|---|---|---|---|---|---|---|---|
| 0 | 1 | 2 | 3 | 4 | 5 | 6 | 7 | 127 |
| 1 | 1 | 2 | 3 | 4 | 5 | 6 | 8 | 191 |
| 2 | 1 | 2 | 3 | 4 | 5 | 7 | 8 | 223 |
| 3 | 1 | 2 | 3 | 4 | 6 | 7 | 8 | 239 |
| 4 | 1 | 2 | 3 | 5 | 6 | 7 | 8 | 247 |
| 5 | 1 | 2 | 4 | 5 | 6 | 7 | 8 | 251 |
| 6 | 1 | 3 | 4 | 5 | 6 | 7 | 8 | 253 |
| 7 | 2 | 3 | 4 | 5 | 6 | 7 | 8 | 254 |

In one example, an UL codebook for 8 antenna ports includes n₇≥1 rank-7 NC precoding matrix/matrices from Table 28.
In one example, n₇=1, and the rank 7 NC precoding matrix is example A_{7,1}.
In one example, n₇=2, and the rank 7 NC precoding matrix are examples (A_{7,x}_{₁}, A_{7,x}_{₂}), where (x₁, x₂) is one of (1,2) or (1,3) or (1,4) or (2,3) or (2,4) or (3,4).
In one example, n₇=3, and the rank 7 NC precoding matrix are examples (A_{7,x}_{₁}, A_{7,x}_{₂}, A_{7,x}_{₃}), where (x₁, x₂, x₃) is one of (1,2,3) or (1,2,4) or (1,3,4) or (2,3,4).
In one example, n₇=4, and the rank 7 NC precoding matrix are examples (A_{7,1}, A_{7,2}, A_{7,3}, A_{7,4}).

TABLE 28

| Example | A_{7,1} | A_{7,2} | A_{7,3} | A_{7,4} |
|---|---|---|---|---|
| 1 of ports, or row index {1, 4, 5, 8} is not selected (i.e., is zero) | $\frac{1}{s} [ \begin{matrix}1 & 0 & 0 & 0 & 0 & 0 & 0 \\ 0 & 1 & 0 & 0 & 0 & 0 & 0 \\ 0 & 0 & 1 & 0 & 0 & 0 & 0 \\ 0 & 0 & 0 & 1 & 0 & 0 & 0 \\ 0 & 0 & 0 & 0 & 1 & 0 & 0 \\ 0 & 0 & 0 & 0 & 0 & 1 & 0 \\ 0 & 0 & 0 & 0 & 0 & 0 & 1 \\ 0 & 0 & 0 & 0 & 0 & 0 & 0\end{matrix} ]$ | $\frac{1}{s} [ \begin{matrix}0 & 0 & 0 & 0 & 0 & 0 & 0 \\ 1 & 0 & 0 & 0 & 0 & 0 & 0 \\ 0 & 1 & 0 & 0 & 0 & 0 & 0 \\ 0 & 0 & 1 & 0 & 0 & 0 & 0 \\ 0 & 0 & 0 & 1 & 0 & 0 & 0 \\ 0 & 0 & 0 & 0 & 1 & 0 & 0 \\ 0 & 0 & 0 & 0 & 0 & 1 & 0 \\ 0 & 0 & 0 & 0 & 0 & 0 & 1\end{matrix} ]$ | $\frac{1}{s} [ \begin{matrix}1 & 0 & 0 & 0 & 0 & 0 & 0 \\ 0 & 1 & 0 & 0 & 0 & 0 & 0 \\ 0 & 0 & 1 & 0 & 0 & 0 & 0 \\ 0 & 0 & 0 & 0 & 0 & 0 & 0 \\ 0 & 0 & 0 & 1 & 0 & 0 & 0 \\ 0 & 0 & 0 & 0 & 1 & 0 & 0 \\ 0 & 0 & 0 & 0 & 0 & 1 & 0 \\ 0 & 0 & 0 & 0 & 0 & 0 & 1\end{matrix} ]$ | $\frac{1}{s} [ \begin{matrix}1 & 0 & 0 & 0 & 0 & 0 & 0 \\ 0 & 1 & 0 & 0 & 0 & 0 & 0 \\ 0 & 0 & 1 & 0 & 0 & 0 & 0 \\ 0 & 0 & 0 & 1 & 0 & 0 & 0 \\ 0 & 0 & 0 & 0 & 0 & 0 & 0 \\ 0 & 0 & 0 & 0 & 1 & 0 & 0 \\ 0 & 0 & 0 & 0 & 0 & 1 & 0 \\ 0 & 0 & 0 & 0 & 0 & 0 & 1\end{matrix} ]$ |
| | (port 8 not selected) | (port 1 not selected) | (port 4 not selected) | (port 5 not selected) |

In one example, an UL codebook for 8 antenna ports includes n₈=1 rank-8 NC precoding matrix

$$[ {e}_{1} , {e}_{2} , {e}_{3} , {e}_{4} , {e}_{5} , {e}_{6} , {e}_{7} , {e}_{8} ] = \frac{1}{s} [ \begin{matrix}10000000 \\ 01000000 \\ 00100000 \\ 00010000 \\ 00001000 \\ 00000100 \\ 00000010 \\ 00000001\end{matrix} ] .$$

In one example, for rank 8, the mapping between Index (J₈) (and port indices (x₁, x₂, . . . , x₈), DEF1) and index I is given by Table 29. In one example, the TPMI index=I. In one example, the TPMI index=k+J₈, where k=1+max (J₇).

TABLE 29
indices (x₁, x₂, . . . , x₈) associated with rank 8 precoding matrix

| Index (J₈) | x₁ | x₂ | x₃ | x₄ | x₅ | x₆ | x₇ | x₈ | Index (I) |
|---|---|---|---|---|---|---|---|---|---|
| 0 | 1 | 2 | 3 | 4 | 5 | 6 | 7 | 8 | 255 |

In one example, the TPMI index 0-254 (Ex1) or 1-255 (Ex2) maps sequentially in order of rank values as follows Table 30. In one example, the TPMI index=k+Jᵥ₋₁, where k=1+max (Jᵥ₋₁).

TABLE 30

| TPMI | TPMI | | I corresponding to |
|---|---|---|---|
| index (Ex1): | index (Ex2): | | (indicated by) |
| 0 to Δ(v) − 1 | 1 to Δ(v) | Rank v | Index Jᵥ |
| 0-7 | 1-8 | 1 | 0-7 of Table 14 |
| 8-35 | 9-36 | 2 | 0-27 of Table 16 |
| 36-91 | 37-92 | 3 | 0-55 of Table 18 |
| 92-161 | 93-162 | 4 | 0-69 of Table 20 |
| 162-217 | 163-218 | 5 | 0-55 of Table 22 |
| 218-245 | 219-246 | 6 | 0-27 of Table 24 |
| 246-253 | 247-254 | 7 | 0-7 of Table 27 |
| 254 | 255 | 8 | 0 of Table 29 |

In particular, for a given rank v∈{1,2, . . . ,8}, TPMI indices 0 to Δ(v)−1 (or 1 to Δ(v)) are mapped to values of I in the following order: indices/for rank 1→indices/for rank 2, and so on, i.e., first by increasing values of the number of transmitted layers (k=1, . . . , v), and then by increasing values of I for a given number of layers (k). Here, Δ(v)=Σᵥ^{k=1}C(8,k) for k≥1, where C(x, y) is defined by Table 5.2.2.2.5-4 of [6, TS 38.214].

A TPMI index in {0 to Δ(v)−1} (or {1 to Δ(v)}) then maps to a value (I) indicating a precoding matrix as follows:

TABLE 31
TPMI index to index I mapping

| | | | | TPMI | TPMI | |
|---|---|---|---|---|---|---|
| | | | | index: | index: | I corresponding |
| | k = | | | 0 to | 1 to | to (indicated |
| v | 1, . . . , v | C(8, k) | Δ(v) | Δ(v) − 1 | Δ(v) | by) Index Jᵥ |
| 1 | 1 | 8 | 8 | 0-7 | 1-8 | 0-7 of Table 14 |
| 2 | 1, 2 | 8, 28 | 36 | 8-35 | 9-36 | 0-27 of Table 16 |
| 3 | 1, 2, 3 | 8, 28, 56 | 92 | 36-91 | 37-92 | 0-55 of Table 18 |
| 4 | 1, . . . , 4 | 8, 28, 56, 70 | 162 | 92-161 | 93-162 | 0-69 of Table 20 |
| 5 | 1, . . . , 5 | 8, 28, 56, 70, | 218 | 162-217 | 163-218 | 0-55 of Table 22 |
| | | 56 | | | | |
| 6 | 1, . . . , 6 | 8, 28, 56, 70, | 246 | 218-245 | 219-246 | 0-27 of Table 24 |
| | | 56, 28 | | | | |
| 7 | 1, . . . , 7 | 8, 28, 56, 70, | 254 | 246-253 | 247-254 | 0-7 of Table 27 |
| | | 56, 28, 8 | | | | |
| 8 | 1, . . . , 8 | 8, 28, 56, 70, | 255 | 254 | 255 | 0 of Table 29 |
| | | 56, 28, 8, 1 | | | | |

In one example, an UL codebook for 8 antenna ports includes 8Tx precoders that are based on Rel.15 4Tx NC precoders (Table 33) applied on 2 antenna groups, each comprising 4 ports. For example, groups {G₁, G₂}= {(g_{1,1}, . . . , g_{1,4}), (g_{2,1}, . . . , g_{2,4})}={(1,2,5,6), (3,4,7,8)} or {(1,2,5,6), (3,4,7,8)}. For the group that is not applied any layers, a 0_{4×r} all zero matrix is included in the corresponding rank r 8Tx precoders.

In one example, the 8Tx precoders included in the codebook correspond to those in Table 32.

TABLE 32

| | Layer | | Number of |
|---|---|---|---|
| | split | | 8Tx NC |
| Rank | (l₁, l₂) | 8Tx NC precoders or precoding matrices | precoders |
| 1 | (1, 0) | [eᵢ_{₁}] i₁ = g_{1, j} and j = 1, . . . , 4 | 4 |
| | (0, 1) | [eᵢ_{₂}] i₂ = g_{2, j} and j = 1, . . . , 4 | 4 |
| 2 | (2, 0) | [eᵢ_{_{1, 1}}, eᵢ_{_{1, 2}}] (i_{1, 1}, i_{1, 2}) = (g_{1, j}_{₁}, g_{1, j}_{₂}) and (j₁, j₂) = | 6 |
| | | {(1, 2), (1, 3), (1, 4), (2, 3), (2, 4), (3, 4)} | |
| | (0, 2) | [eᵢ_{_{2, 1}}, eᵢ_{_{2, 2}}] (i_{2, 1}, i_{2, 2}) = (g_{2, j}_{₁}, g_{2, j}_{₂}) and (j₁, j₂) = | 6 |
| | | {(1, 2), (1, 3), (1, 4), (2, 3), (2, 4), (3, 4)} | |
| | (1, 1) | [eᵢ_{₁}, eᵢ_{₂}], i₁, i₂ values are as in Rank 1 | 16 |
| 3 | (3, 0) | [eᵢ_{_{1, 1}}, . . . , eᵢ_{_{1, 3}}] (i_{1, 1}, i_{1, 2}, i_{1, 3}) = (g_{1, j}_{₁}, g_{1, j}_{₂}, g_{1, j}_{₃}) and | 1 or 4 |
| | | (j₁, j₂, j₃) = {(1, 2, 3)} or (j₁, j₂, j₃) = | |
| | | {(1, 2, 3), (1, 2, 4), (1, 3, 4), (2, 3, 4)} | |
| | (0, 3) | [eᵢ_{_{2, 1}}, . . . , eᵢ_{_{2, 3}}] (i_{2, 1}, i_{2, 2}, i_{2, 3}) = (g_{2, j}_{₁}, g_{2, j}_{₂}, g_{2, j}_{₃}) and | 1 or 4 |
| | | (j₁, j₂, j₃) = {(1, 2, 3)} or (j₁, j₂, j₃) = | |
| | | {(1, 2, 3), (1, 2, 4), (1, 3, 4), (2, 3, 4)} | |
| | (2, 1) | [eᵢ_{_{1, 1}}, eᵢ_{_{1, 2}}, eᵢ_{₂}], (i_{1, 1}, i_{1, 2}) values as in Rank 2 and i₂ is as in | 24 |
| | | Rank 1 | |
| | (1, 2) | [eᵢ_{₁}, eᵢ_{_{2, 1}}, eᵢ_{_{2, 2}}], (i_{2, 1}, i_{2, 2}) values as in Rank 2 and i₁ is as in | 24 |
| | | Rank 1 | |
| 4 | (4, 0) | [eᵢ_{_{1, 1}}, . . . , eᵢ_{_{1, 4}}] (i_{1, 1}, . . . , i_{1, 4}) = G₁ | 1 |
| | (0, 4) | [eᵢ_{_{2, 1}}, . . . , eᵢ_{_{2, 4}}] (i_{2, 1}, . . . , i_{2, 4}) = G₂ | 1 |
| | (3, 1) | [eᵢ_{_{1, 1}}, . . . , eᵢ_{_{1, 3}}, eᵢ_{₂}] (i_{1, 1}, i_{1, 2}, i_{1, 3}) values as in Rank 3 and i₂ is | 4 or 16 |
| | | as in Rank 1 | |
| | (1, 3) | [eᵢ_{₁}, eᵢ_{_{2, 1}}, . . . , eᵢ_{_{2, 3}}] (i_{2, 1}, i_{2, 2}, i_{2, 3}) values as in Rank 3 and i₁ is | 4 or 16 |
| | | as in Rank 1 | |
| | (2, 2) | [eᵢ_{_{1, 1}}, eᵢ_{_{1, 2}}, eᵢ_{_{2, 1}}, eᵢ_{_{2, 2}}], (i_{1, 1}, i_{1, 2}) and (i_{2, 1}, i_{2, 2}) values as in | 36 |
| | | Rank 2 | |
| 5 | (4, 1) | [eᵢ_{_{1, 1}}, . . . , eᵢ_{_{1, 4}}, eᵢ_{₂}] (i_{1, 1}, . . . , i_{1, 4}) = G₁ and i₂ is as in Rank 1 | 4 |
| | (1, 4) | [eᵢ_{₁}, eᵢ_{_{2, 1}}, . . . , eᵢ_{_{2, 4}}] (i_{2, 1}, . . . , i_{2, 4}) = G₂ and i₁ is as in Rank 1 | 4 |
| | (3, 2) | [eᵢ_{_{1, 1}}, . . . , e_{i1, 3}, eᵢ_{_{2, 1}}, eᵢ_{_{2, 2}}] (i_{1, 1}, i_{1, 2}, i_{1, 3}) values as in Rank 3 | 6 or 24 |
| | | and (i_{2, 1}, i_{2, 2}) values as in Rank 2 | |
| | (2, 3) | [eᵢ_{_{1, 1}}, eᵢ_{_{1, 2}}, eᵢ_{_{2, 1}}, . . . , eᵢ_{_{2, 3}}] (i_{2, 1}, i_{2, 2}, i_{2, 3}) values as in Rank 3 | 6 or 24 |
| | | and (i_{1, 1}, i_{1, 2}) values as in Rank 2 | |
| 6 | (4, 2) | [eᵢ_{_{1, 1}}, . . . , eᵢ_{_{1, 4}}, eᵢ_{_{2, 1}}, eᵢ_{_{2, 2}}] (i_{1, 1}, . . . , i_{1, 4}) = G₁ and (i_{2, 1}, i_{2, 2}) | 6 |
| | | values as in Rank 2 | |
| | (2, 4) | [eᵢ_{_{1, 1}}, eᵢ_{_{1, 2}}, eᵢ_{_{2, 1}}, . . . , eᵢ_{_{2, 4}}] (i_{2, 1}, . . . , i_{2, 4}) = G₂ and (i_{1, 1}, i_{1, 2}) | 6 |
| | | values as in Rank 2 | |
| | (3, 3) | [eᵢ_{_{1, 1}}, . . . , eᵢ_{_{1, 3}}, eᵢ_{_{2, 1}}, . . . , eᵢ_{_{2, 3}}], (i_{1, 1}, . . . , i_{1, 3}) and (i_{2, 1}, . . . , i_{2, 3}) | 1 or 16 |
| | | values as in Rank 3 | |
| 7 | (4, 3) | [eᵢ_{_{1, 1}}, . . . , eᵢ_{_{1, 4}}, eᵢ_{_{2, 1}}, . . . , eᵢ_{_{2, 3}}], (i_{1, 1}, . . . , i_{1, 4}) = G₁ and | 1 or 4 |
| | | (i_{2, 1}, . . . , i_{2, 3}) values as in Rank 3 | |
| | (3, 4) | [eᵢ_{_{1, 1}}, eᵢ_{_{1, 2}}, eᵢ_{_{2, 1}}, . . . , eᵢ_{_{2, 4}}], (i_{2, 1}, . . . , i_{2, 4}) = G₂ and (i_{1, 1}, . . . , i_{1, 3}) | 1 or 4 |
| | | values as in Rank 3 | |
| 8 | (4, 4) | [eᵢ_{_{1, 1}}, . . . , eᵢ_{_{1, 4}}, eᵢ_{_{2, 1}}, . . . , eᵢ_{_{2, 4}}], (i_{1, 1}, . . . , i_{1, 4}) = G₁ and | 1 |
| | | (i_{2, 1}, . . . , i_{2, 4}) = G₂ | |
| Total | | | 168 or |

TABLE 33
NC precoders for each of the 2 groups of 4 ports

| | | | | |
|---|---|---|---|---|
| 4 rank1 TPMIs | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ |

| | | | | | | |
|---|---|---|---|---|---|---|
| 6 rank2 TPMIs | $\frac{1}{2} [ \begin{matrix}1 \\ 0 \\ 0 \\ 0\end{matrix} \begin{matrix}0 \\ 1 \\ 0 \\ 0\end{matrix} ]$ | $\frac{1}{2} [ \begin{matrix}1 \\ 0 \\ 0 \\ 0\end{matrix} \begin{matrix}0 \\ 0 \\ 1 \\ 0\end{matrix} ]$ | $\frac{1}{2} [ \begin{matrix}1 \\ 0 \\ 0 \\ 0\end{matrix} \begin{matrix}0 \\ 0 \\ 0 \\ 1\end{matrix} ]$ | $\frac{1}{2} [ \begin{matrix}0 \\ 1 \\ 0 \\ 0\end{matrix} \begin{matrix}0 \\ 0 \\ 1 \\ 0\end{matrix} ]$ | $\frac{1}{2} [ \begin{matrix}0 \\ 1 \\ 0 \\ 0\end{matrix} \begin{matrix}0 \\ 0 \\ 0 \\ 1\end{matrix} ]$ | $\frac{1}{2} [ \begin{matrix}0 \\ 0 \\ 1 \\ 0\end{matrix} \begin{matrix}0 \\ 0 \\ 0 \\ 1\end{matrix} ]$ |
| 1 rank3 TPMI and 1 rank4 TPMI | $\frac{1}{2} [ \begin{matrix}1 \\ 0 \\ 0 \\ 0\end{matrix} \begin{matrix}0 \\ 1 \\ 0 \\ 0\end{matrix} \begin{matrix}0 \\ 0 \\ 1 \\ 0\end{matrix} ]$ | $\frac{1}{2} [ \begin{matrix}1 \\ 0 \\ 0 \\ 0\end{matrix} \begin{matrix}0 \\ 1 \\ 0 \\ 0\end{matrix} \begin{matrix}0 \\ 0 \\ 1 \\ 0\end{matrix} \begin{matrix}0 \\ 0 \\ 0 \\ 1\end{matrix} ]$ | | | | |

In one example, the 8Tx precoders included in the codebook correspond to a subset of those in Table 32. In one example, the subset corresponds to 8Tx precoders for a subset of layer combinations (cf. Table 32). For example, the subset of layer combinations is according to at least one of Table 34-Table 54. The corresponding 8Tx precoders or precoding matrices are shown in Table 32.

TABLE 34

| | T₁: | | T₂: | |
|---|---|---|---|---|
| | Each layer | | Layers split | |
| | in one | Number | across 2 | Number |
| | Antenna | of 8Tx | Antenna | of 8Tx |
| | Group. | NC | Groups, | NC |
| Rank | (l₁, l₂) | precoders | (l₁, l₂) | precoders |
| 1 | (0, 1), (1, 0) | 4 + 4 = 8 | | |
| 2 | (0, 2), (2, 0) | 6 + 6 = 12 | (1, 1) | 4 × 4 = 16 |
| 3 | (0, 3), (3, 0) | 1 + 1 = 2 | (1, 2) | 4 × 6 = 24 |
| 4 | (0, 4), (4, 0) | 1 + 1 = 2 | (2, 2) | 6 × 6 = 36 |
| 5 | | | (1, 4) | 4 |
| 6 | | | (3, 3) | 1 × 1 = 1 |
| 7 | | | (3, 4) | 1 × 1 = 1 |
| 8 | | | (4, 4) | 1 × 1 = 1 |
| Total = 109 | | 24 | | 85 |

TABLE 35

| | T₁: | | T₂: | |
|---|---|---|---|---|
| | Each layer | | Layers split | |
| | in one | Number | across 2 | Number |
| | Antenna | of 8Tx | Antenna | of 8Tx |
| | Group. | NC | Groups, | NC |
| Rank | (l₁, l₂) | precoders | (l₁, l₂) | precoders |
| 1 | (1, 0), (0, 1) | 8 | | |
| 2 | (2, 0) | 6 | | |
| 3 | (3, 0) | 1 | | |
| 4 | (4, 0) | 1 | | |
| 5 | | | (1, 4) | 4 |
| 6 | | | (3, 3) | 1 × 1 = 1 |
| 7 | | | (3, 4) | 1 × 1 = 1 |
| 8 | | | (4, 4) | 1 × 1 = 1 |
| Total = 23 | | 16 | | 7 |

TABLE 36

| | T₁: | | T₂: | |
|---|---|---|---|---|
| | Each layer | | Layers split | |
| | in one | Number | across 2 | Number |
| | Antenna | of 8Tx | Antenna | of 8Tx |
| | Group. | NC | Groups, | NC |
| Rank | (l₁, l₂) | precoders | (l₁, l₂) | precoders |
| 1 | (1, 0), (0, 1) | 8 | | |
| 2 | | | (1, 1) | 4 × 4 = 16 |
| 3 | | | (1, 2) | 4 × 6 = 24 |
| 4 | | | (1, 3) | 4 |
| 5 | | | (1, 4) | 14 |
| 6 | | | (3, 3) | 1 × 1 = 1 |
| 7 | | | (3, 4) | 1 × 1 = 1 |
| 8 | | | (4, 4) | 1 × 1 = 1 |
| Total = 59 | | 8 | | 51 |

TABLE 37

| | T₁: | | T₂: | |
|---|---|---|---|---|
| | Each layer | | Layers split | |
| | in one | Number | across 2 | Number |
| | Antenna | of 8Tx | Antenna | of 8Tx |
| | Group. | NC | Groups, | NC |
| Rank | (l₁, l₂) | precoders | (l₁, l₂) | precoders |
| 1 | (0, 1), (1, 0) | 4 + 4 = 8 | | |
| 2 | (0, 2), (2, 0) | 6 + 6 = 12 | | |
| 3 | (0, 3), (3, 0) | 1 + 1 = 2 | | |
| 4 | (0, 4), (4, 0) | 1 + 1 = 2 | | |
| 5 | | | (1, 4) | 4 |
| 6 | | | (3, 3) | 1 × 1 = 1 |
| 7 | | | (3, 4) | 1 × 1 = 1 |
| 8 | | | (4, 4) | 1 × 1 = 1 |
| Total = 31 | | 24 | | 7 |

TABLE 38

| | T₁: | | T₂: | |
|---|---|---|---|---|
| | Each layer | | Layers split | |
| | in one | Number | across 2 | Number |
| | Antenna | of 8Tx | Antenna | of 8Tx |
| | Group. | NC | Groups, | NC |
| Rank | (l₁, l₂) | precoders | (l₁, l₂) | precoders |
| 1 | (0, 1), (1, 0) | 4 + 4 = 8 | | |
| 2 | (0, 2), (2, 0) | 6 + 6 = 12 | (1, 1) | 4 × 4 = 16 |
| 3 | (0, 3), (3, 0) | 1 + 1 = 2 | | |
| 4 | (0, 4), (4, 0) | 1 + 1 = 2 | | |
| 5 | | | (1, 4) | 4 |
| 6 | | | (3, 3) | 1 × 1 = 1 |
| 7 | | | (3, 4) | 1 × 1 = 1 |
| 8 | | | (4, 4) | 1 × 1 = 1 |
| Total = 47 | | 24 | | 23 |

TABLE 39

| | T₁: | | T₂: | |
|---|---|---|---|---|
| | Each layer | | Layers split | |
| | in one | Number | across 2 | Number |
| | Antenna | of 8Tx | Antenna | of 8Tx |
| | Group. | NC | Groups, | NC |
| Rank | (l₁, l₂) | precoders | (l₁, l₂) | precoders |
| 1 | (0, 1), (1, 0) | 4 + 4 = 8 | | |
| 2 | (0, 2), (2, 0) | 6 + 6 = 12 | (1, 1) | 4 × 4 = 16 |
| 3 | (0, 3), (3, 0) | 1 + 1 = 2 | (1, 2) | 4 × 6 = 24 |
| 4 | (0, 4), (4, 0) | 1 + 1 = 2 | (1, 3) | 4 |
| 5 | | | (1, 4) | 4 |
| 6 | | | (3, 3) | 1 × 1 = 1 |
| 7 | | | (3, 4) | 1 × 1 = 1 |
| 8 | | | (4, 4) | 1 × 1 = 1 |
| Total = 75 | | 24 | | 51 |

TABLE 40

| | T₁: | | T₂: | |
|---|---|---|---|---|
| | Each layer | | Layers split | |
| | in one | Number | across 2 | Number |
| | Antenna | of 8Tx | Antenna | of 8Tx |
| | Group. | NC | Groups, | NC |
| Rank | (l₁, l₂) | precoders | (l₁, l₂) | precoders |
| 1 | (0, 1), (1, 0) | 4 + 4 = 8 | | |
| 2 | (0, 2), (2, 0) | 6 + 6 = 12 | (1, 1) | 4 × 4 = 16 |
| 3 | (0, 3), (3, 0) | 1 + 1 = 2 | (1, 2) | 4 × 6 = 24 |
| 4 | (0, 4), (4, 0) | 1 + 1 = 2 | (2, 2) | 6 × 6 = 36 |
| 5 | | | (2, 3) | 6 |
| 6 | | | (3, 3) | 1 × 1 = 1 |
| 7 | | | (3, 4) | 1 × 1 = 1 |
| 8 | | | (4, 4) | 1 × 1 = 1 |
| Total = 109 | | 24 | | 87 |

TABLE 41

| | T₁: | | T₂: | |
|---|---|---|---|---|
| | Each layer | | Layers split | |
| | in one | Number | across 2 | Number |
| | Antenna | of 8Tx | Antenna | of 8Tx |
| | Group. | NC | Groups, | NC |
| Rank | (l₁, l₂) | precoders | (l₁, l₂) | precoders |
| 1 | (1, 0), (0, 1) | 8 | | |
| 2 | (2, 0) | 6 | | |
| 3 | (3, 0) | 1 | | |
| 4 | (4, 0) | 1 | | |
| 5 | | | (2, 3) | 6 |
| 6 | | | (3, 3) | 1 × 1 = 1 |
| 7 | | | (3, 4) | 1 × 1 = 1 |
| 8 | | | (4, 4) | 1 × 1 = 1 |
| Total = 23 | | 16 | | 9 |

TABLE 42

| | T₁: | | T₂: | |
|---|---|---|---|---|
| | Each layer | | Layers split | |
| | in one | Number | across 2 | Number |
| | Antenna | of 8Tx | Antenna | of 8Tx |
| | Group. | NC | Groups, | NC |
| Rank | (l₁, l₂) | precoders | (l₁, l₂) | precoders |
| 1 | (1, 0), (0, 1) | 8 | | |
| 2 | | | (1, 1) | 4 × 4 = 16 |
| 3 | | | (1, 2) | 4 × 6 = 24 |
| 4 | | | (1, 3) | 4 |
| 5 | | | (2, 3) | 6 |
| 6 | | | (3, 3) | 1 × 1 = 1 |
| 7 | | | (3, 4) | 1 × 1 = 1 |
| 8 | | | (4, 4) | 1 × 1 = 1 |
| Total = 59 | | 8 | | 53 |

TABLE 43

| | T₁: | | T₂: | |
|---|---|---|---|---|
| | Each layer | | Layers split | |
| | in one | Number | across 2 | Number |
| | Antenna | of 8Tx | Antenna | of 8Tx |
| | Group. | NC | Groups, | NC |
| Rank | (l₁, l₂) | precoders | (l₁, l₂) | precoders |
| 1 | (0, 1), (1, 0) | 4 + 4 = 8 | | |
| 2 | (0, 2), (2, 0) | 6 + 6 = 12 | | |
| 3 | (0, 3), (3, 0) | 1 + 1 = 2 | | |
| 4 | (0, 4), (4, 0) | 1 + 1 = 2 | | |
| 5 | | | (2, 3) | 6 |
| 6 | | | (3, 3) | 1 × 1 = 1 |
| 7 | | | (3, 4) | 1 × 1 = 1 |
| 8 | | | (4, 4) | 1 × 1 = 1 |
| Total = 31 | | 24 | | 9 |

TABLE 44

| | T₁: | | T₂: | |
|---|---|---|---|---|
| | Each layer | | Layers split | |
| | in one | Number | across 2 | Number |
| | Antenna | of 8Tx | Antenna | of 8Tx |
| | Group. | NC | Groups, | NC |
| Rank | (l₁, l₂) | precoders | (l₁, l₂) | precoders |
| 1 | (0, 1), (1, 0) | 4 + 4 = 8 | | |
| 2 | (0, 2), (2, 0) | 6 + 6 = 12 | (1, 1) | 4 × 4 = 16 |
| 3 | (0, 3), (3, 0) | 1 + 1 = 2 | | |
| 4 | (0, 4), (4, 0) | 1 + 1 = 2 | | |
| 5 | | | (2, 3) | 6 |
| 6 | | | (3, 3) | 1 × 1 = 1 |
| 7 | | | (3, 4) | 1 × 1 = 1 |
| 8 | | | (4, 4) | 1 × 1 = 1 |
| Total = 47 | | 24 | | 25 |

TABLE 45

| | T₁: | | T₂: | |
|---|---|---|---|---|
| | Each layer | | Layers split | |
| | in one | Number | across 2 | Number |
| | Antenna | of 8Tx | Antenna | of 8Tx |
| | Group. | NC | Groups, | NC |
| Rank | (l₁, l₂) | precoders | (l₁, l₂) | precoders |
| 1 | (0, 1), (1, 0) | 4 + 4 = 8 | | |
| 2 | (0, 2), (2, 0) | 6 + 6 = 12 | (1, 1) | 4 × 4 = 16 |
| 3 | (0, 3), (3, 0) | 1 + 1 = 2 | (1, 2) | 4 × 6 = 24 |
| 4 | (0, 4), (4, 0) | 1 + 1 = 2 | (1, 3) | 4 |
| 5 | | | (2, 3) | 6 |
| 6 | | | (3, 3) | 1 × 1 = 1 |
| 7 | | | (3, 4) | 1 × 1 = 1 |
| 8 | | | (4, 4) | 1 × 1 = 1 |
| Total = 75 | | 24 | | 53 |

TABLE 46

| | T₁: Each layer in one | Number of 8Tx | T₂: Layers split across 2 | Number of 8Tx |
|---|---|---|---|---|
| Rank | Antenna Group. (l₁, l₂) | NC precoders | Antenna Groups, (l₁, l₂) | NC precoders |
| 1 | (0, 1), (1, 0) | 4 + 4 = 8 | | |
| 2 | (0, 2), (2, 0) | 6 + 6 = 12 | (1, 1) | 4 × 4 = 16 |
| 3 | (0, 3), (3, 0) | 1 + 1 = 2 | (1, 2) | 4 × 6 = 24 |
| 4 | (0, 4), (4, 0) | 1 + 1 = 2 | (2, 2) | 6 × 6 = 36 |
| 5 | | | (2, 3) | 6 × 1 = 6 |
| 6 | | | (3, 3) | 1 × 1 = 1 |
| 7 | | | (3, 4) | 1 × 1 = 1 |
| 8 | | | (4, 4) | 1 × 1 = 1 |
| Total = 109 | | 24 | | 85 |

TABLE 47

| | T₁: Each layer in one | Number of 8Tx | T₂: Layers split across 2 | Number of 8Tx |
|---|---|---|---|---|
| Rank | Antenna Group. (l₁, l₂) | NC precoders | Antenna Groups, (l₁, l₂) | NC precoders |
| 1 | (0, 1), (1, 0) | 4 + 4 = 8 | | |
| 2 | (0, 2), (2, 0) | 6 + 6 = 12 | (1, 1) | 4 × 4 = 16 |
| 3 | (0, 3), (3, 0) | 1 + 1 = 2 | (1, 2), (2, 1) | 2*4 × 6 = 48 |
| 4 | (0, 4), (4, 0) | 1 + 1 = 2 | (2, 2) | 6 × 6 = 36 |
| 5 | | | (2, 3), (3, 2) | 2*6 × 1 = 12 |
| 6 | | | (3, 3) | 1 × 1 = 1 |
| 7 | | | (3, 4), (4, 3) | 2*1 × 1 = 2 |
| 8 | | | (4, 4) | 1 × 1 = 1 |
| Total = 140 | | 24 | | 116 |

TABLE 48

| | T₁: Each layer in one | Number of 8Tx | T₂: Layers split across 2 | Number of 8Tx |
|---|---|---|---|---|
| Rank | Antenna Group. (l₁, l₂) | NC precoders | Antenna Groups, (l₁, l₂) | NC precoders |
| 1 | (0, 1), (1, 0) | 4 + 4 = 8 | | |
| 2 | (0, 2), (2, 0) | 6 + 6 = 12 | (1, 1) | 4 × 4 = 16 |
| 3 | (0, 3), (3, 0) | 1 + 1 = 2 | (1, 2), (2, 1) | 4 × 6 = 24 |
| 4 | (0, 4), (4, 0) | 1 + 1 = 2 | (1, 3), (2, 2) | 6 × 6 = 36 |
| 5 | | | (1, 4), (2, 3) | 6 × 1 = 6 |
| 6 | | | (2, 4), (3, 3) | 1 × 1 = 1 |
| 7 | | | (3, 4) | 1 × 1 = 1 |
| 8 | | | (4, 4) | 1 × 1 = 1 |
| | | 24 | | 85 |

TABLE 49

| | T₁: Each layer in one | Number of 8Tx | T₂: Layers split across 2 | Number of 8Tx |
|---|---|---|---|---|
| Rank | Antenna Group. (l₁, l₂) | NC precoders | Antenna Groups, (l₁, l₂) | NC precoders |
| 1 | (0, 1), (1, 0) | 4 + 4 = 8 | | |
| 2 | (0, 2), (2, 0) | 6 + 6 = 12 | (1, 1) | 4 × 4 = 16 |
| 3 | (0, 3), (3, 0) | 1 + 1 = 2 | (1, 2), (2, 1) | 2*4 × 6 = 48 |
| 4 | (0, 4), (4, 0) | 1 + 1 = 2 | (2, 2) | 6 × 6 = 36 |
| 5 | | | (2, 3) | 6 × 1 = 6 |
| 6 | | | (3, 3) | 1 × 1 = 1 |
| 7 | | | (3, 4) | 1 × 1 = 1 |
| 8 | | | (4, 4) | 1 × 1 = 1 |
| Total = 133 | | 24 | | 109 |

TABLE 50

| | T₁: Each layer in one | Number of 8Tx | T₂: Layers split across 2 | Number of 8Tx |
|---|---|---|---|---|
| Rank | Antenna Group. (l₁, l₂) | NC precoders | Antenna Groups, (l₁, l₂) | NC precoders |
| 1 | (0, 1), (1, 0) | 4 + 4 = 8 | | |
| 2 | (0, 2), (2, 0) | 6 + 6 = 12 | (1, 1) | 4 × 4 = 16 |
| 3 | (0, 3), (3, 0) | 1 + 1 = 2 | (1, 2) | 4 × 6 = 24 |
| 4 | (0, 4), (4, 0) | 1 + 1 = 2 | (2, 2) | 6 × 6 = 36 |
| 5 | | | (2, 3), (3, 2) | 2*6 × 1 = 12 |
| 6 | | | (3, 3) | 1 × 1 = 1 |
| 7 | | | (3, 4), (4, 3) | 2*1 × 1 = 2 |
| 8 | | | (4, 4) | 1 × 1 = 1 |
| Total = 116 | | 24 | | 92 |

TABLE 51

| | T₁: Each layer in one | Number of 8Tx | T₂: Layers split across 2 | Number of 8Tx |
|---|---|---|---|---|
| Rank | Antenna Group. (l₁, l₂) | NC precoders | Antenna Groups, (l₁, l₂) | NC precoders |
| 1 | (0, 1), (1, 0) | 4 + 4 = 8 | | |
| 2 | (0, 2), (2, 0) | 6 + 6 = 12 | (1, 1) | 4 × 4 = 16 |
| 3 | (0, 3), (3, 0) | 1 + 1 = 2 | (1, 2) | 4 × 6 = 24 |
| 4 | (0, 4), (4, 0) | 1 + 1 = 2 | (2, 2) | 6 × 6 = 36 |
| 5 | | | (2, 3) | 6 × 1 = 6 |
| 6 | | | (3, 3) | 1 × 1 = 1 |
| 7 | | | (3, 4), (4, 3) | 2*1 × 1 = 2 |
| 8 | | | (4, 4) | 1 × 1 = 1 |
| Total = 110 | | 24 | | 86 |

TABLE 52

| | T₁: Each layer in one | Number of 8Tx | T₂: Layers split across 2 | Number of 8Tx |
|---|---|---|---|---|
| Rank | Antenna Group. (l₁, l₂) | NC precoders | Antenna Groups, (l₁, l₂) | NC precoders |
| 1 | (0, 1), (1, 0) | 4 + 4 = 8 | | |
| 2 | (0, 2), (2, 0) | 6 + 6 = 12 | (1, 1) | 4 × 4 = 16 |
| 3 | (0, 3), (3, 0) | 1 + 1 = 2 | (1, 2) | 8 out of 24 |
| 4 | (0, 4), (4, 0) | 1 + 1 = 2 | (2, 2) | 7 out of 36 |
| 5 | | | (2, 3) | 6 × 1 = 6 |
| 6 | | | (3, 3) | 1 × 1 = 1 |
| 7 | | | (3, 4) | 1 |
| 8 | | | (4, 4) | 1 × 1 = 1 |
| Total = 64 | | 24 | | 86 |

TABLE 53

| | T₁: Each layer in one | Number of 8Tx | T₂: Layers split across 2 | Number of 8Tx |
|---|---|---|---|---|
| Rank | Antenna Group. (l₁, l₂) | NC precoders | Antenna Groups, (l₁, l₂) | NC precoders |
| 1 | (0, 1), (1, 0) | 4 + 4 = 8 | | |
| 2 | (0, 2), (2, 0) | 6 + 6 = 12 | (1, 1) | |
| 3 | (0, 3), (3, 0) | 1 + 1 = 2 | (1, 2) | |
| 4 | (0, 4), (4, 0) | 1 + 1 = 2 | (2, 2) | 1 out of 36 |
| 5 | | | (2, 3) | 6 × 1 = 6 |
| 6 | | | (3, 3) | 1 × 1 = 1 |
| 7 | | | (3, 4) | 1 |
| 8 | | | (4, 4) | 1 × 1 = 1 |
| Total = 32 | | 24 | | 8 |

TABLE 54

| | T₁: Each layer in one | Number of 8Tx | T₂: Layers split across 2 | Number of 8Tx |
|---|---|---|---|---|
| Rank | Antenna Group. (l₁, l₂) | NC precoders | Antenna Groups, (l₁, l₂) | NC precoders |
| 1 | (0, 1), (1, 0) | 4 + 4 = 8 | | |
| 2 | (0, 2), (2, 0) | 6 + 6 = 12 | (1, 1) | |
| 3 | (0, 3), (3, 0) | 1 + 1 = 2 | (1, 2) | 2 out of 24 |
| 4 | (0, 4), (4, 0) | 1 + 1 = 2 | (2, 2) | 2 out of 36 |
| 5 | | | (2, 3) | 6 × 1 = 1 |
| 6 | | | (3, 3) | 1 × 1 = 1 |
| 7 | | | (3, 4) | 1 |
| 8 | | | (4, 4) | 1 × 1 = 1 |
| Total = 32 | | 24 | | 8 |

In one example, the CB includes a subset of the rank 2 NC 8Tx precoding matrices.
In one example, the subset comprises n₂=6 that corresponds to layer split (2,0) or (0,2).
In one example, the subset comprises n₂=16 that corresponds to layer split (1,1).
In one example, the subset comprises n₂=12 that correspond to layer split (2,0) and (0,2).
In one example, the subset comprises n₂=18 that correspond to layer split (1,1) and one of (2,0) and (0,2).
In one example, the subset comprises n₂=24 that correspond to layer split (1,1), (2,0), and (0,2).

In one example, the CB includes a subset of the rank 3 NC 8Tx precoding matrices.
In one example, the subset comprises n₃=1 or 4 that corresponds to layer split (3,0) or (0,3).
In one example, the subset comprises n₃=24 that corresponds to layer split (1,2) or (2,1).
In one example, the subset comprises n₃=1 or 4 that corresponds to layer split (3,0) and (0,3).
In one example, the subset comprises n₃=48 that corresponds to layer split (1,2) and (2,1).
In one example, the subset comprises n₃=25 that corresponds to layer split (1,2) or (2,1), and layer split (3,0 and (0,3).
In one example, the subset comprises n₃=49 that corresponds to layer split (1,2) and (2,1), and layer split (3,0) or (0,3).
In one example, the subset comprises n₃=50 that corresponds to layer split (1,2) and (2,1), and layer split (3,0) and (0,3).

In one example, the CB includes a subset of the rank 4 NC 8Tx precoding matrices.
In one example, the subset comprises n₄=1 that corresponds to layer split (4,0) or (0,4).
In one example, the subset comprises n₄=4 or 16 that corresponds to layer split (1,3) or (3,1).
In one example, the subset comprises n₄=36 that corresponds to layer split (2,2).
In one example, the subset comprises n₄=2 that corresponds to layer split (4,0) and (0,4).
In one example, the subset comprises n₄=8 or 32 that corresponds to layer split (1,3) and (3,1).
In one example, the subset comprises n₄=40 or 52 that corresponds to layer split (2,2) and (1,3) or (3,1).
In one example, the subset comprises n₄=37 that corresponds to layer split (2,2) and (4,0) or (0,4).
In one example, the subset comprises n₄=41 or 53 that corresponds to layer split (2,2) and (1,3) or (3,1) and (4,0) or (0,4).
In one example, the subset comprises n₄=42 or 69 that corresponds to layer split (2,2) and (1,3) and (3,1) and (4,0) and (0,4).

In one example, the CB includes a subset of the rank 5 NC 8Tx precoding matrices.
In one example, the subset comprises n₅=4 that corresponds to layer split (4,1) or (1,4).
In one example, the subset comprises n₅=6 or 24 that corresponds to layer split (3,2) or (2,3).
In one example, the subset comprises n₅=8 that corresponds to layer split (4,1) and (1,4).
In one example, the subset comprises n₅=12 or 48 that corresponds to layer split (3,2) and (2,3).
In one example, the subset comprises n₅=10 or 28 that corresponds to layer split (4,1) or (1,4), and layer split (3,2) or (2,3).
In one example, the subset comprises n₅=16 or 52 that corresponds to layer split (4,1) or (1,4), and layer split (3,2) and (2,3).
In one example, the subset comprises n₅=14 or 32 that corresponds to layer split (4,1) and (1,4), and layer split (3,2) or (2,3).
In one example, the subset comprises n₅=20 or 56 that corresponds to layer split (4,1) and (1,4), and layer split (3,2) and (2,3).

In one example, the CB includes a subset of the rank 6 NC 8Tx precoding matrices.
In one example, the subset comprises n₆=6 that corresponds to layer split (4,2) or (2,4).
In one example, the subset comprises n₆=1 or 16 that corresponds to layer split (3,3).
In one example, the subset comprises n₆=12 that corresponds to layer split (4,2) and (2,4).
In one example, the subset comprises n₆=7 or 22 that corresponds to layer split (4,2) or (2,4) and split (3,3).
In one example, the subset comprises n₆=13 or 28 that corresponds to layer split (4,2) and (2,4) and split (3,3).

In one example, the CB includes a subset of the rank 7 NC 8Tx precoding matrices.
In one example, the subset comprises n₇=1 or 4 that corresponds to layer split (4,3) or (3,4).
In one example, the subset comprises n₇=2 or 8 that corresponds to layer split (4,3) and (3,4).

FIG. 7 illustrates an example method 700 performed by a UE in a wireless communication system according to embodiments of the present disclosure. The method 700 of FIG. 7 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 700 is for illustration only and other embodiments can be used without departing from the scope of the present disclosure.

The method 700 begins with the UE receiving a configuration including a value N_{g}=8 indicating an UL codebook for eight antenna ports (710). The UE then receives a TPMI index indicating a precoding matrix from the UL codebook (720). The UE then transmits a PUSCH using with the precoding matrix (730).

In various embodiments, the precoding matrix is given by

$$W = \frac{1}{2 \sqrt{2}} [ {e}_{{x}_{1}} , … , {e}_{{x}_{v}} ] ,$$

where v is a number of layers of the precoding matrix, xᵢ is a port index associated with layer i, eᵢ is a column vector with a value 1 at row corresponding to port xᵢ and value 0 at other rows, xᵢ∈ {0, . . . ,7}, i∈{1, . . . , v}, v∈{1, . . . ,8}. The TPMI index maps to ports (x₁, . . . , xᵥ) associated with v layers via an index I.

In various embodiments, the UE transmits UE capability information indicating support for the UL codebook and the index I=Σ₇^{p=0}δ(p)2^{p}, δ(p)=1 if a layer is to be transmitted on port p and δ(p)=0 otherwise.

Any of the above variation embodiments can be utilized independently or in combination with at least one other variation embodiment.

The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) comprising:
a processor; and
a transceiver operably coupled to the processor, the transceiver configured to:
receive a configuration including a value N_{g}=8 indicating an uplink (UL) codebook for eight antenna ports;
receive a transmit precoding matrix indicator (TPMI) index indicating a precoding matrix from the UL codebook; and
transmit a physical uplink shared channel (PUSCH) using the precoding matrix, wherein:
the precoding matrix is given by:
$$W = \frac{1}{2 \sqrt{2}} [ {e}_{{x}_{1}} , … , {e}_{{x}_{v}} ] ,$$
where v is a number of layers of the precoding matrix, xᵢ is a port index associated with layer i, eᵢ is a column vector with a value 1 at row corresponding to port xᵢ and value 0 at other rows, xᵢ∈ {0, . . . ,7}, i∈{1, . . . , v}, v∈{1, . . . ,8}, and
the TPMI index maps to ports (x₁, . . . , xᵥ) associated with v layers via an index I.

2. The UE of claim 1, wherein:
the transceiver is further configured to transmit UE capability information indicating support for the UL codebook,
the index I=Σₚ₌₀⁷δ(p)2^{p}, δ(p)=1 if a layer is to be transmitted on port p and δ(p)=0 otherwise, and
association of the TPMI index to layer is according to:

| v | TPMI index |
|---|---|
| 1 | 0-7 |
| 2 | 8-35 |
| 3 | 36-91 |
| 4 | 92-161 |
| 5 | 162-217 |
| 6 | 218-245 |
| 7 | 246-253 |
| 8 | 254 |

3. The UE of claim 2, wherein for v=1 layer, the TPMI index=J₁ and (J₁, I, x₁) is

| J₁ | I | x₁ |
|---|---|---|
| 0 | 1 | 0 |
| 1 | 2 | 1 |
| 2 | 4 | 2 |
| 3 | 8 | 3 |
| 4 | 16 | 4 |
| 5 | 32 | 5 |
| 6 | 64 | 6 |
| 7 | 128 | 7 |

4. The UE of claim 2, wherein for v=2 layers, the TPMI index=8+J₂ and (J₂, I, x₁, x₂) is according to:

| J₂ | 0 | 1 | 2 | 3 | 4 | 5 | 6 | 7 | 8 | 9 | 10 | 11 | 12 | 13 |
|---|---|---|---|---|---|---|---|---|---|---|---|---|---|---|
| I | 3 | 5 | 9 | 17 | 33 | 65 | 129 | 6 | 10 | 18 | 34 | 66 | 130 | 12 |
| J₂ | 14 | 15 | 16 | 17 | 18 | 19 | 20 | 21 | 22 | 23 | 24 | 25 | 26 | 27 |
| I | 20 | 36 | 68 | 132 | 24 | 40 | 72 | 136 | 48 | 80 | 144 | 96 | 160 | 192 |

and

| J₂ | x₁ | x₂ |
|---|---|---|
| 0 | 1 | 2 |
| 1 | 1 | 3 |
| 2 | 1 | 4 |
| 3 | 1 | 5 |
| 4 | 1 | 6 |
| 5 | 1 | 7 |
| 6 | 1 | 8 |
| 7 | 2 | 3 |
| 8 | 2 | 4 |
| 9 | 2 | 5 |
| 10 | 2 | 6 |
| 11 | 2 | 7 |
| 12 | 2 | 8 |
| 13 | 3 | 4 |
| 14 | 3 | 5 |
| 15 | 3 | 6 |
| 16 | 3 | 7 |
| 17 | 3 | 8 |
| 18 | 4 | 5 |
| 19 | 4 | 6 |
| 20 | 4 | 7 |
| 21 | 4 | 8 |
| 22 | 5 | 6 |
| 23 | 5 | 7 |
| 24 | 5 | 8 |
| 25 | 6 | 7 |
| 26 | 6 | 8 |
| 27 | 7 | 8. |

5. The UE of claim 2, wherein for v=3 layers, the TPMI index=36+J₃ and (J₃, I, x₁, x₂, x₃) is according to:

| J₃ | x₁ | x₂ | x₃ |
|---|---|---|---|
| 0 | 1 | 2 | 3 |
| 1 | 1 | 2 | 4 |
| 2 | 1 | 2 | 5 |
| 3 | 1 | 2 | 6 |
| 4 | 1 | 2 | 7 |
| 5 | 1 | 2 | 8 |
| 6 | 1 | 3 | 4 |
| 7 | 1 | 3 | 5 |
| 8 | 1 | 3 | 6 |
| 9 | 1 | 3 | 7 |
| 10 | 1 | 3 | 8 |
| 11 | 1 | 4 | 5 |
| 12 | 1 | 4 | 6 |
| 13 | 1 | 4 | 7 |
| 14 | 1 | 4 | 8 |
| 15 | 1 | 5 | 6 |
| 16 | 1 | 5 | 7 |
| 17 | 1 | 5 | 8 |
| 18 | 1 | 6 | 7 |
| 19 | 1 | 6 | 8 |
| 20 | 1 | 7 | 8 |
| 21 | 2 | 3 | 4 |
| 22 | 2 | 3 | 5 |
| 23 | 2 | 3 | 6 |
| 24 | 2 | 3 | 7 |
| 25 | 2 | 3 | 8 |
| 26 | 2 | 4 | 5 |
| 27 | 2 | 4 | 6 |
| 28 | 2 | 4 | 7 |
| 29 | 2 | 4 | 8 |
| 30 | 2 | 5 | 6 |
| 31 | 2 | 5 | 7 |
| 32 | 2 | 5 | 8 |
| 33 | 2 | 6 | 7 |
| 34 | 2 | 6 | 8 |
| 35 | 2 | 7 | 8 |
| 36 | 3 | 4 | 5 |
| 37 | 3 | 4 | 6 |
| 38 | 3 | 4 | 7 |
| 39 | 3 | 4 | 8 |
| 40 | 3 | 5 | 6 |
| 41 | 3 | 5 | 7 |
| 42 | 3 | 5 | 8 |
| 43 | 3 | 6 | 7 |
| 44 | 3 | 6 | 8 |
| 45 | 3 | 7 | 8 |
| 46 | 4 | 5 | 6 |
| 47 | 4 | 5 | 7 |
| 48 | 4 | 5 | 8 |
| 49 | 4 | 6 | 7 |
| 50 | 4 | 6 | 8 |
| 51 | 4 | 7 | 8 |
| 52 | 5 | 6 | 7 |
| 53 | 5 | 6 | 8 |
| 54 | 5 | 7 | 8 |
| 55 | 6 | 7 | 8 |

and

| J₃ | 0 | 1 | 2 | 3 | 4 | 5 | 6 | 7 | 8 | 9 | 10 | 11 | 12 | 13 |
|---|---|---|---|---|---|---|---|---|---|---|---|---|---|---|
| I | 7 | 11 | 19 | 35 | 67 | 131 | 13 | 21 | 37 | 69 | 133 | 25 | 41 | 73 |
| J₃ | 14 | 15 | 16 | 17 | 18 | 19 | 20 | 21 | 22 | 23 | 24 | 25 | 26 | 27 |
| I | 137 | 49 | 81 | 145 | 97 | 161 | 193 | 14 | 22 | 38 | 70 | 134 | 26 | 42 |
| J₃ | 28 | 29 | 30 | 31 | 32 | 33 | 34 | 35 | 36 | 37 | 38 | 39 | 40 | 41 |
| I | 74 | 138 | 50 | 82 | 146 | 98 | 162 | 194 | 28 | 44 | 76 | 140 | 52 | 84 |
| J₃ | 42 | 43 | 44 | 45 | 46 | 47 | 48 | 49 | 50 | 51 | 52 | 53 | 54 | 55 |
| I | 148 | 100 | 164 | 196 | 56 | 88 | 152 | 104 | 168 | 200 | 112 | 176 | 208 | 224. |

6. The UE of claim 2, wherein for v=4 layers, the TPMI index=92+J₄ and (J₄, I, x₁, . . . , x₄) is according to:

| J₄ | x₁ | x₂ | x₃ | x₄ |
|---|---|---|---|---|
| 0 | 1 | 2 | 3 | 4 |
| 1 | 1 | 2 | 3 | 5 |
| 2 | 1 | 2 | 3 | 6 |
| 3 | 1 | 2 | 3 | 7 |
| 4 | 1 | 2 | 3 | 8 |
| 5 | 1 | 2 | 4 | 5 |
| 6 | 1 | 2 | 4 | 6 |
| 7 | 1 | 2 | 4 | 7 |
| 8 | 1 | 2 | 4 | 8 |
| 9 | 1 | 2 | 5 | 6 |
| 10 | 1 | 2 | 5 | 7 |
| 11 | 1 | 2 | 5 | 8 |
| 12 | 1 | 2 | 6 | 7 |
| 13 | 1 | 2 | 6 | 8 |
| 14 | 1 | 2 | 7 | 8 |
| 15 | 1 | 3 | 4 | 5 |
| 16 | 1 | 3 | 4 | 6 |
| 17 | 1 | 3 | 4 | 7 |
| 18 | 1 | 3 | 4 | 8 |
| 19 | 1 | 3 | 5 | 6 |
| 20 | 1 | 3 | 5 | 7 |
| 21 | 1 | 3 | 5 | 8 |
| 22 | 1 | 3 | 6 | 7 |
| 23 | 1 | 3 | 6 | 8 |
| 24 | 1 | 3 | 7 | 8 |
| 25 | 1 | 4 | 5 | 6 |
| 26 | 1 | 4 | 5 | 7 |
| 27 | 1 | 4 | 5 | 8 |
| 28 | 1 | 4 | 6 | 7 |
| 29 | 1 | 4 | 6 | 8 |
| 30 | 1 | 4 | 7 | 8 |
| 31 | 1 | 5 | 6 | 7 |
| 32 | 1 | 5 | 6 | 8 |
| 33 | 1 | 5 | 7 | 8 |
| 34 | 1 | 6 | 7 | 8 |
| 35 | 2 | 3 | 4 | 5 |
| 36 | 2 | 3 | 4 | 6 |
| 37 | 2 | 3 | 4 | 7 |
| 38 | 2 | 3 | 4 | 8 |
| 39 | 2 | 3 | 5 | 6 |
| 40 | 2 | 3 | 5 | 7 |
| 41 | 2 | 3 | 5 | 8 |
| 42 | 2 | 3 | 6 | 7 |
| 43 | 2 | 3 | 6 | 8 |
| 44 | 2 | 3 | 7 | 8 |
| 45 | 2 | 4 | 5 | 6 |
| 46 | 2 | 4 | 5 | 7 |
| 47 | 2 | 4 | 5 | 8 |
| 48 | 2 | 4 | 6 | 7 |
| 49 | 2 | 4 | 6 | 8 |
| 50 | 2 | 4 | 7 | 8 |
| 51 | 2 | 5 | 6 | 7 |
| 52 | 2 | 5 | 6 | 8 |
| 53 | 2 | 5 | 7 | 8 |
| 54 | 2 | 6 | 7 | 8 |
| 55 | 3 | 4 | 5 | 6 |
| 56 | 3 | 4 | 5 | 7 |
| 57 | 3 | 4 | 5 | 8 |
| 58 | 3 | 4 | 6 | 7 |
| 59 | 3 | 4 | 6 | 8 |
| 60 | 3 | 4 | 7 | 8 |
| 61 | 3 | 5 | 6 | 7 |
| 62 | 3 | 5 | 6 | 8 |
| 63 | 3 | 5 | 7 | 8 |
| 64 | 3 | 6 | 7 | 8 |
| 65 | 4 | 5 | 6 | 7 |
| 66 | 4 | 5 | 6 | 8 |
| 67 | 4 | 5 | 7 | 8 |
| 68 | 4 | 6 | 7 | 8 |
| 69 | 5 | 6 | 7 | 8 |

and

| J₄ | x₁ | x₂ | x₃ | x₄ | I |
|---|---|---|---|---|---|
| 0 | 1 | 2 | 3 | 4 | 15 |
| 1 | 1 | 2 | 3 | 5 | 23 |
| 2 | 1 | 2 | 3 | 6 | 39 |
| 3 | 1 | 2 | 3 | 7 | 71 |
| 4 | 1 | 2 | 3 | 8 | 135 |
| 5 | 1 | 2 | 4 | 5 | 27 |
| 6 | 1 | 2 | 4 | 6 | 43 |
| 7 | 1 | 2 | 4 | 7 | 75 |
| 8 | 1 | 2 | 4 | 8 | 139 |
| 9 | 1 | 2 | 5 | 6 | 51 |
| 10 | 1 | 2 | 5 | 7 | 83 |
| 11 | 1 | 2 | 5 | 8 | 147 |
| 12 | 1 | 2 | 6 | 7 | 99 |
| 13 | 1 | 2 | 6 | 8 | 163 |
| 14 | 1 | 2 | 7 | 8 | 195 |
| 15 | 1 | 3 | 4 | 5 | 29 |
| 16 | 1 | 3 | 4 | 6 | 45 |
| 17 | 1 | 3 | 4 | 7 | 77 |
| 18 | 1 | 3 | 4 | 8 | 141 |
| 19 | 1 | 3 | 5 | 6 | 53 |
| 20 | 1 | 3 | 5 | 7 | 85 |
| 21 | 1 | 3 | 5 | 8 | 149 |
| 22 | 1 | 3 | 6 | 7 | 101 |
| 23 | 1 | 3 | 6 | 8 | 165 |
| 24 | 1 | 3 | 7 | 8 | 197 |
| 25 | 1 | 4 | 5 | 6 | 57 |
| 26 | 1 | 4 | 5 | 7 | 89 |
| 27 | 1 | 4 | 5 | 8 | 153 |
| 28 | 1 | 4 | 6 | 7 | 105 |
| 29 | 1 | 4 | 6 | 8 | 169 |
| 30 | 1 | 4 | 7 | 8 | 201 |
| 31 | 1 | 5 | 6 | 7 | 113 |
| 32 | 1 | 5 | 6 | 8 | 177 |
| 33 | 1 | 5 | 7 | 8 | 209 |
| 34 | 1 | 6 | 7 | 8 | 225 |
| 35 | 2 | 3 | 4 | 5 | 30 |
| 36 | 2 | 3 | 4 | 6 | 46 |
| 37 | 2 | 3 | 4 | 7 | 78 |
| 38 | 2 | 3 | 4 | 8 | 142 |
| 39 | 2 | 3 | 5 | 6 | 54 |
| 40 | 2 | 3 | 5 | 7 | 86 |
| 41 | 2 | 3 | 5 | 8 | 150 |
| 42 | 2 | 3 | 6 | 7 | 102 |
| 43 | 2 | 3 | 6 | 8 | 166 |
| 44 | 2 | 3 | 7 | 8 | 198 |
| 45 | 2 | 4 | 5 | 6 | 58 |
| 46 | 2 | 4 | 5 | 7 | 90 |
| 47 | 2 | 4 | 5 | 8 | 154 |
| 48 | 2 | 4 | 6 | 7 | 106 |
| 49 | 2 | 4 | 6 | 8 | 170 |
| 50 | 2 | 4 | 7 | 8 | 202 |
| 51 | 2 | 5 | 6 | 7 | 114 |
| 52 | 2 | 5 | 6 | 8 | 178 |
| 53 | 2 | 5 | 7 | 8 | 210 |
| 54 | 2 | 6 | 7 | 8 | 226 |
| 55 | 3 | 4 | 5 | 6 | 60 |
| 56 | 3 | 4 | 5 | 7 | 92 |
| 57 | 3 | 4 | 5 | 8 | 156 |
| 58 | 3 | 4 | 6 | 7 | 108 |
| 59 | 3 | 4 | 6 | 8 | 172 |
| 60 | 3 | 4 | 7 | 8 | 204 |
| 61 | 3 | 5 | 6 | 7 | 116 |
| 62 | 3 | 5 | 6 | 8 | 180 |
| 63 | 3 | 5 | 7 | 8 | 212 |
| 64 | 3 | 6 | 7 | 8 | 228 |
| 65 | 4 | 5 | 6 | 7 | 120 |
| 66 | 4 | 5 | 6 | 8 | 184 |
| 67 | 4 | 5 | 7 | 8 | 216 |
| 68 | 4 | 6 | 7 | 8 | 232 |
| 69 | 5 | 6 | 7 | 8 | 240. |

7. The UE of claim 2, wherein for v=5 layers, the TPMI index=162+J₅ and (J₅, I, x₁, . . . , x₅) is according to:

| J₅ | x₁ | x₂ | x₃ | x₄ | x₅ |
|---|---|---|---|---|---|
| 0 | 1 | 2 | 3 | 4 | 5 |
| 1 | 1 | 2 | 3 | 4 | 6 |
| 2 | 1 | 2 | 3 | 4 | 7 |
| 3 | 1 | 2 | 3 | 4 | 8 |
| 4 | 1 | 2 | 3 | 5 | 6 |
| 5 | 1 | 2 | 3 | 5 | 7 |
| 6 | 1 | 2 | 3 | 5 | 8 |
| 7 | 1 | 2 | 3 | 6 | 7 |
| 8 | 1 | 2 | 3 | 6 | 8 |
| 9 | 1 | 2 | 3 | 7 | 8 |
| 10 | 1 | 2 | 4 | 5 | 6 |
| 11 | 1 | 2 | 4 | 5 | 7 |
| 12 | 1 | 2 | 4 | 5 | 8 |
| 13 | 1 | 2 | 4 | 6 | 7 |
| 14 | 1 | 2 | 4 | 6 | 8 |
| 15 | 1 | 2 | 4 | 7 | 8 |
| 16 | 1 | 2 | 5 | 6 | 7 |
| 17 | 1 | 2 | 5 | 6 | 8 |
| 18 | 1 | 2 | 5 | 7 | 8 |
| 19 | 1 | 2 | 6 | 7 | 8 |
| 20 | 1 | 3 | 4 | 5 | 6 |
| 21 | 1 | 3 | 4 | 5 | 7 |
| 22 | 1 | 3 | 4 | 5 | 8 |
| 23 | 1 | 3 | 4 | 6 | 7 |
| 24 | 1 | 3 | 4 | 6 | 8 |
| 25 | 1 | 3 | 4 | 7 | 8 |
| 26 | 1 | 3 | 5 | 6 | 7 |
| 27 | 1 | 3 | 5 | 6 | 8 |
| 28 | 1 | 3 | 5 | 7 | 8 |
| 29 | 1 | 3 | 6 | 7 | 8 |
| 30 | 1 | 4 | 5 | 6 | 7 |
| 31 | 1 | 4 | 5 | 6 | 8 |
| 32 | 1 | 4 | 5 | 7 | 8 |
| 33 | 1 | 4 | 6 | 7 | 8 |
| 34 | 1 | 5 | 6 | 7 | 8 |
| 35 | 2 | 3 | 4 | 5 | 6 |
| 36 | 2 | 3 | 4 | 5 | 7 |
| 37 | 2 | 3 | 4 | 5 | 8 |
| 38 | 2 | 3 | 4 | 6 | 7 |
| 39 | 2 | 3 | 4 | 6 | 8 |
| 40 | 2 | 3 | 4 | 7 | 8 |
| 41 | 2 | 3 | 5 | 6 | 7 |
| 42 | 2 | 3 | 5 | 6 | 8 |
| 43 | 2 | 3 | 5 | 7 | 8 |
| 44 | 2 | 3 | 6 | 7 | 8 |
| 45 | 2 | 4 | 5 | 6 | 7 |
| 46 | 2 | 4 | 5 | 6 | 8 |
| 47 | 2 | 4 | 5 | 7 | 8 |
| 48 | 2 | 4 | 6 | 7 | 8 |
| 49 | 2 | 5 | 6 | 7 | 8 |
| 50 | 3 | 4 | 5 | 6 | 7 |
| 51 | 3 | 4 | 5 | 6 | 8 |
| 52 | 3 | 4 | 5 | 7 | 8 |
| 53 | 3 | 4 | 6 | 7 | 8 |
| 54 | 3 | 5 | 6 | 7 | 8 |
| 55 | 4 | 5 | 6 | 7 | 8 |

and

| J₅ | x₁ | x₂ | x₃ | x₄ | x₅ | I |
|---|---|---|---|---|---|---|
| 0 | 1 | 2 | 3 | 4 | 5 | 31 |
| 1 | 1 | 2 | 3 | 4 | 6 | 47 |
| 2 | 1 | 2 | 3 | 4 | 7 | 79 |
| 3 | 1 | 2 | 3 | 4 | 8 | 143 |
| 4 | 1 | 2 | 3 | 5 | 6 | 55 |
| 5 | 1 | 2 | 3 | 5 | 7 | 87 |
| 6 | 1 | 2 | 3 | 5 | 8 | 151 |
| 7 | 1 | 2 | 3 | 6 | 7 | 103 |
| 8 | 1 | 2 | 3 | 6 | 8 | 167 |
| 9 | 1 | 2 | 3 | 7 | 8 | 199 |
| 10 | 1 | 2 | 4 | 5 | 6 | 59 |
| 11 | 1 | 2 | 4 | 5 | 7 | 91 |
| 12 | 1 | 2 | 4 | 5 | 8 | 155 |
| 13 | 1 | 2 | 4 | 6 | 7 | 107 |
| 14 | 1 | 2 | 4 | 6 | 8 | 171 |
| 15 | 1 | 2 | 4 | 7 | 8 | 203 |
| 16 | 1 | 2 | 5 | 6 | 7 | 115 |
| 17 | 1 | 2 | 5 | 6 | 8 | 179 |
| 18 | 1 | 2 | 5 | 7 | 8 | 211 |
| 19 | 1 | 2 | 6 | 7 | 8 | 227 |
| 20 | 1 | 3 | 4 | 5 | 6 | 61 |
| 21 | 1 | 3 | 4 | 5 | 7 | 93 |
| 22 | 1 | 3 | 4 | 5 | 8 | 157 |
| 23 | 1 | 3 | 4 | 6 | 7 | 109 |
| 24 | 1 | 3 | 4 | 6 | 8 | 173 |
| 25 | 1 | 3 | 4 | 7 | 8 | 205 |
| 26 | 1 | 3 | 5 | 6 | 7 | 117 |
| 27 | 1 | 3 | 5 | 6 | 8 | 181 |
| 28 | 1 | 3 | 5 | 7 | 8 | 213 |
| 29 | 1 | 3 | 6 | 7 | 8 | 229 |
| 30 | 1 | 4 | 5 | 6 | 7 | 121 |
| 31 | 1 | 4 | 5 | 6 | 8 | 185 |
| 32 | 1 | 4 | 5 | 7 | 8 | 217 |
| 33 | 1 | 4 | 6 | 7 | 8 | 233 |
| 34 | 1 | 5 | 6 | 7 | 8 | 241 |
| 35 | 2 | 3 | 4 | 5 | 6 | 62 |
| 36 | 2 | 3 | 4 | 5 | 7 | 94 |
| 37 | 2 | 3 | 4 | 5 | 8 | 158 |
| 38 | 2 | 3 | 4 | 6 | 7 | 110 |
| 39 | 2 | 3 | 4 | 6 | 8 | 174 |
| 40 | 2 | 3 | 4 | 7 | 8 | 206 |
| 41 | 2 | 3 | 5 | 6 | 7 | 118 |
| 42 | 2 | 3 | 5 | 6 | 8 | 182 |
| 43 | 2 | 3 | 5 | 7 | 8 | 214 |
| 44 | 2 | 3 | 6 | 7 | 8 | 230 |
| 45 | 2 | 4 | 5 | 6 | 7 | 122 |
| 46 | 2 | 4 | 5 | 6 | 8 | 186 |
| 47 | 2 | 4 | 5 | 7 | 8 | 218 |
| 48 | 2 | 4 | 6 | 7 | 8 | 234 |
| 49 | 2 | 5 | 6 | 7 | 8 | 242 |
| 50 | 3 | 4 | 5 | 6 | 7 | 124 |
| 51 | 3 | 4 | 5 | 6 | 8 | 188 |
| 52 | 3 | 4 | 5 | 7 | 8 | 220 |
| 53 | 3 | 4 | 6 | 7 | 8 | 236 |
| 54 | 3 | 5 | 6 | 7 | 8 | 244 |
| 55 | 4 | 5 | 6 | 7 | 8 | 248. |

8. The UE of claim 2, wherein for v=6 layers, the TPMI index=218+J₆ and (J₆, I, x₁, . . . , x₆) is according to:

| J₆ | x₁ | x₂ | x₃ | x₄ | x₅ | x₆ |
|---|---|---|---|---|---|---|
| 0 | 1 | 2 | 3 | 4 | 5 | 6 |
| 1 | 1 | 2 | 3 | 4 | 5 | 7 |
| 2 | 1 | 2 | 3 | 4 | 5 | 8 |
| 3 | 1 | 2 | 3 | 4 | 6 | 7 |
| 4 | 1 | 2 | 3 | 4 | 6 | 8 |
| 5 | 1 | 2 | 3 | 4 | 7 | 8 |
| 6 | 1 | 2 | 3 | 5 | 6 | 7 |
| 7 | 1 | 2 | 3 | 5 | 6 | 8 |
| 8 | 1 | 2 | 3 | 5 | 7 | 8 |
| 9 | 1 | 2 | 3 | 6 | 7 | 8 |
| 10 | 1 | 2 | 4 | 5 | 6 | 7 |
| 11 | 1 | 2 | 4 | 5 | 6 | 8 |
| 12 | 1 | 2 | 4 | 5 | 7 | 8 |
| 13 | 1 | 2 | 4 | 6 | 7 | 8 |
| 14 | 1 | 2 | 5 | 6 | 7 | 8 |
| 15 | 1 | 3 | 4 | 5 | 6 | 7 |
| 16 | 1 | 3 | 4 | 5 | 6 | 8 |
| 17 | 1 | 3 | 4 | 5 | 7 | 8 |
| 18 | 1 | 3 | 4 | 6 | 7 | 8 |
| 19 | 1 | 3 | 5 | 6 | 7 | 8 |
| 20 | 1 | 4 | 5 | 6 | 7 | 8 |
| 21 | 2 | 3 | 4 | 5 | 6 | 7 |
| 22 | 2 | 3 | 4 | 5 | 6 | 8 |
| 23 | 2 | 3 | 4 | 5 | 7 | 8 |
| 24 | 2 | 3 | 4 | 6 | 7 | 8 |
| 25 | 2 | 3 | 5 | 6 | 7 | 8 |
| 26 | 2 | 4 | 5 | 6 | 7 | 8 |
| 27 | 3 | 4 | 5 | 6 | 7 | 8 |

and

| J₆ | x₁ | x₂ | x₃ | x₄ | x₅ | x₆ | I |
|---|---|---|---|---|---|---|---|
| 0 | 1 | 2 | 3 | 4 | 5 | 6 | 63 |
| 1 | 1 | 2 | 3 | 4 | 5 | 7 | 95 |
| 2 | 1 | 2 | 3 | 4 | 5 | 8 | 159 |
| 3 | 1 | 2 | 3 | 4 | 6 | 7 | 111 |
| 4 | 1 | 2 | 3 | 4 | 6 | 8 | 175 |
| 5 | 1 | 2 | 3 | 4 | 7 | 8 | 207 |
| 6 | 1 | 2 | 3 | 5 | 6 | 7 | 119 |
| 7 | 1 | 2 | 3 | 5 | 6 | 8 | 183 |
| 8 | 1 | 2 | 3 | 5 | 7 | 8 | 215 |
| 9 | 1 | 2 | 3 | 6 | 7 | 8 | 231 |
| 10 | 1 | 2 | 4 | 5 | 6 | 7 | 123 |
| 11 | 1 | 2 | 4 | 5 | 6 | 8 | 187 |
| 12 | 1 | 2 | 4 | 5 | 7 | 8 | 219 |
| 13 | 1 | 2 | 4 | 6 | 7 | 8 | 235 |
| 14 | 1 | 2 | 5 | 6 | 7 | 8 | 243 |
| 15 | 1 | 3 | 4 | 5 | 6 | 7 | 125 |
| 16 | 1 | 3 | 4 | 5 | 6 | 8 | 189 |
| 17 | 1 | 3 | 4 | 5 | 7 | 8 | 221 |
| 18 | 1 | 3 | 4 | 6 | 7 | 8 | 237 |
| 19 | 1 | 3 | 5 | 6 | 7 | 8 | 245 |
| 20 | 1 | 4 | 5 | 6 | 7 | 8 | 249 |
| 21 | 2 | 3 | 4 | 5 | 6 | 7 | 126 |
| 22 | 2 | 3 | 4 | 5 | 6 | 8 | 190 |
| 23 | 2 | 3 | 4 | 5 | 7 | 8 | 222 |
| 24 | 2 | 3 | 4 | 6 | 7 | 8 | 238 |
| 25 | 2 | 3 | 5 | 6 | 7 | 8 | 246 |
| 26 | 2 | 4 | 5 | 6 | 7 | 8 | 250 |
| 27 | 3 | 4 | 5 | 6 | 7 | 8 | 252, |

for v=7 layers, the TPMI index=246+J₇ and (J₇, I, x₁, . . . , x₇) is according to:

| J₇ | x₁ | x₂ | x₃ | x₄ | x₅ | x₆ | x₇ | I |
|---|---|---|---|---|---|---|---|---|
| 0 | 1 | 2 | 3 | 4 | 5 | 6 | 7 | 127 |
| 1 | 1 | 2 | 3 | 4 | 5 | 6 | 8 | 191 |
| 2 | 1 | 2 | 3 | 4 | 5 | 7 | 8 | 223 |
| 3 | 1 | 2 | 3 | 4 | 6 | 7 | 8 | 239 |
| 4 | 1 | 2 | 3 | 5 | 6 | 7 | 8 | 247 |
| 5 | 1 | 2 | 4 | 5 | 6 | 7 | 8 | 251 |
| 6 | 1 | 3 | 4 | 5 | 6 | 7 | 8 | 253 |
| 7 | 2 | 3 | 4 | 5 | 6 | 7 | 8 | 254, |

and
for v=8 layers, the TPMI index=254+J₈ and (J₈, I, x₁, . . . , x₈) is according to:

| J₈ | x₁ | x₂ | x₃ | x₄ | x₅ | x₆ | x₇ | x₈ | I |
|---|---|---|---|---|---|---|---|---|---|
| 0 | 1 | 2 | 3 | 4 | 5 | 6 | 7 | 8 | 255. |

9. A base station (BS) comprising:
a processor; and
a transceiver operably coupled to the processor, the transceiver configured to:
transmit a configuration including a value N_{g}=8 indicating an uplink (UL) codebook for eight antenna ports;
transmit a transmit precoding matrix indicator (TPMI) index indicating a precoding matrix from the UL codebook; and
receive a physical uplink shared channel (PUSCH) transmitted using the precoding matrix,
wherein:
the precoding matrix is given by:
$$W = \frac{1}{2 \sqrt{2}} [ {e}_{{x}_{1}} , … , {e}_{{x}_{v}} ] ,$$
where v is a number of layers of the precoding matrix, xᵢ is a port index associated with layer i, eᵢ is a column vector with a value 1 at row corresponding to port xᵢ and value 0 at other rows, xᵢ∈ {0, . . . ,7}, i∈{1, . . . , v}, v∈{1, . . . ,8}, and
the TPMI index maps to ports (x₁, . . . xᵥ) associated with v layers via an index I.

10. The BS of claim 9, wherein:
the transceiver is further configured to receive user equipment capability information indicating support for the UL codebook,
the index 1=Σₚ₌₀⁷δ(p)2^{p}, δ(p)=1 if a layer is to be transmitted on port p and δ(p)=0 otherwise, and
association of the TPMI index to layer is according to:

| v | TPMI index |
|---|---|
| 1 | 0-7 |
| 2 | 8-35 |
| 3 | 36-91 |
| 4 | 92-161 |
| 5 | 162-217 |
| 6 | 218-245 |
| 7 | 246-253 |
| 8 | 254 |

11. The BS of claim 10, wherein for v=1 layer, the TPMI index=1 and (J₁, I, x₁) is according to:

| J₁ | I | x₁ |
|---|---|---|
| 0 | 1 | 0 |
| 1 | 2 | 1 |
| 2 | 4 | 2 |
| 3 | 8 | 3 |
| 4 | 16 | 4 |
| 5 | 32 | 5 |
| 6 | 64 | 6 |
| 7 | 128 | 7 |

12. The BS of claim 10, wherein for v=2 layers, the TPMI index=8+J₂ and (J₂, I, x₁, x₂) is according to:

| J₂ | 0 | 1 | 2 | 3 | 4 | 5 | 6 | 7 | 8 | 9 | 10 | 11 | 12 | 13 |
|---|---|---|---|---|---|---|---|---|---|---|---|---|---|---|
| I | 3 | 5 | 9 | 17 | 33 | 65 | 129 | 6 | 10 | 18 | 34 | 66 | 130 | 12 |
| J₂ | 14 | 15 | 16 | 17 | 18 | 19 | 20 | 21 | 22 | 23 | 24 | 25 | 26 | 27 |
|---|---|---|---|---|---|---|---|---|---|---|---|---|---|---|
| I | 20 | 36 | 68 | 132 | 24 | 40 | 72 | 136 | 48 | 80 | 144 | 96 | 160 | 192 |

and

| J₂ | x₁ | x₂ |
|---|---|---|
| 0 | 1 | 2 |
| 1 | 1 | 3 |
| 2 | 1 | 4 |
| 3 | 1 | 5 |
| 4 | 1 | 6 |
| 5 | 1 | 7 |
| 6 | 1 | 8 |
| 7 | 2 | 3 |
| 8 | 2 | 4 |
| 9 | 2 | 5 |
| 10 | 2 | 6 |
| 11 | 2 | 7 |
| 12 | 2 | 8 |
| 13 | 3 | 4 |
| 14 | 3 | 5 |
| 15 | 3 | 6 |
| 16 | 3 | 7 |
| 17 | 3 | 8 |
| 18 | 4 | 5 |
| 19 | 4 | 6 |
| 20 | 4 | 7 |
| 21 | 4 | 8 |
| 22 | 5 | 6 |
| 23 | 5 | 7 |
| 24 | 5 | 8 |
| 25 | 6 | 7 |
| 26 | 6 | 8 |
| 27 | 7 | 8. |

13. The BS of claim 10, wherein for v=3 layers, the TPMI index=36+J₃ and (J₃, I, x₁, x₂, x₃) is according to:

| J₃ | x₁ | x₂ | x₃ |
|---|---|---|---|
| 0 | 1 | 2 | 3 |
| 1 | 1 | 2 | 4 |
| 2 | 1 | 2 | 5 |
| 3 | 1 | 2 | 6 |
| 4 | 1 | 2 | 7 |
| 5 | 1 | 2 | 8 |
| 6 | 1 | 3 | 4 |
| 7 | 1 | 3 | 5 |
| 8 | 1 | 3 | 6 |
| 9 | 1 | 3 | 7 |
| 10 | 1 | 3 | 8 |
| 11 | 1 | 4 | 5 |
| 12 | 1 | 4 | 6 |
| 13 | 1 | 4 | 7 |
| 14 | 1 | 4 | 8 |
| 15 | 1 | 5 | 6 |
| 16 | 1 | 5 | 7 |
| 17 | 1 | 5 | 8 |
| 18 | 1 | 6 | 7 |
| 19 | 1 | 6 | 8 |
| 20 | 1 | 7 | 8 |
| 21 | 2 | 3 | 4 |
| 22 | 2 | 3 | 5 |
| 23 | 2 | 3 | 6 |
| 24 | 2 | 3 | 7 |
| 25 | 2 | 3 | 8 |
| 26 | 2 | 4 | 5 |
| 27 | 2 | 4 | 6 |
| 28 | 2 | 4 | 7 |
| 29 | 2 | 4 | 8 |
| 30 | 2 | 5 | 6 |
| 31 | 2 | 5 | 7 |
| 32 | 2 | 5 | 8 |
| 33 | 2 | 6 | 7 |
| 34 | 2 | 6 | 8 |
| 35 | 2 | 7 | 8 |
| 36 | 3 | 4 | 5 |
| 37 | 3 | 4 | 6 |
| 38 | 3 | 4 | 7 |
| 39 | 3 | 4 | 8 |
| 40 | 3 | 5 | 6 |
| 41 | 3 | 5 | 7 |
| 42 | 3 | 5 | 8 |
| 43 | 3 | 6 | 7 |
| 44 | 3 | 6 | 8 |
| 45 | 3 | 7 | 8 |
| 46 | 4 | 5 | 6 |
| 47 | 4 | 5 | 7 |
| 48 | 4 | 5 | 8 |
| 49 | 4 | 6 | 7 |
| 50 | 4 | 6 | 8 |
| 51 | 4 | 7 | 8 |
| 52 | 5 | 6 | 7 |
| 53 | 5 | 6 | 8 |
| 54 | 5 | 7 | 8 |
| 55 | 6 | 7 | 8 |

and

| J₃ | 0 | 1 | 2 | 3 | 4 | 5 | 6 | 7 | 8 | 9 | 10 | 11 | 12 | 13 |
|---|---|---|---|---|---|---|---|---|---|---|---|---|---|---|
| I | 7 | 11 | 19 | 35 | 67 | 131 | 13 | 21 | 37 | 69 | 133 | 25 | 41 | 73 |
| J₃ | 14 | 15 | 16 | 17 | 18 | 19 | 20 | 21 | 22 | 23 | 24 | 25 | 26 | 27 |
|---|---|---|---|---|---|---|---|---|---|---|---|---|---|---|
| I | 137 | 49 | 81 | 145 | 97 | 161 | 193 | 14 | 22 | 38 | 70 | 134 | 26 | 42 |
| J₃ | 28 | 29 | 30 | 31 | 32 | 33 | 34 | 35 | 36 | 37 | 38 | 39 | 40 | 41 |
|---|---|---|---|---|---|---|---|---|---|---|---|---|---|---|
| I | 74 | 138 | 50 | 82 | 146 | 98 | 162 | 194 | 28 | 44 | 76 | 140 | 52 | 84 |
| J₃ | 42 | 43 | 44 | 45 | 46 | 47 | 48 | 49 | 50 | 51 | 52 | 53 | 54 | 55 |
|---|---|---|---|---|---|---|---|---|---|---|---|---|---|---|
| I | 148 | 100 | 164 | 196 | 56 | 88 | 152 | 104 | 168 | 200 | 112 | 176 | 208 | 224. |

14. The BS of claim 10, wherein for v=4 layers, the TPMI index=92+J₄ and (J₄, I, x₁, . . . , x₄) is according to:

| J₄ | x₁ | x₂ | x₃ | x₄ |
|---|---|---|---|---|
| 0 | 1 | 2 | 3 | 4 |
| 1 | 1 | 2 | 3 | 5 |
| 2 | 1 | 2 | 3 | 6 |
| 3 | 1 | 2 | 3 | 7 |
| 4 | 1 | 2 | 3 | 8 |
| 5 | 1 | 2 | 4 | 5 |
| 6 | 1 | 2 | 4 | 6 |
| 7 | 1 | 2 | 4 | 7 |
| 8 | 1 | 2 | 4 | 8 |
| 9 | 1 | 2 | 5 | 6 |
| 10 | 1 | 2 | 5 | 7 |
| 11 | 1 | 2 | 5 | 8 |
| 12 | 1 | 2 | 6 | 7 |
| 13 | 1 | 2 | 6 | 8 |
| 14 | 1 | 2 | 7 | 8 |
| 15 | 1 | 3 | 4 | 5 |
| 16 | 1 | 3 | 4 | 6 |
| 17 | 1 | 3 | 4 | 7 |
| 18 | 1 | 3 | 4 | 8 |
| 19 | 1 | 3 | 5 | 6 |
| 20 | 1 | 3 | 5 | 7 |
| 21 | 1 | 3 | 5 | 8 |
| 22 | 1 | 3 | 6 | 7 |
| 23 | 1 | 3 | 6 | 8 |
| 24 | 1 | 3 | 7 | 8 |
| 25 | 1 | 4 | 5 | 6 |
| 26 | 1 | 4 | 5 | 7 |
| 27 | 1 | 4 | 5 | 8 |
| 28 | 1 | 4 | 6 | 7 |
| 29 | 1 | 4 | 6 | 8 |
| 30 | 1 | 4 | 7 | 8 |
| 31 | 1 | 5 | 6 | 7 |
| 32 | 1 | 5 | 6 | 8 |
| 33 | 1 | 5 | 7 | 8 |
| 34 | 1 | 6 | 7 | 8 |
| 35 | 2 | 3 | 4 | 5 |
| 36 | 2 | 3 | 4 | 6 |
| 37 | 2 | 3 | 4 | 7 |
| 38 | 2 | 3 | 4 | 8 |
| 39 | 2 | 3 | 5 | 6 |
| 40 | 2 | 3 | 5 | 7 |
| 41 | 2 | 3 | 5 | 8 |
| 42 | 2 | 3 | 6 | 7 |
| 43 | 2 | 3 | 6 | 8 |
| 44 | 2 | 3 | 7 | 8 |
| 45 | 2 | 4 | 5 | 6 |
| 46 | 2 | 4 | 5 | 7 |
| 47 | 2 | 4 | 5 | 8 |
| 48 | 2 | 4 | 6 | 7 |
| 49 | 2 | 4 | 6 | 8 |
| 50 | 2 | 4 | 7 | 8 |
| 51 | 2 | 5 | 6 | 7 |
| 52 | 2 | 5 | 6 | 8 |
| 53 | 2 | 5 | 7 | 8 |
| 54 | 2 | 6 | 7 | 8 |
| 55 | 3 | 4 | 5 | 6 |
| 56 | 3 | 4 | 5 | 7 |
| 57 | 3 | 4 | 5 | 8 |
| 58 | 3 | 4 | 6 | 7 |
| 59 | 3 | 4 | 6 | 8 |
| 60 | 3 | 4 | 7 | 8 |
| 61 | 3 | 5 | 6 | 7 |
| 62 | 3 | 5 | 6 | 8 |
| 63 | 3 | 5 | 7 | 8 |
| 64 | 3 | 6 | 7 | 8 |
| 65 | 4 | 5 | 6 | 7 |
| 66 | 4 | 5 | 6 | 8 |
| 67 | 4 | 5 | 7 | 8 |
| 68 | 4 | 6 | 7 | 8 |
| 69 | 5 | 6 | 7 | 8 |

and

| J₄ | x₁ | x₂ | x₃ | x₄ | I |
|---|---|---|---|---|---|
| 0 | 1 | 2 | 3 | 4 | 15 |
| 1 | 1 | 2 | 3 | 5 | 23 |
| 2 | 1 | 2 | 3 | 6 | 39 |
| 3 | 1 | 2 | 3 | 7 | 71 |
| 4 | 1 | 2 | 3 | 8 | 135 |
| 5 | 1 | 2 | 4 | 5 | 27 |
| 6 | 1 | 2 | 4 | 6 | 43 |
| 7 | 1 | 2 | 4 | 7 | 75 |
| 8 | 1 | 2 | 4 | 8 | 139 |
| 9 | 1 | 2 | 5 | 6 | 51 |
| 10 | 1 | 2 | 5 | 7 | 83 |
| 11 | 1 | 2 | 5 | 8 | 147 |
| 12 | 1 | 2 | 6 | 7 | 99 |
| 13 | 1 | 2 | 6 | 8 | 163 |
| 14 | 1 | 2 | 7 | 8 | 195 |
| 15 | 1 | 3 | 4 | 5 | 29 |
| 16 | 1 | 3 | 4 | 6 | 45 |
| 17 | 1 | 3 | 4 | 7 | 77 |
| 18 | 1 | 3 | 4 | 8 | 141 |
| 19 | 1 | 3 | 5 | 6 | 53 |
| 20 | 1 | 3 | 5 | 7 | 85 |
| 21 | 1 | 3 | 5 | 8 | 149 |
| 22 | 1 | 3 | 6 | 7 | 101 |
| 23 | 1 | 3 | 6 | 8 | 165 |
| 24 | 1 | 3 | 7 | 8 | 197 |
| 25 | 1 | 4 | 5 | 6 | 57 |
| 26 | 1 | 4 | 5 | 7 | 89 |
| 27 | 1 | 4 | 5 | 8 | 153 |
| 28 | 1 | 4 | 6 | 7 | 105 |
| 29 | 1 | 4 | 6 | 8 | 169 |
| 30 | 1 | 4 | 7 | 8 | 201 |
| 31 | 1 | 5 | 6 | 7 | 113 |
| 32 | 1 | 5 | 6 | 8 | 177 |
| 33 | 1 | 5 | 7 | 8 | 209 |
| 34 | 1 | 6 | 7 | 8 | 225 |
| 35 | 2 | 3 | 4 | 5 | 30 |
| 36 | 2 | 3 | 4 | 6 | 46 |
| 37 | 2 | 3 | 4 | 7 | 78 |
| 38 | 2 | 3 | 4 | 8 | 142 |
| 39 | 2 | 3 | 5 | 6 | 54 |
| 40 | 2 | 3 | 5 | 7 | 86 |
| 41 | 2 | 3 | 5 | 8 | 150 |
| 42 | 2 | 3 | 6 | 7 | 102 |
| 43 | 2 | 3 | 6 | 8 | 166 |
| 44 | 2 | 3 | 7 | 8 | 198 |
| 45 | 2 | 4 | 5 | 6 | 58 |
| 46 | 2 | 4 | 5 | 7 | 90 |
| 47 | 2 | 4 | 5 | 8 | 154 |
| 48 | 2 | 4 | 6 | 7 | 106 |
| 49 | 2 | 4 | 6 | 8 | 170 |
| 50 | 2 | 4 | 7 | 8 | 202 |
| 51 | 2 | 5 | 6 | 7 | 114 |
| 52 | 2 | 5 | 6 | 8 | 178 |
| 53 | 2 | 5 | 7 | 8 | 210 |
| 54 | 2 | 6 | 7 | 8 | 226 |
| 55 | 3 | 4 | 5 | 6 | 60 |
| 56 | 3 | 4 | 5 | 7 | 92 |
| 57 | 3 | 4 | 5 | 8 | 156 |
| 58 | 3 | 4 | 6 | 7 | 108 |
| 59 | 3 | 4 | 6 | 8 | 172 |
| 60 | 3 | 4 | 7 | 8 | 204 |
| 61 | 3 | 5 | 6 | 7 | 116 |
| 62 | 3 | 5 | 6 | 8 | 180 |
| 63 | 3 | 5 | 7 | 8 | 212 |
| 64 | 3 | 6 | 7 | 8 | 228 |
| 65 | 4 | 5 | 6 | 7 | 120 |
| 66 | 4 | 5 | 6 | 8 | 184 |
| 67 | 4 | 5 | 7 | 8 | 216 |
| 68 | 4 | 6 | 7 | 8 | 232 |
| 69 | 5 | 6 | 7 | 8 | 240. |

15. The BS of claim 10, wherein for v=5 layers, the TPMI index=162+J₅ and (J₅, I, x₁, . . . , x₅) is according to:

| J₅ | x₁ | x₂ | x₃ | x₄ | x₅ |
|---|---|---|---|---|---|
| 0 | 1 | 2 | 3 | 4 | 5 |
| 1 | 1 | 2 | 3 | 4 | 6 |
| 2 | 1 | 2 | 3 | 4 | 7 |
| 3 | 1 | 2 | 3 | 4 | 8 |
| 4 | 1 | 2 | 3 | 5 | 6 |
| 5 | 1 | 2 | 3 | 5 | 7 |
| 6 | 1 | 2 | 3 | 5 | 8 |
| 7 | 1 | 2 | 3 | 6 | 7 |
| 8 | 1 | 2 | 3 | 6 | 8 |
| 9 | 1 | 2 | 3 | 7 | 8 |
| 10 | 1 | 2 | 4 | 5 | 6 |
| 11 | 1 | 2 | 4 | 5 | 7 |
| 12 | 1 | 2 | 4 | 5 | 8 |
| 13 | 1 | 2 | 4 | 6 | 7 |
| 14 | 1 | 2 | 4 | 6 | 8 |
| 15 | 1 | 2 | 4 | 7 | 8 |
| 16 | 1 | 2 | 5 | 6 | 7 |
| 17 | 1 | 2 | 5 | 6 | 8 |
| 18 | 1 | 2 | 5 | 7 | 8 |
| 19 | 1 | 2 | 6 | 7 | 8 |
| 20 | 1 | 3 | 4 | 5 | 6 |
| 21 | 1 | 3 | 4 | 5 | 7 |
| 22 | 1 | 3 | 4 | 5 | 8 |
| 23 | 1 | 3 | 4 | 6 | 7 |
| 24 | 1 | 3 | 4 | 6 | 8 |
| 25 | 1 | 3 | 4 | 7 | 8 |
| 26 | 1 | 3 | 5 | 6 | 7 |
| 27 | 1 | 3 | 5 | 6 | 8 |
| 28 | 1 | 3 | 5 | 7 | 8 |
| 29 | 1 | 3 | 6 | 7 | 8 |
| 30 | 1 | 4 | 5 | 6 | 7 |
| 31 | 1 | 4 | 5 | 6 | 8 |
| 32 | 1 | 4 | 5 | 7 | 8 |
| 33 | 1 | 4 | 6 | 7 | 8 |
| 34 | 1 | 5 | 6 | 7 | 8 |
| 35 | 2 | 3 | 4 | 5 | 6 |
| 36 | 2 | 3 | 4 | 5 | 7 |
| 37 | 2 | 3 | 4 | 5 | 8 |
| 38 | 2 | 3 | 4 | 6 | 7 |
| 39 | 2 | 3 | 4 | 6 | 8 |
| 40 | 2 | 3 | 4 | 7 | 8 |
| 41 | 2 | 3 | 5 | 6 | 7 |
| 42 | 2 | 3 | 5 | 6 | 8 |
| 43 | 2 | 3 | 5 | 7 | 8 |
| 44 | 2 | 3 | 6 | 7 | 8 |
| 45 | 2 | 4 | 5 | 6 | 7 |
| 46 | 2 | 4 | 5 | 6 | 8 |
| 47 | 2 | 4 | 5 | 7 | 8 |
| 48 | 2 | 4 | 6 | 7 | 8 |
| 49 | 2 | 5 | 6 | 7 | 8 |
| 50 | 3 | 4 | 5 | 6 | 7 |
| 51 | 3 | 4 | 5 | 6 | 8 |
| 52 | 3 | 4 | 5 | 7 | 8 |
| 53 | 3 | 4 | 6 | 7 | 8 |
| 54 | 3 | 5 | 6 | 7 | 8 |
| 55 | 4 | 5 | 6 | 7 | 8 |

and

| J₅ | x₁ | x₂ | x₃ | x₄ | x₅ | I |
|---|---|---|---|---|---|---|
| 0 | 1 | 2 | 3 | 4 | 5 | 31 |
| 1 | 1 | 2 | 3 | 4 | 6 | 47 |
| 2 | 1 | 2 | 3 | 4 | 7 | 79 |
| 3 | 1 | 2 | 3 | 4 | 8 | 143 |
| 4 | 1 | 2 | 3 | 5 | 6 | 55 |
| 5 | 1 | 2 | 3 | 5 | 7 | 87 |
| 6 | 1 | 2 | 3 | 5 | 8 | 151 |
| 7 | 1 | 2 | 3 | 6 | 7 | 103 |
| 8 | 1 | 2 | 3 | 6 | 8 | 167 |
| 9 | 1 | 2 | 3 | 7 | 8 | 199 |
| 10 | 1 | 2 | 4 | 5 | 6 | 59 |
| 11 | 1 | 2 | 4 | 5 | 7 | 91 |
| 12 | 1 | 2 | 4 | 5 | 8 | 155 |
| 13 | 1 | 2 | 4 | 6 | 7 | 107 |
| 14 | 1 | 2 | 4 | 6 | 8 | 171 |
| 15 | 1 | 2 | 4 | 7 | 8 | 203 |
| 16 | 1 | 2 | 5 | 6 | 7 | 115 |
| 17 | 1 | 2 | 5 | 6 | 8 | 179 |
| 18 | 1 | 2 | 5 | 7 | 8 | 211 |
| 19 | 1 | 2 | 6 | 7 | 8 | 227 |
| 20 | 1 | 3 | 4 | 5 | 6 | 61 |
| 21 | 1 | 3 | 4 | 5 | 7 | 93 |
| 22 | 1 | 3 | 4 | 5 | 8 | 157 |
| 23 | 1 | 3 | 4 | 6 | 7 | 109 |
| 24 | 1 | 3 | 4 | 6 | 8 | 173 |
| 25 | 1 | 3 | 4 | 7 | 8 | 205 |
| 26 | 1 | 3 | 5 | 6 | 7 | 117 |
| 27 | 1 | 3 | 5 | 6 | 8 | 181 |
| 28 | 1 | 3 | 5 | 7 | 8 | 213 |
| 29 | 1 | 3 | 6 | 7 | 8 | 229 |
| 30 | 1 | 4 | 5 | 6 | 7 | 121 |
| 31 | 1 | 4 | 5 | 6 | 8 | 185 |
| 32 | 1 | 4 | 5 | 7 | 8 | 217 |
| 33 | 1 | 4 | 6 | 7 | 8 | 233 |
| 34 | 1 | 5 | 6 | 7 | 8 | 241 |
| 35 | 2 | 3 | 4 | 5 | 6 | 62 |
| 36 | 2 | 3 | 4 | 5 | 7 | 94 |
| 37 | 2 | 3 | 4 | 5 | 8 | 158 |
| 38 | 2 | 3 | 4 | 6 | 7 | 110 |
| 39 | 2 | 3 | 4 | 6 | 8 | 174 |
| 40 | 2 | 3 | 4 | 7 | 8 | 206 |
| 41 | 2 | 3 | 5 | 6 | 7 | 118 |
| 42 | 2 | 3 | 5 | 6 | 8 | 182 |
| 43 | 2 | 3 | 5 | 7 | 8 | 214 |
| 44 | 2 | 3 | 6 | 7 | 8 | 230 |
| 45 | 2 | 4 | 5 | 6 | 7 | 122 |
| 46 | 2 | 4 | 5 | 6 | 8 | 186 |
| 47 | 2 | 4 | 5 | 7 | 8 | 218 |
| 48 | 2 | 4 | 6 | 7 | 8 | 234 |
| 49 | 2 | 5 | 6 | 7 | 8 | 242 |
| 50 | 3 | 4 | 5 | 6 | 7 | 124 |
| 51 | 3 | 4 | 5 | 6 | 8 | 188 |
| 52 | 3 | 4 | 5 | 7 | 8 | 220 |
| 53 | 3 | 4 | 6 | 7 | 8 | 236 |
| 54 | 3 | 5 | 6 | 7 | 8 | 244 |
| 55 | 4 | 5 | 6 | 7 | 8 | 248. |

16. The BS of claim 10, wherein for v=6 layers, the TPMI index=218+J₆ and (J₆, I, x₁, . . . , x₆) is according to:

| J₆ | x₁ | x₂ | x₃ | x₄ | x₅ | x₆ |
|---|---|---|---|---|---|---|
| 0 | 1 | 2 | 3 | 4 | 5 | 6 |
| 1 | 1 | 2 | 3 | 4 | 5 | 7 |
| 2 | 1 | 2 | 3 | 4 | 5 | 8 |
| 3 | 1 | 2 | 3 | 4 | 6 | 7 |
| 4 | 1 | 2 | 3 | 4 | 6 | 8 |
| 5 | 1 | 2 | 3 | 4 | 7 | 8 |
| 6 | 1 | 2 | 3 | 5 | 6 | 7 |
| 7 | 1 | 2 | 3 | 5 | 6 | 8 |
| 8 | 1 | 2 | 3 | 5 | 7 | 8 |
| 9 | 1 | 2 | 3 | 6 | 7 | 8 |
| 10 | 1 | 2 | 4 | 5 | 6 | 7 |
| 11 | 1 | 2 | 4 | 5 | 6 | 8 |
| 12 | 1 | 2 | 4 | 5 | 7 | 8 |
| 13 | 1 | 2 | 4 | 6 | 7 | 8 |
| 14 | 1 | 2 | 5 | 6 | 7 | 8 |
| 15 | 1 | 3 | 4 | 5 | 6 | 7 |
| 16 | 1 | 3 | 4 | 5 | 6 | 8 |
| 17 | 1 | 3 | 4 | 5 | 7 | 8 |
| 18 | 1 | 3 | 4 | 6 | 7 | 8 |
| 19 | 1 | 3 | 5 | 6 | 7 | 8 |
| 20 | 1 | 4 | 5 | 6 | 7 | 8 |
| 21 | 2 | 3 | 4 | 5 | 6 | 7 |
| 22 | 2 | 3 | 4 | 5 | 6 | 8 |
| 23 | 2 | 3 | 4 | 5 | 7 | 8 |
| 24 | 2 | 3 | 4 | 6 | 7 | 8 |
| 25 | 2 | 3 | 5 | 6 | 7 | 8 |
| 26 | 2 | 4 | 5 | 6 | 7 | 8 |
| 27 | 3 | 4 | 5 | 6 | 7 | 8 |

and

| J₆ | x₁ | x₂ | x₃ | x₄ | x₅ | x₆ | I |
|---|---|---|---|---|---|---|---|
| 0 | 1 | 2 | 3 | 4 | 5 | 6 | 63 |
| 1 | 1 | 2 | 3 | 4 | 5 | 7 | 95 |
| 2 | 1 | 2 | 3 | 4 | 5 | 8 | 159 |
| 3 | 1 | 2 | 3 | 4 | 6 | 7 | 111 |
| 4 | 1 | 2 | 3 | 4 | 6 | 8 | 175 |
| 5 | 1 | 2 | 3 | 4 | 7 | 8 | 207 |
| 6 | 1 | 2 | 3 | 5 | 6 | 7 | 119 |
| 7 | 1 | 2 | 3 | 5 | 6 | 8 | 183 |
| 8 | 1 | 2 | 3 | 5 | 7 | 8 | 215 |
| 9 | 1 | 2 | 3 | 6 | 7 | 8 | 231 |
| 10 | 1 | 2 | 4 | 5 | 6 | 7 | 123 |
| 11 | 1 | 2 | 4 | 5 | 6 | 8 | 187 |
| 12 | 1 | 2 | 4 | 5 | 7 | 8 | 219 |
| 13 | 1 | 2 | 4 | 6 | 7 | 8 | 235 |
| 14 | 1 | 2 | 5 | 6 | 7 | 8 | 243 |
| 15 | 1 | 3 | 4 | 5 | 6 | 7 | 125 |
| 16 | 1 | 3 | 4 | 5 | 6 | 8 | 189 |
| 17 | 1 | 3 | 4 | 5 | 7 | 8 | 221 |
| 18 | 1 | 3 | 4 | 6 | 7 | 8 | 237 |
| 19 | 1 | 3 | 5 | 6 | 7 | 8 | 245 |
| 20 | 1 | 4 | 5 | 6 | 7 | 8 | 249 |
| 21 | 2 | 3 | 4 | 5 | 6 | 7 | 126 |
| 22 | 2 | 3 | 4 | 5 | 6 | 8 | 190 |
| 23 | 2 | 3 | 4 | 5 | 7 | 8 | 222 |
| 24 | 2 | 3 | 4 | 6 | 7 | 8 | 238 |
| 25 | 2 | 3 | 5 | 6 | 7 | 8 | 246 |
| 26 | 2 | 4 | 5 | 6 | 7 | 8 | 250 |
| 27 | 3 | 4 | 5 | 6 | 7 | 8 | 252, |

for v=7 layers, the TPMI index=246+J, and (J₇, I, x₁, . . . , x₇) is according to:

| J₇ | x₁ | x₂ | x₃ | x₄ | x₅ | x₆ | x₇ | I |
|---|---|---|---|---|---|---|---|---|
| 0 | 1 | 2 | 3 | 4 | 5 | 6 | 7 | 127 |
| 1 | 1 | 2 | 3 | 4 | 5 | 6 | 8 | 191 |
| 2 | 1 | 2 | 3 | 4 | 5 | 7 | 8 | 223 |
| 3 | 1 | 2 | 3 | 4 | 6 | 7 | 8 | 239 |
| 4 | 1 | 2 | 3 | 5 | 6 | 7 | 8 | 247 |
| 5 | 1 | 2 | 4 | 5 | 6 | 7 | 8 | 251 |
| 6 | 1 | 3 | 4 | 5 | 6 | 7 | 8 | 253 |
| 7 | 2 | 3 | 4 | 5 | 6 | 7 | 8 | 254, |

and
for v=8 layers, the TPMI index=254+J₈ and (J₈, I, x₁, . . . , x₈) is according to:

| J₈ | x₁ | x₂ | x₃ | x₄ | x₅ | x₆ | x₇ | x₈ | I |
|---|---|---|---|---|---|---|---|---|---|
| 0 | 1 | 2 | 3 | 4 | 5 | 6 | 7 | 8 | 255. |

17. A method performed by a user equipment (UE), the method comprising:
receiving a configuration including a value N_{g}=8 indicating an uplink (UL) codebook for eight antenna ports;
receiving a transmit precoding matrix indicator (TPMI) index indicating a precoding matrix from the UL codebook; and
transmitting a physical uplink shared channel (PUSCH) using the precoding matrix,
wherein:
the precoding matrix is given by:
$$W = \frac{1}{2 \sqrt{2}} [ {e}_{{x}_{1}} , … , {e}_{{x}_{v}} ] ,$$
where v is a number of layers of the precoding matrix, xᵢ is a port index associated with layer i, e; is a column vector with a value 1 at row corresponding to port xᵢ and value 0 at other rows, xᵢ∈ {0, . . . ,7}, i∈{1, . . . , v}, v∈{1, . . . ,8}, and
the TPMI index maps to ports (x₁, . . . , xᵥ) associated with v layers via an index I.

18. The method of claim 17, further comprising:
transmitting UE capability information indicating support for the UL codebook,
wherein the index I=Σ₇^{p=0}δ(p)2^{p}, δ(p)=1 if a layer is to be transmitted on port p and δ(p)=0 otherwise, and
wherein association of the TPMI index to layer is according to:

| v | TPMI index |
|---|---|
| 1 | 0-7 |
| 2 | 8-35 |
| 3 | 36-91 |
| 4 | 92-161 |
| 5 | 162-217 |
| 6 | 218-245 |
| 7 | 246-253 |
| 8 | 254 |

19. The method of claim 18, wherein for v=1 layer, the TPMI index=J₁ and (J₁, I, x₁) is according to:

| J₁ | I | x₁ |
|---|---|---|
| 0 | 1 | 0 |
| 1 | 2 | 1 |
| 2 | 4 | 2 |
| 3 | 8 | 3 |
| 4 | 16 | 4 |
| 5 | 32 | 5 |
| 6 | 64 | 6 |
| 7 | 128 | 7 |

20. The method of claim 18, wherein for v=2 layers, the TPMI index=8+J₂ and (J₂, I, x₁, x₂) is according to:

| J₂ | 0 | 1 | 2 | 3 | 4 | 5 | 6 | 7 | 8 | 9 | 10 | 11 | 12 | 13 |
|---|---|---|---|---|---|---|---|---|---|---|---|---|---|---|
| I | 3 | 5 | 9 | 17 | 33 | 65 | 129 | 6 | 10 | 18 | 34 | 66 | 130 | 12 |
| J₂ | 14 | 15 | 16 | 17 | 18 | 19 | 20 | 21 | 22 | 23 | 24 | 25 | 26 | 27 |
|---|---|---|---|---|---|---|---|---|---|---|---|---|---|---|
| I | 20 | 36 | 68 | 132 | 24 | 40 | 72 | 136 | 48 | 80 | 144 | 96 | 160 | 192 |

and

| J₂ | x₁ | x₂ |
|---|---|---|
| 0 | 1 | 2 |
| 1 | 1 | 3 |
| 2 | 1 | 4 |
| 3 | 1 | 5 |
| 4 | 1 | 6 |
| 5 | 1 | 7 |
| 6 | 1 | 8 |
| 7 | 2 | 3 |
| 8 | 2 | 4 |
| 9 | 2 | 5 |
| 10 | 2 | 6 |
| 11 | 2 | 7 |
| 12 | 2 | 8 |
| 13 | 3 | 4 |
| 14 | 3 | 5 |
| 15 | 3 | 6 |
| 16 | 3 | 7 |
| 17 | 3 | 8 |
| 18 | 4 | 5 |
| 19 | 4 | 6 |
| 20 | 4 | 7 |
| 21 | 4 | 8 |
| 22 | 5 | 6 |
| 23 | 5 | 7 |
| 24 | 5 | 8 |
| 25 | 6 | 7 |
| 26 | 6 | 8 |
| 27 | 7 | 8. |
